(19) United States
(12) Patent Application Publication
(10) Pub. No.: US 2026/0260424 A1
(43) Pub. Date: Sep. 3, 2026

(54) INFORMATION PROCESSING DEVICE AND METHOD

(71) Applicant: Sony Group Corporation, Tokyo (JP)

(72) Inventors: Ryohei TAKAHASHI, Tokyo (JP); Mitsuhiro HIRABAYASHI, Tokyo (JP)

(73) Assignee: Sony Group Corporation, Tokyo (JP)

(21) Appl. No.: 19/162,094

(22) PCT Filed: Mar. 13, 2024
(86) PCT No.: PCT/JP2024/009675

§ 371 Date: Sep. 4, 2025

Related U.S. Application Data
(60) Provisional application No. 63/452,200, filed on Mar. 15, 2023.

(51) Int. Cl. G06T 17/20

(52) U.S. Cl. CPC G06T 17/20

(57) ABSTRACT

The present disclosure relates to an information processing device and method capable of suppressing a reduction in processing efficiency of decoding processing.

A scene description representing a scene configured by a 3D object is generated, and first reference information to a first buffer that stores submesh association information for specifying data of a submesh that is a part of a mesh representing the 3D object is set in the scene description. The submesh association information is stored in the first buffer, the submesh association information is acquired from the first buffer, the data of the submesh is specified using the acquired submesh association information, and the mesh is reconstructed. The present disclosure can be applied to, for example, an information processing device, an information processing method, or the like.

### TECHNICAL FIELD

The present disclosure relates to an information processing device and method, and more particularly, to an information processing device and method capable of suppressing a reduction in processing efficiency of decoding processing.

### BACKGROUND ART

Conventionally, there has been the GL transmission format (glTF) (registered trademark) 2.0 that is a format of a scene description for disposing and rendering a three-dimensional (3D) object in a three-dimensional space (for example, see Non-Patent Document 1).

Furthermore, in the MPEG-I scene description (moving picture experts group (MPEG)-I scene description), a method of extending this glTF2.0 and handling dynamic content in the time direction has been proposed (for example, see Non-Patent Document 2). This MPEG-I scene description supports video-based point cloud compression (V-PCC), which is a point cloud coding scheme that is one of the 3D data (see, for example, Non-Patent Document 3).

Meanwhile, as a method of coding a mesh that is 3D data representing a three-dimensional structure of an object by connection with vertices, there is video-based dynamic mesh coding (V-DMC) (see, for example, Non-Patent Documents 5 to 5 Non-Patent Document 7).

In recent years, establishment of a method of storing a bit stream coded by the V-DMC (also referred to as a V-DMC bit stream) in the International Organization for Standardization base media file format (ISOBMFF) or the like and distributing the bit stream is expected. For example, it can be assumed that ISO/IEC 23090-10 (see, for example, Non-Patent Document 8), which is a distribution technology standard of the V-PCC, is extended and standardized. In this case, the V-DMC bit stream is stored in the track of the ISOBMFF.

### CITATION LIST

### Non-Patent Document

Non-Patent Document 1: Saurabh Bhatia, Patrick Cozzi, Alexey Knyazev, Tony Parisi, “Khronos glTF2.0”, https://github.com/KhronosGroup/glTF/tree/master/specific ation/2.0, Jun. 9, 2017
Non-Patent Document 2: “Information technology-Coded representation of immersive media-Part 14: Scene Description”, ISO/IEC DIS 23090-14:2021 (E), ISO/IEC JTC 1/SC 29/WG 03 N00485, 137th MPEG meeting, January 2022, online
Non-Patent Document 3: “Potential improvements of ISO/IEC 23090-14 DAM 1 Support for immersive media codecs in scene description”, ISO/IEC JTC 1/SC 29/WG 03 N00795, 2023 Feb. 4
Non-Patent Document 4: Khaled Mammou, Jungsun Kim, Alexis Tourapis, Dimitri Podborski, Krasimir Kolarov, “[V-CG] Apple's Dynamic Mesh Coding CfP Response”, ISO/IEC JTC 1/SC 29/WG 7 m59281, April 2022
Non-Patent Document 5: Jungsun Kim, Alexis Tourapis, Dimitri Podborski, Khaled Mammou, “VDMC support in the V3C framework”, ISO/IEC JTC 1/SC 29/WG 7 m60748, October 2022
Non-Patent Document 6: Alexis Tourapis, Jungsun Kim, Dimitri Podborski, Khaled Mammou, “Base mesh data substream format for VDMC”, ISO/IEC JTC 1/SC 29/WG 7 m60362, July 2022
Non-Patent Document 7: “WD 2.0 of V-DMC”, ISO/IEC JTC 1/SC 29/WG 07 N0546, MPEG 141th meeting, 2023-1
Non-Patent Document 8: “Text of ISO/IEC FDIS 23090-10 Carriage of Visual Volumetric Video-based Coding Data”, ISO/IEC JTC 1/SC 29/WG 03 N00241, 2021 Aug. 20, ISO/IEC 23090-10:2022, 1st edition, 2022-05

### SUMMARY OF THE INVENTION

### Problems to be Solved by the Invention

According to the V-DMC coding, Non-registered Mesh data can be transmitted at a higher compression rate than before, and support is expected as one of the coding techniques for 3D objects constituting a scene also in the MPEG-I scene description. In this case, it is assumed that processing for reconstructing 3D data from V-DMC data, such as subdivision of base mesh, refinement of vertex positions by displacement vectors, mapping of attributes, and the like, is performed in a presentation engine (PE) with higher processing efficiency than in a case of a media access function (MAF).

However, the correspondence relationship between the patch and the submesh cannot be grasped in the PE, and it is difficult to reconstruct the 3D data from the V-DMC data in the PE. Therefore, there is a possibility that the processing efficiency of the decoding processing is reduced.

The present disclosure has been made in view of such a situation, and an object thereof is to suppress a decrease in processing efficiency of decoding processing.

### Solutions to Problems

An information processing device according to one aspect of the present technology is an information processing device including a scene description generation unit that generates a scene description representing a scene configured by a 3D object, and sets, in the scene description, first reference information to a first buffer that stores submesh association information, in which the submesh association information is information for specifying data of a submesh that is a part of a mesh representing the 3D object.

An information processing method according to one aspect of the present technology is an information processing method including: generating a scene description representing a scene configured by a 3D object; and setting, in the scene description, first reference information to a first buffer that stores submesh association information, in which the submesh association information is information for specifying data of a submesh that is a part of a mesh representing the 3D object.

An information processing device according to another aspect of the present technology is an information processing device including: a storage processing unit that stores submesh association information for specifying data of a submesh that is a part of a mesh representing a 3D object, in a first buffer designated by a scene description representing a scene configured by the 3D object; and a reconstruction unit that acquires the submesh association information from the first buffer, specifies the data of the submesh using the acquired submesh association information, and reconstructs the mesh.

An information processing method according to another aspect of the present technology is an information processing method including: storing submesh association information for specifying data of a submesh that is a part of a mesh representing a 3D object in a first buffer designated by a scene description representing a scene configured by the 3D object; and acquiring the submesh association information from the first buffer, specifying the data of the submesh using the acquired submesh association information, and reconfiguring the mesh.

In the information processing device and method according to one aspect of the present technology, a scene description representing a scene configured by a 3D object is generated, and first reference information to a first buffer that stores submesh association information is set in the scene description.

In an information processing device and method according to another aspect of the present technology, submesh association information for specifying data of a submesh that is a part of a mesh representing a 3D object is stored in a first buffer designated by a scene description representing a scene configured by the 3D object, the submesh association information is acquired from the first buffer, the data of the submesh is specified using the acquired submesh association information, and the mesh is reconstructed.

### BRIEF DESCRIPTION OF DRAWINGS

FIG. 1 is a diagram illustrating a main configuration example of the glTF 2.0.

FIG. 2 is a diagram illustrating an example of a glTF object and a reference relationship.

FIG. 3 is a diagram illustrating a description example of a scene description.

FIG. 4 is a diagram for describing a method of accessing binary data.

FIG. 5 is a diagram illustrating a description example of a scene description.

FIG. 6 is a diagram for describing an object extension method.

FIG. 7 is a diagram illustrating a configuration of a client process.

FIG. 8 is a diagram illustrating a configuration example of an extension for handling timed metadata.

FIG. 9 is a diagram illustrating a description example of a scene description.

FIG. 10 is a diagram illustrating an example of a point cloud reconstruction processing method in a case where V-PCC is applied.

FIG. 11 is a diagram illustrating an exemplary structure of a scene description in a case of reconfiguration in MAF.

FIG. 12 is a diagram illustrating an exemplary structure of a scene description in a case of reconstruction in PE.

FIG. 13 is a diagram illustrating an example of patch information in V-PCC.

FIG. 14 is a diagram for explaining a mesh.

FIG. 15 is a diagram for explaining V-DMC.

FIG. 16 is a diagram illustrating an example of decoding processing of a V-DMC bit stream.

FIG. 17 is a diagram for explaining a submesh.

FIG. 18 is a diagram for explaining a submesh.

FIG. 19 is a diagram for explaining multi-track.

FIG. 20 is a diagram illustrating an example of a method of supporting V-DMC data in a scene description.

FIG. 21 is a diagram illustrating an example of an outline of decoding processing in a case where 3D data is reconstructed from V-DMC data in MAF.

FIG. 22 is a diagram illustrating an example of an outline of a decoding processing in a case where 3D data is reconstructed from V-DMC data in PE.

FIG. 23 is a diagram illustrating an example of patch information in V-DMC coding.

FIG. 24 is a diagram illustrating an exemplary structure of a scene description in a case where 3D data is reconstructed from V-DMC data in PE.

FIG. 25 is a diagram illustrating a description example of a scene description.

FIG. 26 is a diagram for explaining association between a patch and a submesh.

FIG. 27 is a diagram illustrating an application example of submesh association information.

FIG. 28 is a diagram illustrating an exemplary structure of a scene description in a case where submesh association information is applied.

FIG. 29 is a diagram illustrating an example of submesh association information.

FIG. 30 is a diagram illustrating an exemplary structure of a scene description corresponding to submesh association information.

FIG. 31 is a diagram illustrating an example of submesh association information.

FIG. 32 is a diagram illustrating an exemplary structure of a scene description in a case where submesh association information is applied.

FIG. 33 is a diagram illustrating an example of submesh association information.

FIG. 34 is a diagram illustrating an exemplary structure of a scene description in a case where submesh association information is applied.

FIG. 35 is a diagram illustrating an example of submesh association information.

FIG. 36 is a diagram illustrating an example of an outline of a decoding processing in a case where 3D data is reconstructed from V-DMC data in PE.

FIG. 37 is a diagram illustrating an example of subdivision information.

FIG. 38 is a diagram illustrating an example of subdivision information.

FIG. 39 is a block diagram illustrating a principal configuration example of a file generation device.

FIG. 40 is a block diagram illustrating a main configuration example of a V-DMC data coding unit.

FIG. 41 is a flowchart illustrating an example of a flow of file generation processing.

FIG. 42 is a flowchart illustrating an example of a flow of V-DMC coding processing.

FIG. 43 is a flowchart illustrating an example of a flow of file generation processing.

FIG. 44 is a flowchart illustrating an example of a flow of file generation processing.

FIG. 45 is a flowchart illustrating an example of a flow of file generation processing.

FIG. 46 is a flowchart illustrating an example of a flow of file generation processing.

FIG. 47 is a flowchart illustrating an example of a flow of file generation processing.

FIG. 48 is a flowchart illustrating an example of a flow of file generation processing.

FIG. 49 is a block diagram illustrating a main configuration example of a reproduction device.

FIG. 50 is a block diagram illustrating a main configuration example of MAF.

FIG. 51 is a flowchart illustrating an example of a flow of reproduction processing.

FIG. 52 is a flowchart illustrating an example of a flow of MAF processing.

FIG. 53 is a block diagram illustrating a main configuration example of the reproduction device.

FIG. 54 is a block diagram illustrating a main configuration example of MAF.

FIG. 55 is a flowchart illustrating an example of a flow of reproduction processing.

FIG. 56 is a flowchart illustrating an example of a flow of MAF processing.

FIG. 57 is a block diagram illustrating a main configuration example of MAF.

FIG. 58 is a flowchart illustrating an example of a flow of MAF processing.

FIG. 59 is a block diagram illustrating a main configuration example of MAF.

FIG. 60 is a flowchart illustrating an example of a flow of MAF processing.

FIG. 61 is a block diagram illustrating a main configuration example of the reproduction device.

FIG. 62 is a block diagram illustrating a main configuration example of MAF.

FIG. 63 is a flowchart illustrating an example of a flow of reproduction processing.

FIG. 64 is a flowchart illustrating an example of a flow of MAF processing.

FIG. 65 is a block diagram illustrating a main configuration example of MAF.

FIG. 66 is a flowchart illustrating an example of a flow of MAF processing.

FIG. 67 is a block diagram illustrating a main configuration example of MAF.

FIG. 68 is a flowchart illustrating an example of a flow of MAF processing.

FIG. 69 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. Documents and the like Supporting Technical Content and Technical Terms
2. Scene Description and V-DMC
3. V-DMC Data Distribution using Scene Description
4. First Embodiment (File Generation Device)
5. Second Embodiment (Reproduction Device)
6. Supplementary Note
   <1. Documents and the like Supporting Technical Content and Technical Terms>

The scope disclosed in the present technology includes, in addition to the contents disclosed in the embodiments, contents described in following Non-Patent Documents and the like known at the time of filing, the contents of other documents referred to in following Non-Patent Documents and the like.
Non-Patent Document 1: (As described above)
Non-Patent Document 2: (As described above)
Non-Patent Document 3: (As described above)
Non-Patent Document 4: (As described above)
Non-Patent Document 5: (As described above)
Non-Patent Document 6: (As described above)
Non-Patent Document 7: (As described above)
Non Patent Document 8: (As described above)

That is, the contents described in the above-described Non Patent Documents, the contents of other documents referred to in the above-described Non Patent Documents, and the like are also basis for determining the support requirement.

### <2. Scene Description and V-DMC>

<gltf2.0>

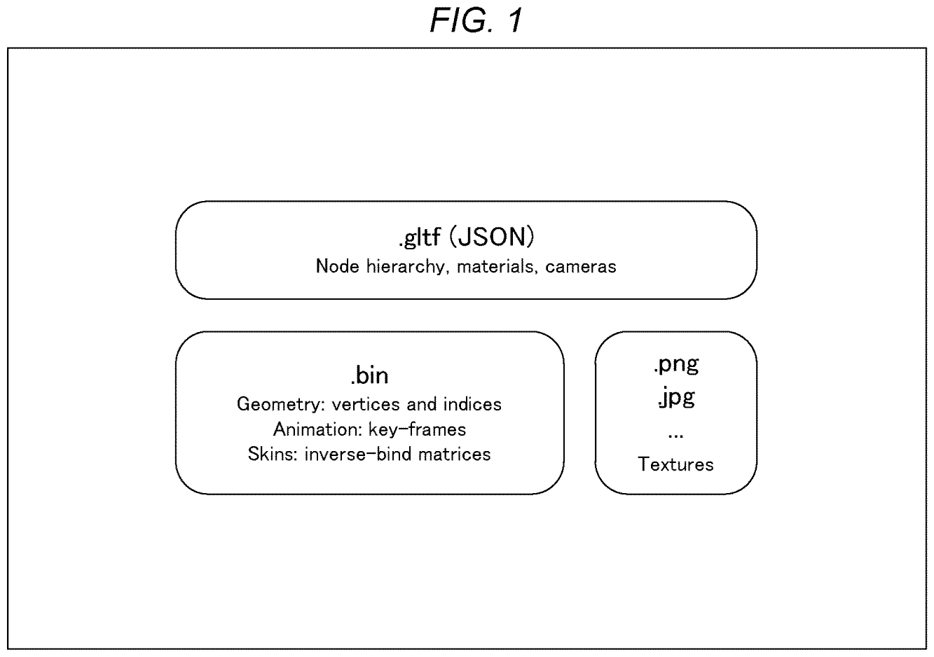

Conventionally, for example, as described in Non-Patent Document 1, there is a glTF (The GL Transmission Format) (registered trademark) 2.0 which is a format of a scene description (Scene Description) for arranging and rendering a 3D (three-dimensional) object in an area (for example, a three-dimensional space). For example, as illustrated in FIG. 1, the glTF2.0 includes a JSON format file (.glTF), a binary file (.bin), and an image file (.png, .jpg, or the like). The binary file stores binary data such as geometry and animation. The image file stores data such as texture.

The JSON format file is a scene description file described in JavaScript (registered trademark) Object Notation (JSON). A scene description is metadata describing (a description of) a scene of a 3D content. A description of the scene description defines what kind of scene the scene is. The scene description file is a file that stores such a scene description.

A description of the JSON format file includes a list of pairs of a key (KEY) and a value (VALUE). An example of a format of the description will be described below.

### “KEY”: “VALUE”

The key includes a character string. The value includes a numerical value, a character string, a true/false value, an array, an object, null, or the like.

Furthermore, a plurality of pairs of a key and a value (“KEY”: “VALUE”) can be put together using { } (braces). A pair put together in braces is also referred to as a JSON object. An example of a format of the description will be described below. “user”: {“id”: 1, “name”: “tanaka”}

In the case of the example, a JSON object in which a pair of “id”: 1 and a pair of “name”: “tanaka” are put together is defined as a value corresponding to a key (user).

Furthermore, zero or more values can be made to be an array by using [ ] (square brackets). The array is also referred to as a JSON array. For example, a JSON object can be applied as an element of the JSON array. An example of a format of the description will be described below.

```
  “test”:[“hoge”, “fuga”, “bar”]
  “users”:[{“id”:1,
“name”:“tanaka”},{“id”:2,“name”:“yamada”},{“id”:3,
“name”:“sato”}]
```

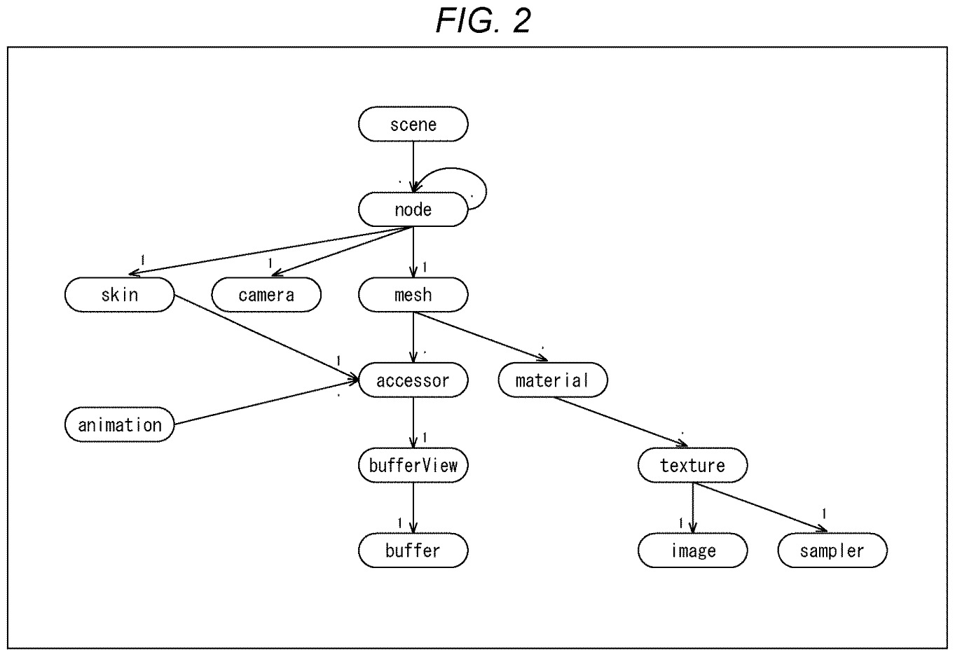

FIG. 2 illustrates glTF objects that can be described at the top of the JSON format file and a reference relationship that they have. Long circles in the tree structure illustrated in FIG. 2 indicate objects, and arrows between the objects indicate reference relationships. As illustrated in FIG. 2, objects such as “scene”, “node”, “mesh”, “camera”, “skin”, “material”, and “texture” are described at the top of the JSON format file.

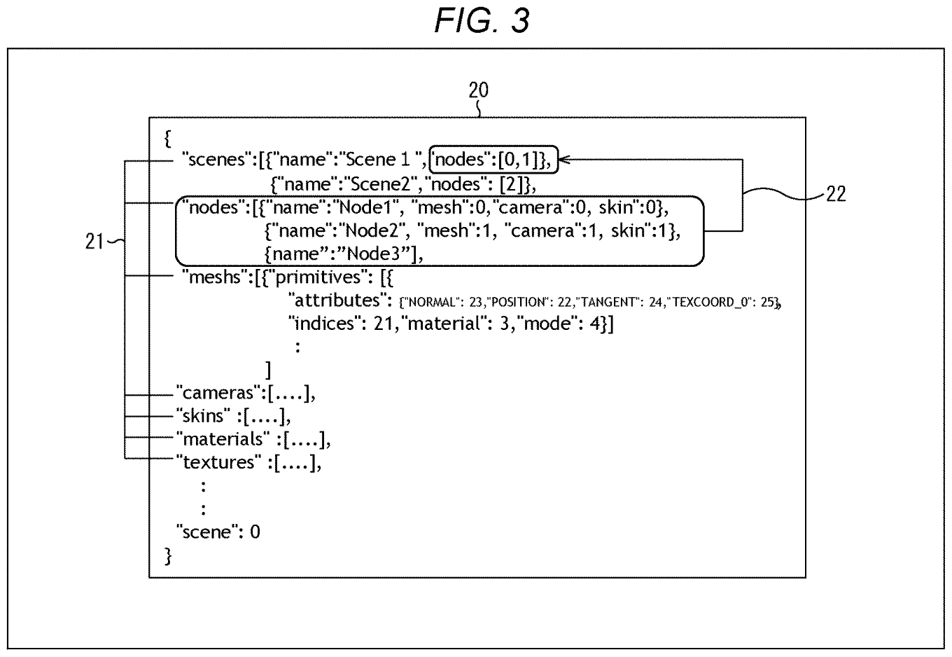

FIG. 3 illustrates a description example of such a JSON format file (scene description). A JSON format file 20 of FIG. 3 illustrates a description example of part of the top. In the JSON format file 20, top-level objects (top-level object) 21 used are all described at the top. The top-level objects 21 are the glTF objects illustrated in FIG. 2. Furthermore, in the JSON format file 20, as indicated as an arrow 22, a reference relationship between objects (object) is indicated. More specifically, the reference relationship is indicated by designating an index (index) of an element of an array of an object to be referred to with a property (property) of a superior object.

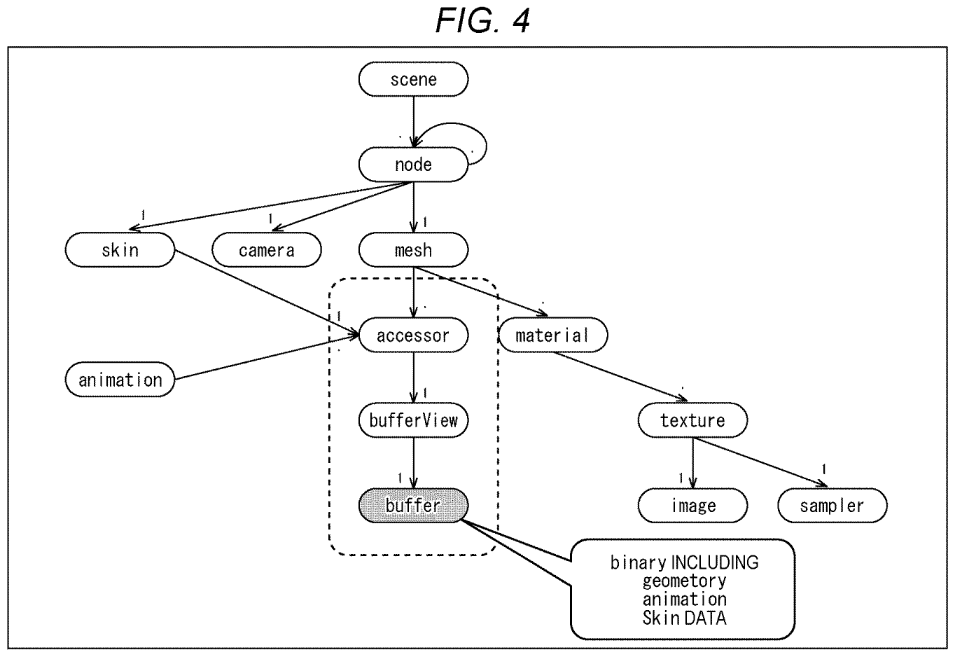

FIG. 4 is a diagram for describing a method of accessing binary data. As illustrated in FIG. 4, the binary data is stored in a buffer object (buffer object). That is, information (for example, a uniform resource identifier (URI) or the like) for accessing the binary data in the buffer object is indicated. In the JSON format file, as illustrated in FIG. 4, it is possible to access the buffer object via an accessor object (accessor object) and a buffer view object (bufferView object), for example, from objects such as a mesh (mesh), a camera (camera), and a skin (skin).

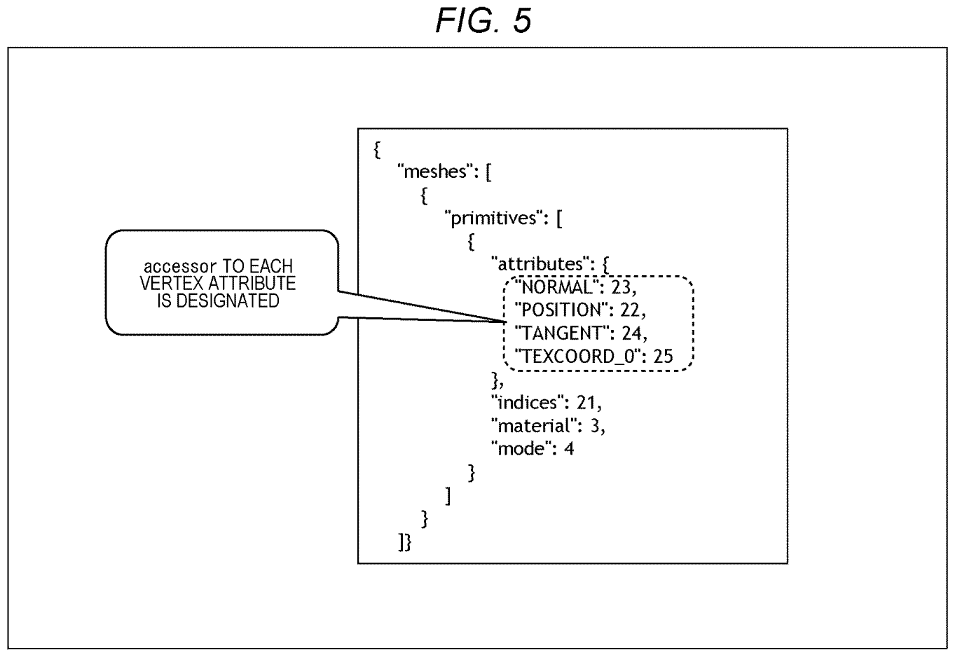

That is, in an object such as the mesh (mesh), the camera (camera), or the skin (skin), an accessor object to be referred to is designated. FIG. 5 illustrates a description example of the mesh object (mesh) in the JSON format file. For example, as illustrated in FIG. 5, in the mesh object, attributes (attribute) of vertices such as NORMAL, POSITION, TANGENT, and TEXCORD 0 are defined as keys, and an accessor object to be referred to is designated as a value for each attribute.

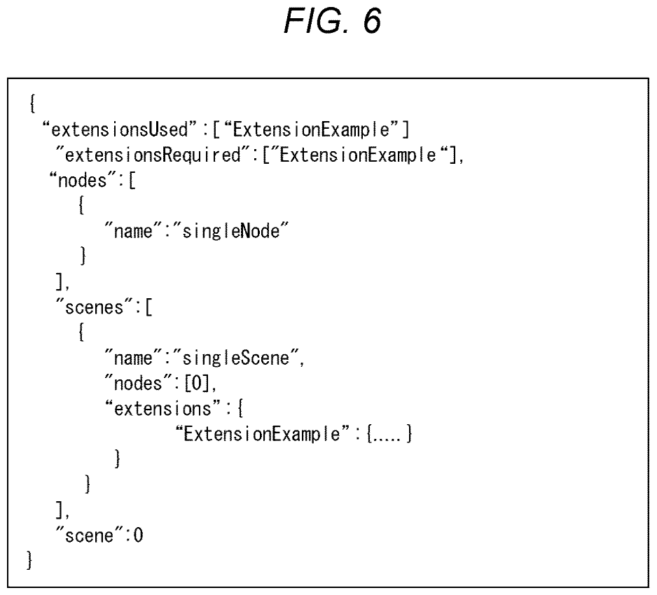

Next, extension of an object of such a scene description will be described. Each object of glTF2.0 may store a newly defined object in an extension object (extension object). FIG. 6 illustrates a description example in a case where a newly defined object (ExtensionExample) is specified. As illustrated in FIG. 6, in a case where a newly defined extension is used, the extension object name (in the example of FIG. 6, ExtensionExample) is described in “extensionUsed” and “extensionRequired”. As a result, it is indicated that the extension is an extension that is used or is an extension required for loading (load).

### <Client Processing>

The MPEG-I scene description is a standard for controlling reproduction of a 6DoF visual using such a scene description conforming to the glTF2.0. Here, the visual is visual information (information transmitted using vision) such as an image, and the 6DoF visual indicates a visual corresponding to movement (so-called free viewpoint) of six degrees of freedom (6DoF) of a viewer (a receiver of the visual information). That is, in the MPEG-I scene description, reproduction of the 6DoF visual (that is, reproduction of the visual scene) is controlled using the scene description representing the visual scene. Here, the visual scene indicates a scene related to a visual. A visual scene includes visual objects arranged in an area (for example, a three-dimensional space). A visual object is an object (object) existing in an area, and is configured visually. That is, the reproduction device in the MPEG-I scene description reproduces the 6DoF visual and reconstructs the visual scene indicated by the scene description.

The scene description conforming to the MPEG-I scene description expresses a visual scene including a high-definition visual object. Note that, in the present specification, a scene description conforming to an MPEG-I scene description may also be referred to as an MPEG-I scene description.

Next, processing of the client device in the MPEG-I scene description will be described. The client device acquires a scene description, acquires data of a 3D object on the basis of the scene description, and generates a display image using the scene description and the data of the 3D object.

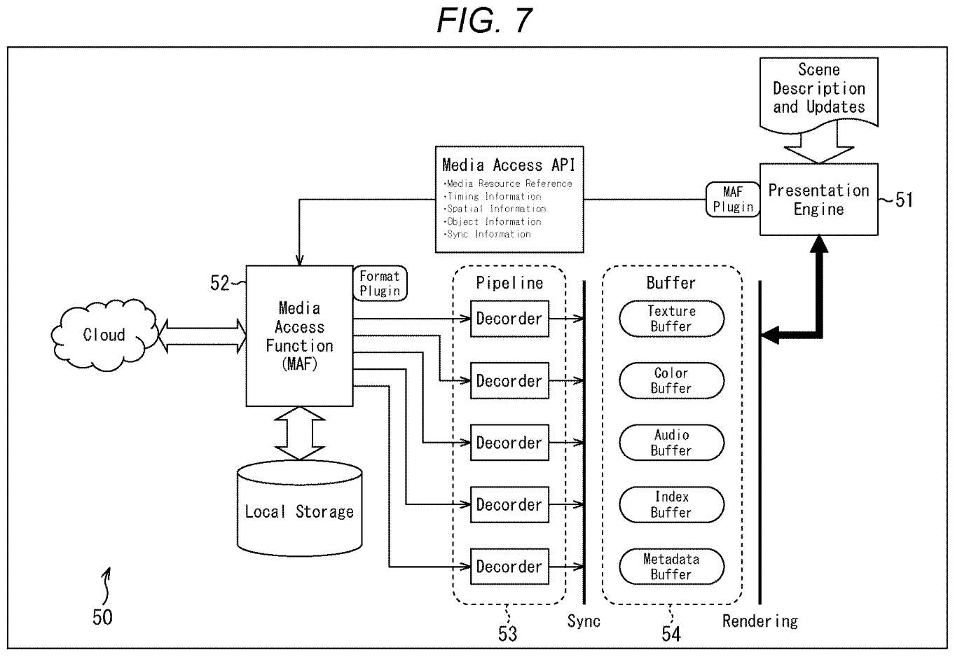

As described in Non-Patent Document 2, in the client device, a presentation engine, a media access function, or the like performs processing. For example, as illustrated in FIG. 7, a presentation engine (Presentation Engine) 51 of a client device 50 acquires an initial value of a scene description and information (hereinafter, also referred to as update information) for updating the scene description, and generates the scene description at the processing target time. Then, the presentation engine 51 parses the scene description and specifies a medium (moving image, audio, or the like) to be reproduced. Then, the presentation engine 51 requests a media access function (Media Access Function) 52 to acquire the medium via a media access API (Media Access API (Application Program Interface)). Furthermore, the presentation engine 51 also performs setting of a pipeline process, designation of a buffer, and the like.

The media access function 52 acquires various pieces of data of media requested by the presentation engine 51 from a cloud (Cloud), a local storage (Local Storage), or the like. The media access function 52 supplies the acquired various pieces of data (coded data) of the media to a pipeline (Pipeline) 53.

The pipeline 53 decodes various pieces of data (coded data) of the supplied media by a pipeline process, and supplies a decoding result to a buffer (Buffer) 54. The buffer 54 holds various pieces of data of the supplied medium.

The presentation engine 51 performs rendering (Rendering) or the like using various pieces of data of the media held in the buffer 54.

### <Application of Timed Media>

In recent years, for example, as described in Non-Patent Document 2, in the MPEG-I scene description, it has been studied to extend the glTF 2.0 and to apply a timed medium (Timed media) as 3D object content. The timed media is media data that changes in the time axis direction like a moving image in a two-dimensional image. The glTF has been applicable only to still image data as media data (3D object content). That is, the glTF has not been applicable to media data of a moving image. In a case where a 3D object is moved, animation (a method of switching a still image along the time axis) has been applied.

In the MPEG-I scene description, it has been studied to apply the glTF 2.0, apply a JSON format file as a scene description, and further extend the glTF so that timed media (for example, video data) can be handled as media data. In order to handle timed media, for example, an extension is performed as below.

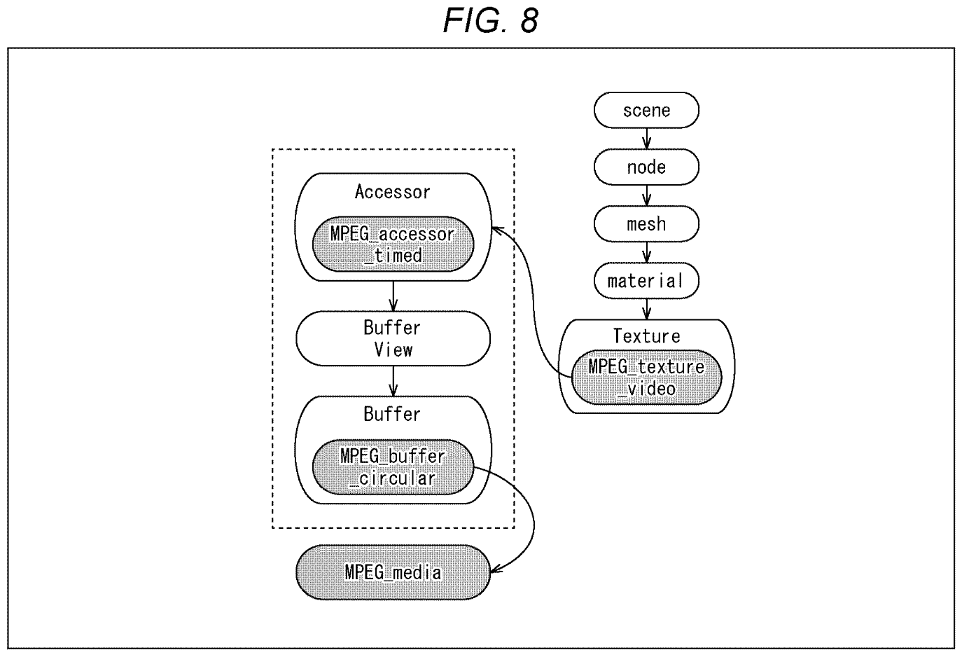

FIG. 8 is a diagram for describing the extension for handling timed media. In the example in FIG. 8, an MPEG media object (MPEG media) is an extension of glTF, and is an object that designates attributes of MPEG media such as video data, for example, uri, track, startTime, and the like.

Furthermore, as illustrated in FIG. 8, an MPEG texture video object (MPEG texture video) is provided as an extension object (extensions) of the texture object (texture). In the MPEG texture video object, information about an accessor corresponding to a buffer object to be accessed is stored. That is, the MPEG texture video object is an object that designates an index of an accessor (accessor) corresponding to a buffer (buffer) in which texture media (texture media) designated by the MPEG media object (MPEG media) are decoded and stored.

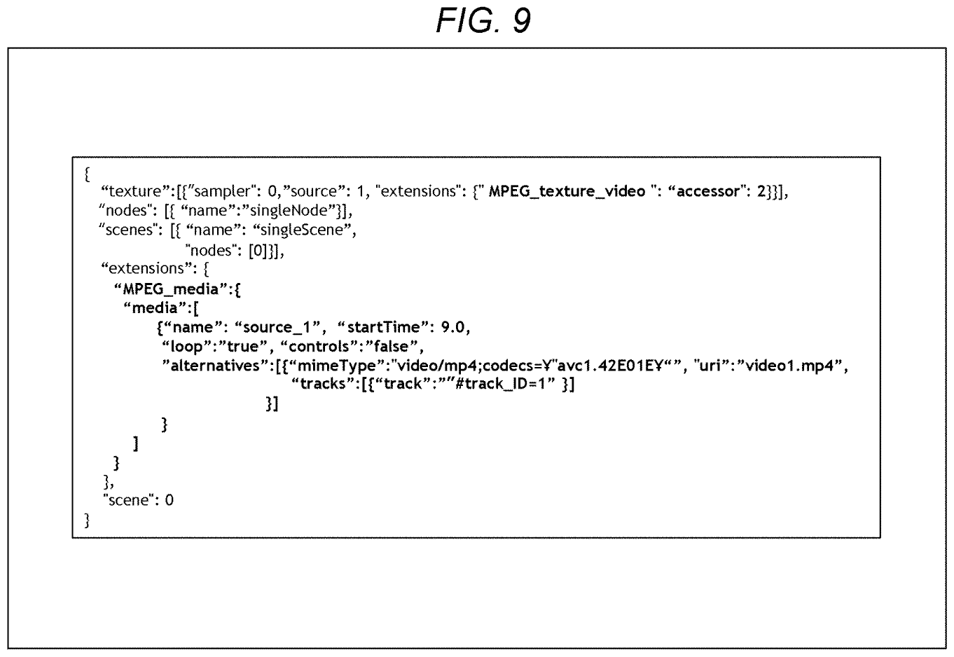

FIG. 9 is a diagram illustrating a description example of an MPEG media object (MPEG media) and an MPEG texture video object (MPEG texture video) in a scene description for describing an extension for handling timed media. In the case of the example of FIG. 9, in the second line from the top, an MPEG texture video object (MPEG texture video) is set as an extension object (extensions) of a texture object (texture) as described below. Then, the index (“2” in this example) of the accessor is designated as a value of the MPEG video texture object.

“texture”: [{“sampler”: 0, “source”: 1, “extensions”: {“MPEG texture video”: “accessor”: 2}],

Furthermore, in the case of the example of FIG. 9, in the seventh to 16 lines from the top, an MPEG media object (MPEG media) is set as an extension object (extensions) of the glTF as described below. Then, as values of the MPEG media object, various pieces of information related to the MPEG media object are stored, for example, coding and URI of the MPEG media object, and the like.

```
  “MPEG_media”:{
  “media”:[
  {“name”:“source_1”, “startTime”:9.0,
  “loop”:“true”, “controls”:“false”,
  “alternatives”:[{“mimeType”:”video/mp4;codecs=¥”avc
1.42E01E¥””, “uri”:”video1.mp4”,
  “tracks”:[{“track”:””#track_ID=1”}]
  }]
  }
  ]
  }
```

In addition, each frame data is decoded and sequentially stored in a buffer, but its position and the like fluctuate. Therefore, the scene description has a mechanism to store the fluctuating information so that the renderer (renderer) can read the data. For example, as illustrated in FIG. 8, an MPEG buffer circular object (MPEG buffer circular) is provided as an extension object (extensions) of the buffer object (buffer). Information for dynamically storing data in the buffer object is stored in the MPEG buffer circular object. For example, information such as access information to MPEG media and information indicating the number of frames is stored in the MPEG buffer circular object.

Further, as illustrated in FIG. 8, an MPEG accessory timed object (MPEG accessor timed) is provided as an extension object (extensions) of the accessory object (accessor). In this case, since the media data is a moving image, the buffer view object (bufferView) to be referred to in the time direction can change (the position can change). Thus, information indicating the buffer view object to be referred to is stored in the MPEG accessor timed object. For example, the MPEG accessor timed object stores information indicating a reference to the buffer view object (bufferView) in which a timed accessor information header (timedAccessor information header) is described. Note that the timed accessor information header is, for example, header information that stores information in the dynamically changing accessor object and buffer view object.

### <V-PCC Support>

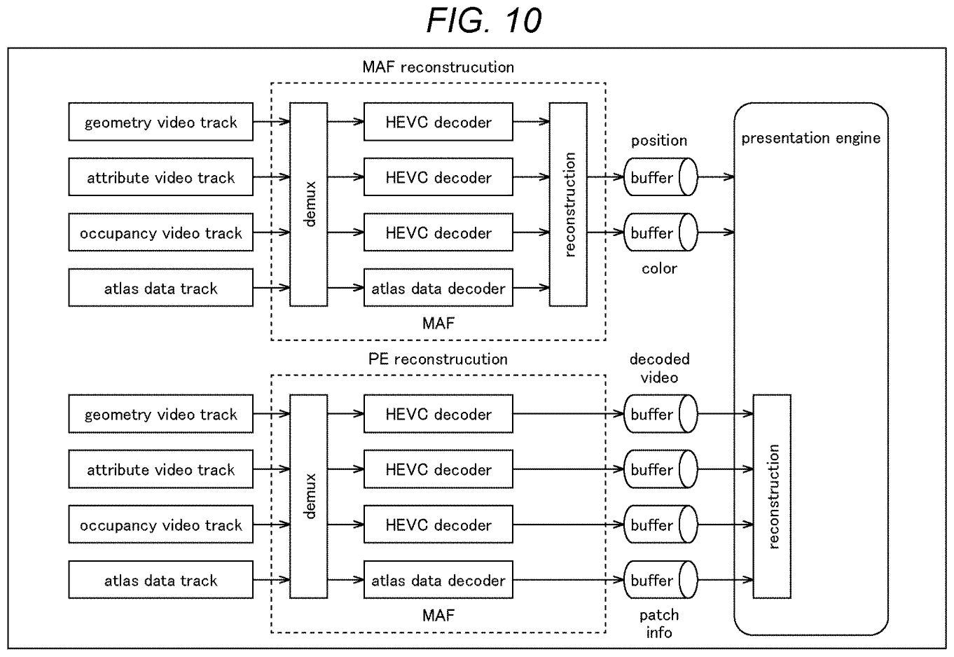

The MPEG-I scene description supports video-based point cloud compression (V-PCC) which is a point cloud coding scheme which is one of 3D data. Non-Patent Document 3 proposes, as a method of reconstructing a point cloud, a method of reconstructing (MAF reconstruction) in a media access function (MAF) and a method of reconstructing (PE reconstruction) in a presentation engine (PE) as illustrated in FIG. 10.

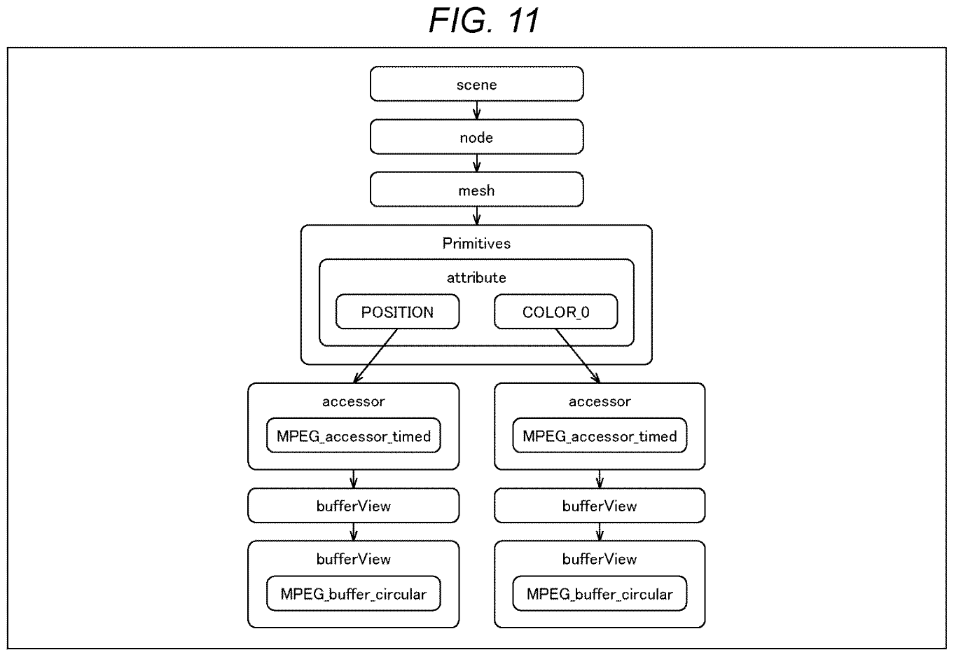

In the case of MAF reconstruction, a point cloud can be reconstructed using a central processing unit (CPU). In this case, the buffer stores the geometry data (position) and the attribute data (color) of the reconstructed 3D data. That is, the reconstructed 3D data is supplied to the PE. The scene description is configured as illustrated in FIG. 11. In the position property (POSITION property) of the attributes object in mesh. primitives, an accessor (accessor) to a buffer (buffer) that stores position information about the point (Point) is designated. Similarly, in the color property (COLOR property) of the attributes object, an accessor (accessor) to a buffer (buffer) that stores color information about the point (Point) is designated.

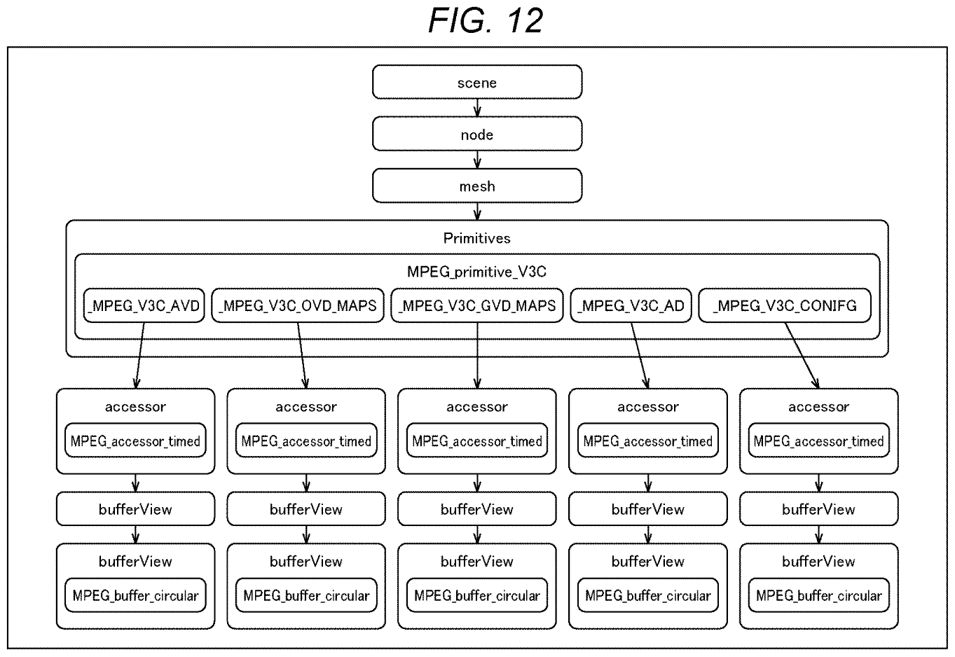

In the case of PE reconstruction, a point cloud can be reconstructed and rendered using a graphics processing unit (GPU). In this case, the V-PCC data before reconstruction (video data (decoded video) such as a geometry, an attribute, and an ocupuncture, and atlas information (patch info)) is stored in the buffer. That is, the V-PCC data before the reconstruction is supplied to the PE. The scene description is configured as illustrated in FIG. 12. Properties such as MPEG_V3C_AVD, MPEG_V3C OVD MAPS, MPEG_V3C_GVD MAPS, MP EG_V3C_AD, and MPEG_V3C CONFIG are formed in the attributes object in mesh. primitives, and an access to a buffer that stores V-PCC data before reconstruction is designated.

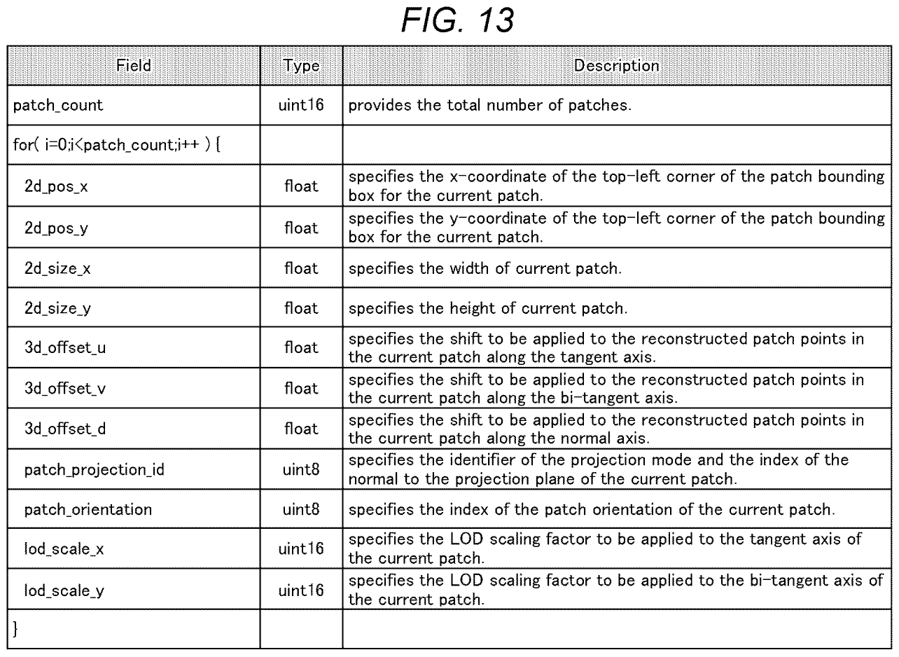

An example of atlas information is illustrated in FIG. 13. As illustrated in FIG. 13, the atlas information includes patch information related to the patch, and the patch such as the geometry, the attribute, and the augmentation map can be identified by referring to the patch information. Therefore, at the time of reconstruction, patches of each video can be associated.

### <Mesh>

Meanwhile, as 3D data representing a three-dimensional structure of a three-dimensional structure object (object having a three-dimensional shape), there is a mesh (Mesh) representing a three-dimensional shape of an object surface by forming polygons by vertices and connections (also referred to as edges).

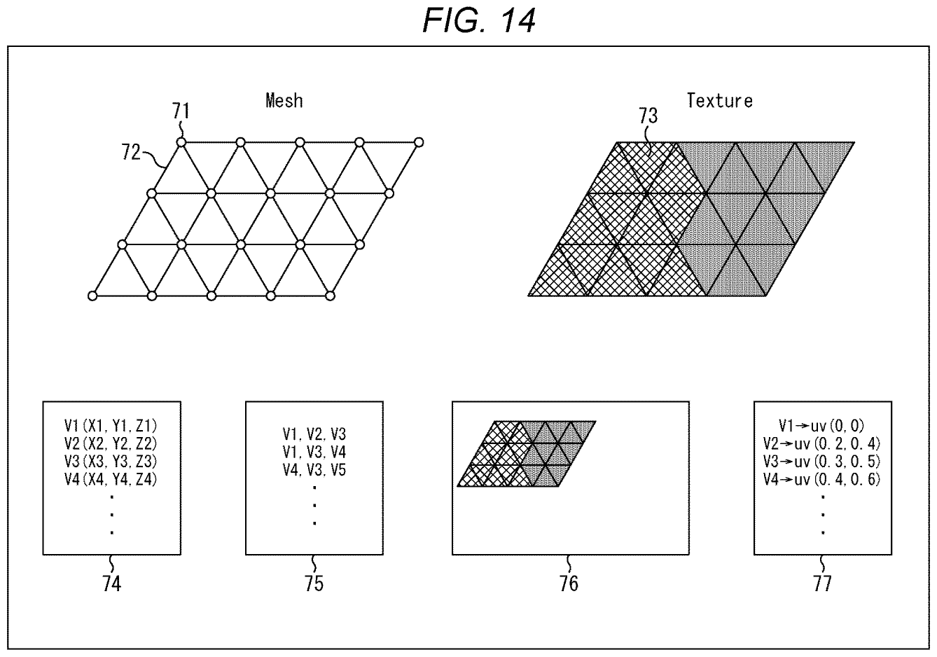

As illustrated in the upper left part of FIG. 14, in the mesh (Mesh), a polygonal plane (polygon) is formed by vertices 71 and connections 72 connecting the vertices 71. In the following description, it is assumed that the polygon has a triangular shape. The surface of the object having the three-dimensional structure, that is, the three-dimensional shape of the object is expressed by the polygon (also referred to as a face). Note that a texture (Texture) 73 as illustrated in the upper right part of FIG. 14 can be attached (also referred to as applied) to each face of the mesh.

The data of the mesh includes, for example, information as illustrated in the lower part of FIG. 14. Vertex information 74 illustrated first from the left in the lower part of FIG. 14 is information indicating the three-dimensional position (three-dimensional coordinates (X, Y, Z)) of each vertex 71 constituting the mesh. Connection information 75 illustrated second from the left in the lower part of FIG. 14 is information indicating each connection (edge) 72 constituting the mesh. A texture image 76 illustrated third from the left in the lower part of FIG. 14 is map information of the texture 73 attached to each face. A UV map 77 illustrated fourth from the left in the lower part of FIG. 14 is information indicating the correspondence between the vertex 71 and the texture 73. In the UV map 77, coordinates (UV coordinates) of each vertex 71 in the texture image 76 are illustrated.

Note that the mesh data can change in the time direction like a moving image of 2D data. That is, the mesh data can have a structure in which frames including mesh data representing three-dimensional structures at different timings are continuous.

### <V-DMC>

As a coding method of such a mesh, for example, there is video-based dynamic mesh coding (V-DMC) as disclosed in Non-Patent Document 4 to Non-Patent Document 7.

In V-DMC, a mesh to be coded (referred to as an original mesh in the present specification) is expressed by a base mesh having low definition (that is, coarse) than the original mesh and a displacement vector of a division point obtained by subdividing the base mesh, and the base mesh and the displacement vector are coded. For example, a dynamic mesh stream generated by camera capture, the dynamic mesh (Dynamic Mesh) stream being (Non-registered) mesh data having a structure that changes every frame, is to be coded.

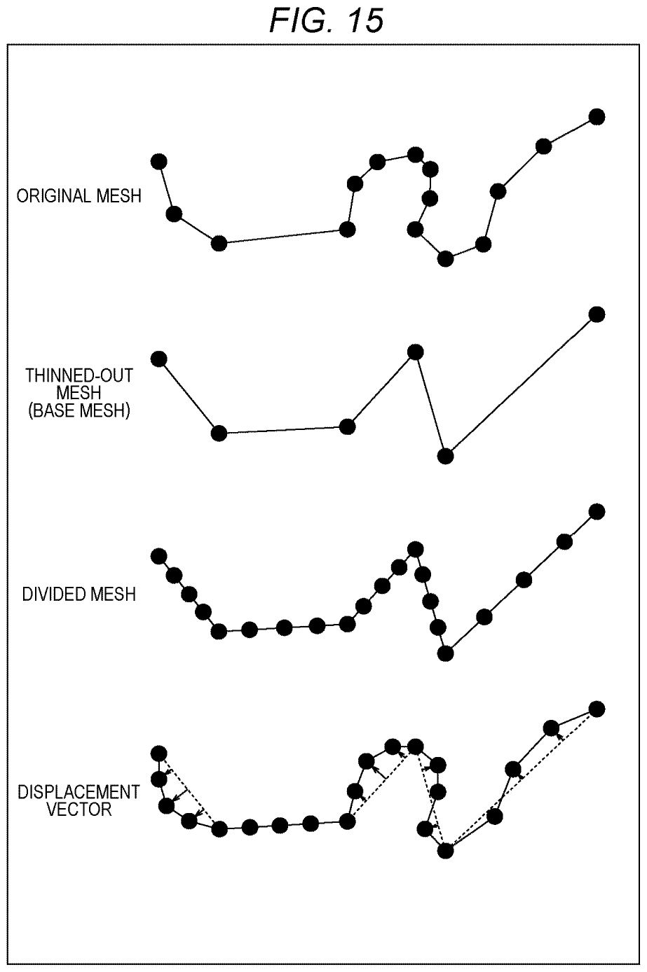

For example, it is assumed that there is an original mesh as illustrated in the uppermost part of FIG. 15. In FIG. 15, a black dot indicates a vertex, and a line connecting the black dots indicates a connection (edge). As described above, the mesh originally forms a surface (polygon) by vertices and edges in a space, but here, for convenience of description, the mesh is described as a vertex group linearly (in series) connected in a plane.

By decimating (Decimate) some vertices of the original mesh, a coarse (low definition) mesh as illustrated in the second part from the top in FIG. 15 is formed. This is referred to as a base mesh.

By subdividing (Subdivide) each polygon of this base mesh, vertices and edges are added as illustrated in the third part from the top in FIG. 15. For example, by this subdivision, vertices can be added by the number obtained by decimating the original mesh. That is, by subdividing the base mesh, a mesh having the same number of vertices as the original mesh are obtained. In the present specification, vertices added by such subdivision is also referred to as division points.

However, the connections have been updated when the vertices of the original mesh are decimated, and division points are formed on theses updated connections (edges). Therefore, even if the number of vertices is made the same as that of the original mesh by subdivision, the positions of the vertices of the subdivided base mesh (the third part from the top in FIG. 15) are different from the positions of the vertices of the original mesh (the uppermost part in FIG. 15). In other words, as illustrated in the lowermost part of FIG. 15, ideally, the original mesh can be restored by moving (displacing) the positions of the vertices of the subdivided base mesh to the vertex positions of the original mesh. In the present specification, one indicating such displacement (movement) of the vertex as a vector is referred to as a displacement vector.

That is, ideally, the original mesh can be expressed as a base mesh and a displacement vector. By expressing the original mesh as the base mesh and the displacement vector in this manner, the number of polygons (that is, the number of vertices and the number of edges) is reduced. Therefore, by coding the base mesh and the displacement vector instead of coding the original mesh, it is possible to suppress a reduction in the coding efficiency (increase in the amount of code).

That is, in V-DMC, V-DMC data including a base mesh, a displacement vector, an attribute (texture), and atlas information is generated from 3D data such as the mesh data as illustrated in FIG. 14, and the V-DMC data is coded. The atlas information is information necessary for reconstructing the mesh, and includes, for example, information indicating a correspondence relationship between the base mesh, the displacement vector, and the texture. For example, the atlas information may include information that associates patches of a mesh with patches of an attribute, such as the UV map 77 of FIG. 14.

As described above, since the mesh data can change in the time direction, the mesh data has a structure in the time direction (continuous frame structure). Therefore, in V-DMC, the mesh data is divided and processed according to the structure in the time direction. The processing unit in the time direction is referred to as a sample. That is, coding and decoding are performed using one frame or a plurality of consecutive frames of the mesh data as one sample. In general, one frame of the mesh data is one sample.

The samples may be intra coded independently of other samples, or may be inter coded using other samples (other frames) as key samples (key frames).

At the time of coding the V-DMC data, the base mesh, the displacement vector, the attribute (texture), and the atlas information constituting the V-DMC data are coded.

The atlas information is coded by a predetermined method. The displacement vector is packed into a frame image (also referred to as a displacement map or a geometry map) and coded as a moving image (also referred to as a displacement video or a geometry video) using a coding scheme for a moving image. The attribute (texture) is packed into a frame image (also referred to as a texture image or an attribute map) and coded as a moving image (also referred to as a texture video or an attribute video) using a coding scheme for a moving image.

On the other hand, in the case of intra coding, the base mesh is coded independently of other samples by a predetermined coding scheme (for example, Draco or the like), and in the case of inter coding, a difference from a key sample is derived and the difference is coded. Note that, in a case where there is no difference between the sample to be processed and the key sample (in a case where the sample to be processed is the same as the key sample), the coding can be skipped. That is, the base mesh is coded as 3D data.

One bit stream (also referred to as V-DMC bit stream) is generated by using the bit stream of each piece of data generated in this manner as a sub stream. Therefore, the V-DMC bit stream includes a substream of atlas information (atlas data substream), a substream of a base mesh (basemesh substream), a substream of a geometry video (geometry video substream), and a substream of an attribute video (attribute video substream).

The substream of the atlas information has information for associating a patch of a mesh (submesh), a patch of a geometry (displacement video), and a patch of an attribute with each other. The substream of the base mesh has a static mesh (intra-frame) and motion information (inter-frame). After decoding, the base mesh is plane-divided (subdivided) on the basis of the subdivision information indicated in the substream of atlas information (the number of faces increases). The substream of the geometry video is a substream of the displacement video and has a displacement vector. It has displacement vectors in the order of iteration count of the subdivision. Each vertex is associated in decoding order. The substream of the attribute video has a UV texture. The geometry video substream and the attribute video substream coded by the coding scheme for moving images are also collectively referred to as video components.

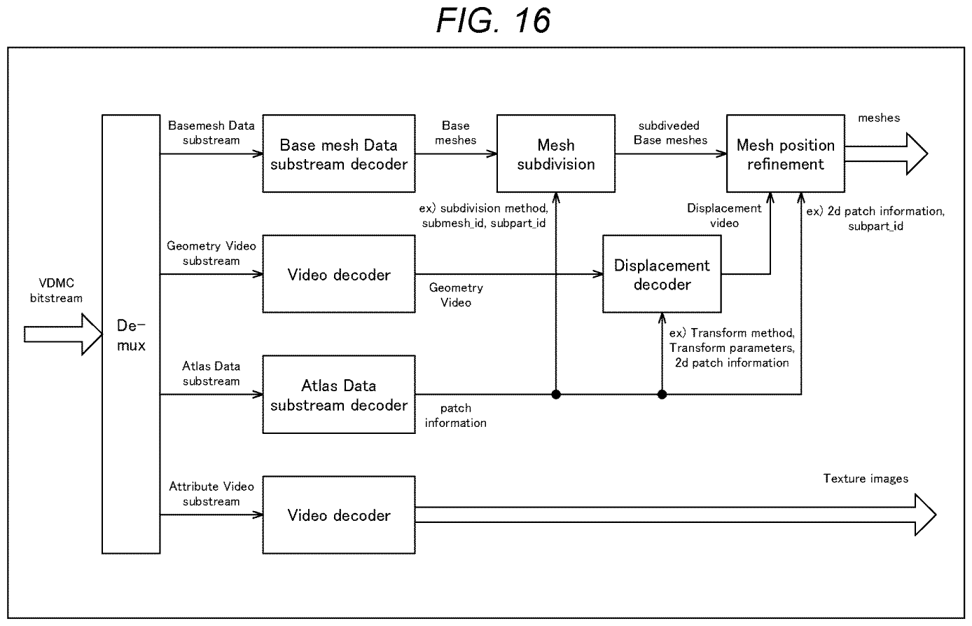

FIG. 16 is a diagram illustrating a configuration example of a decoder of a V-DMC bit stream. The V-DMC bit stream is divided into respective substreams of the base mesh, the displacement vector, the attribute (texture), and the atlas information by demultiplexing, and each substream is decoded by a decoding method corresponding to each coding method. That is, the base mesh is decoded by a decoding scheme for 3D data. The displacement vector (geometry video) and the attribute (attribute video) are decoded by a decoding scheme for moving images (that is, 2D data). The atlas information is decoded in a predetermined scheme.

Then, as described above, the base mesh is subdivided on the basis of the atlas information, the displacement vectors are applied to the vertices (that is, the vertices are displaced), and the texture is applied to the faces, so that the mesh is reconstructed (a restored mesh is generated).

### <Submesh>

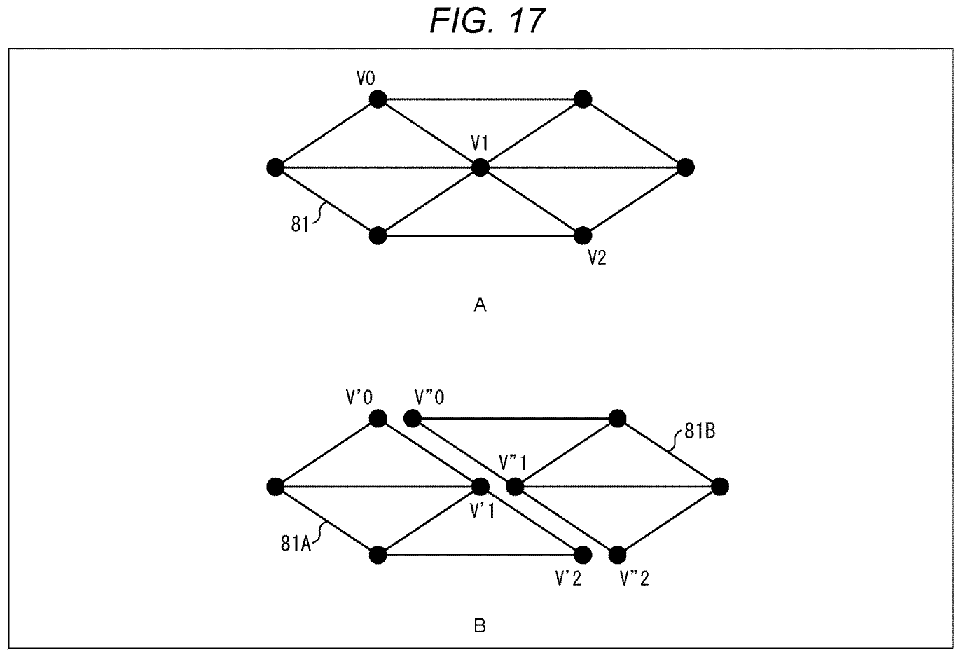

Incidentally, the mesh (base mesh in the case of V-DMC) may include one or more submeshes. The submesh is a unit of coding processing in the spatial direction (area direction). That is, the submeshes can be coded independently of each other. For example, if a mesh 81 illustrated in A of FIG. 17 is divided into a submesh 81A and a submesh 81B as illustrated in B of FIG. 17, the submesh 81A and the submesh 81B can be independently coded. As a result, the submesh 81A and the submesh 81B can be decoded independently of each other. That is, only the submesh 81A can be decoded, or only the submesh 81B can be decoded. That is, only a desired part of the mesh can be decoded, and an unnecessary increase in the decoding processing amount can be suppressed. As a result, an increase in the load and processing time of the decoding processing can be suppressed.

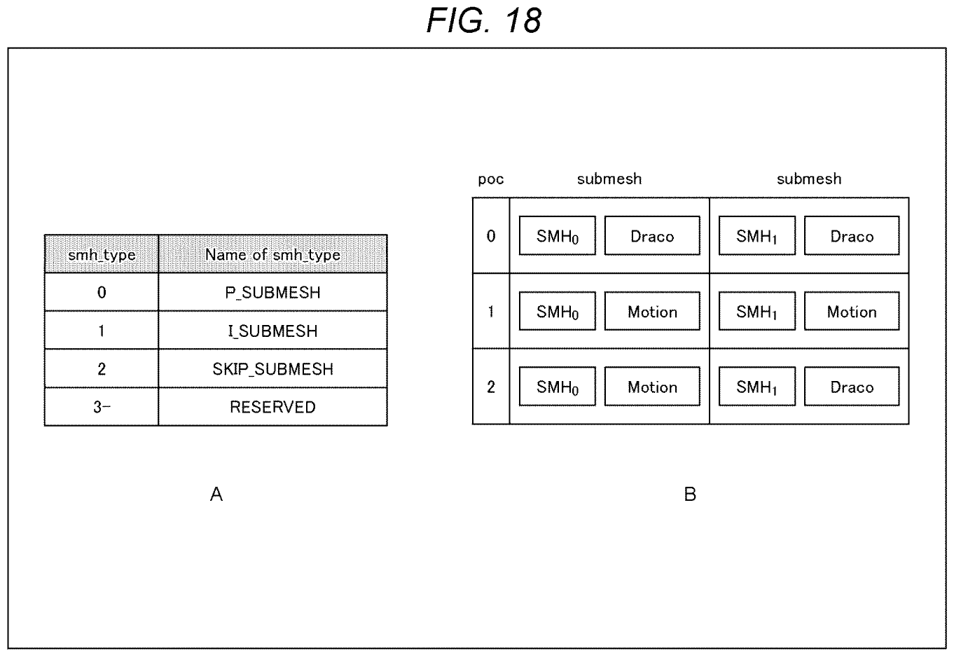

Furthermore, for example, it is also possible to perform intra coding on the submesh 81A and inter coding on the submesh 81B. For example, as illustrated in A of FIG. 18, three types of I, P, and Skip are prepared as the type (coding type) of the coding method of the submesh. I indicates intra coding. That is, the submesh for which the type I is designated is coded independently of the others. P indicates inter coding. That is, differences (motion information) from other reference samples are coded in the submesh for which the type P is designated. Skip indicates skipping of coding. That is, coding of the sample is skipped, and the other reference samples are repeated. Note that the reference sample is a submesh having the same submesh ID as the current sample.

As illustrated in B of FIG. 18, such a coding type (smh type) is managed for each sample (POC) of each submesh. Therefore, in each sample, the coding scheme can be set for each submesh. Note that the submesh ID (submesh id) and the coding type (smh type) are managed in the submesh header.

### <Distribution of V-DMC Bit Stream>

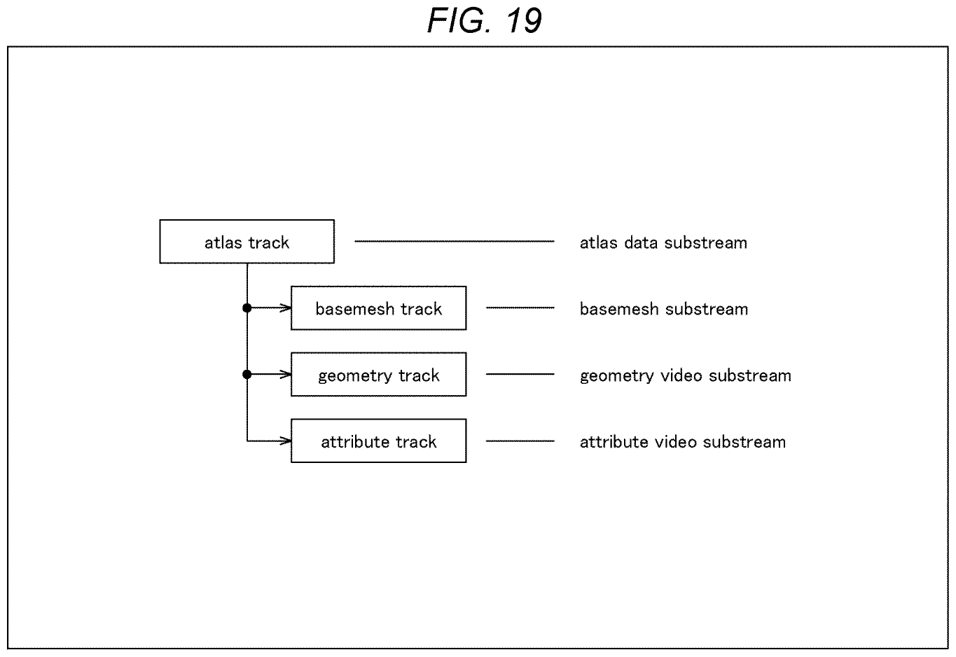

In recent years, establishment of a method of storing such a V-DMC stream in the International Organization for Standardization base media file format (ISOBMFF) or the like and distributing the V-DMC bit stream is expected. ISOBMFF is a file container specification of the international standard technology of moving image compression “MPEG-4 (Moving Picture Experts Group-4) “. For example, it can be assumed that ISO/IEC 23090-10, which is the distribution technology standard of V-PCC as described in Non-Patent Document 8, is extended and a V-DMC bit stream is stored in the ISOBMFF. In this case, the V-DMC bit stream is stored in the track of the ISOBMFF. At that time, a method of storing the V-DMC bit stream in one track (single track) or a method of storing the respective substreams of the atlas information, the base mesh, the displacement vector, and the attribute in different tracks (multi-track) as illustrated in FIG. 19 can be considered.

According to the V-DMC coding as described above, Non-registered Mesh data can be transmitted at a higher compression rate than before, and support is expected as one of the coding techniques for 3D objects constituting a scene also in the MPEG-I scene description. However, the conventional MPEG-I scene description does not correspond to the V-DMC bit stream, and it is difficult to apply the MPEG-I scene description to distribution of the V-DMC bit stream. In other words, in the distribution of the 3D data to which the MPEG-I scene description is applied, it is difficult to apply the V-DMC coding scheme as the coding scheme of the 3D data. Therefore, there has been a possibility that coding efficiency is deteriorated.

<3. V-DMC Data Distribution using Scene Description

### <Method 1>

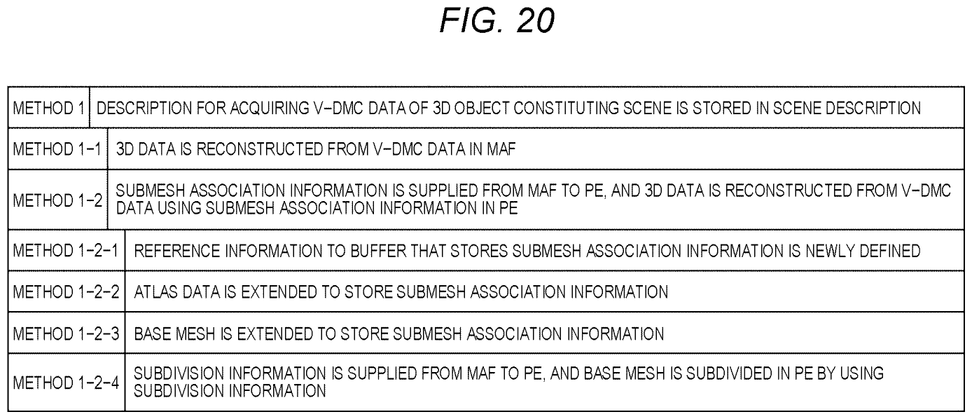

Therefore, as illustrated in the uppermost part of the table in FIG. 20, a description for acquiring the V-DMC data of the 3D object constituting the scene is stored in the scene description (Method 1). That is, V-DMC data can be handled in the scene description. By doing in this way, decrease in coding efficiency can be suppressed.

### <Method 1-1>

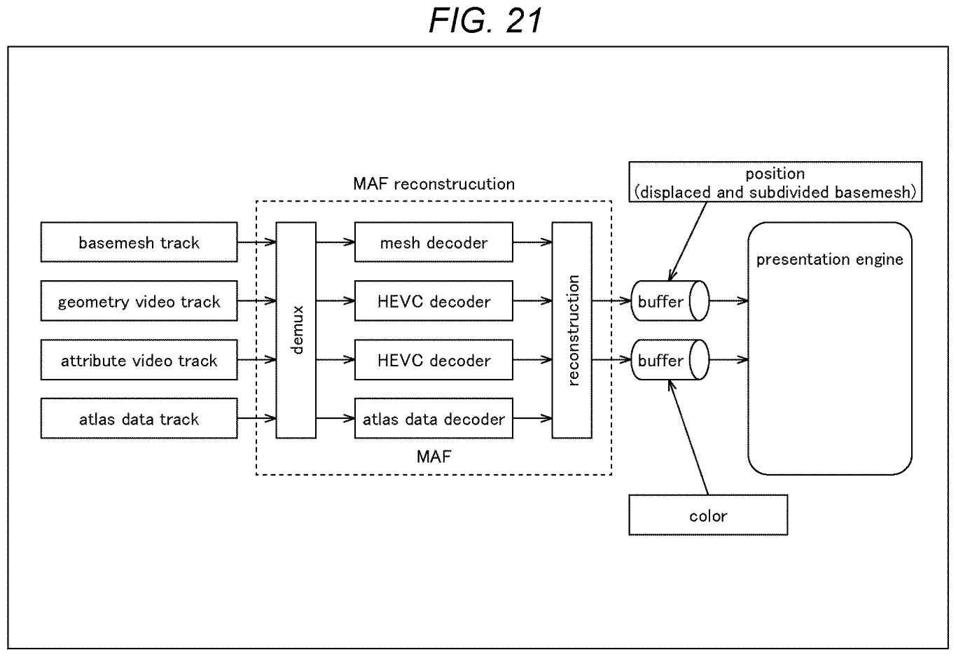

In a case where the MPEG-I scene description is applied to the distribution of the V-DMC data by applying Method 1, as illustrated in the second part from the top of the table in FIG. 20, 3D data may be reconstructed from V-DMC data in MAF (Method 1-1). The processing of reconstructing the 3D data from the V-DMC data may include subdivision (subdivision) of the base mesh, displacement (refinement) of vertices by displacement vectors (displacement), and mapping of attributes. That is, MAF reconstruction may be applied, and these pieces of processing may be executed in MAF. In the case of MAF reconstruction, these pieces of processing can be executed using a CPU. FIG. 21 illustrates an outline of processing in the case of MAF reconstruction. In this case, the buffer stores the geometry data (position) and the attribute data (color) of the reconstructed 3D data. That is, the reconstructed 3D data is supplied to the PE. Therefore, the scene description is configured similarly to the example of FIG. 11.

In this case, a first information processing device that generates the scene description sets, in the scene description, reference information to a buffer that stores the geometry of the 3D data reconstructed using the V-DMC data and reference information to a buffer that stores the attribute of the 3D data reconstructed using the V-DMC data. A second information processing device that decodes the V-DMC bit stream acquires and decodes the V-DMC bit stream in the MAF on the basis of the scene description, reconstructs the 3D data from the V-DMC data, and stores the geometry and the attribute of the reconstructed 3D data in the buffer. The PE of the second information processing device acquires the geometry and attributes of the reconstructed 3D data from the buffers on the basis of the scene description, and performs rendering or the like.

In this way, MAF reconstruction can be implemented. That is, the first information processing device and the second information processing device can implement distribution of V-DMC data using the scene description, and can suppress a decrease in coding efficiency in distribution of 3D data using the scene description.

### <Method 1-2>

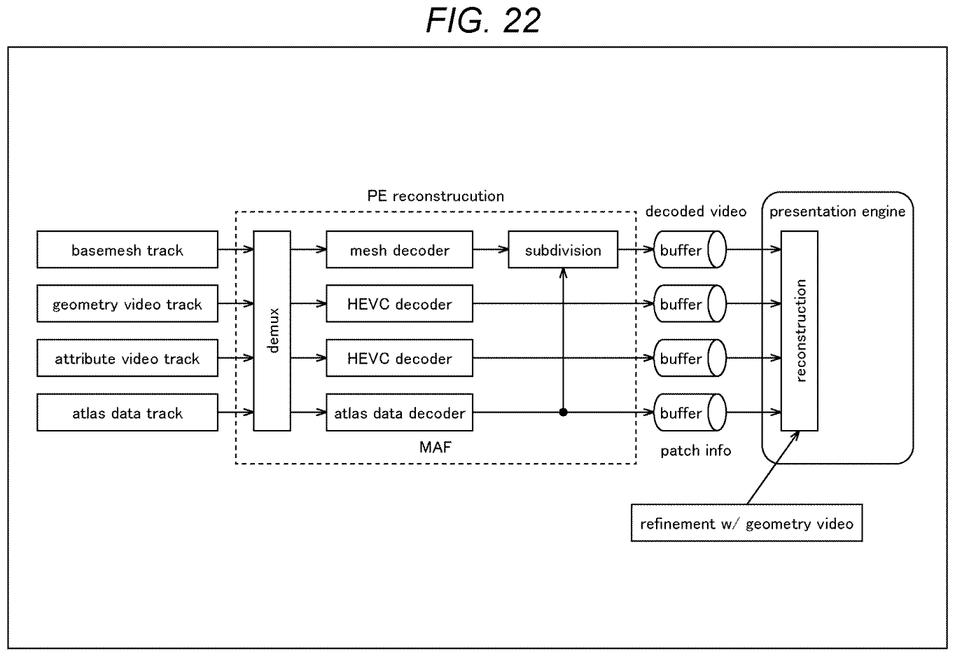

In a case where the MPEG-I scene description is applied to the distribution of the V-DMC data by applying Method 1, the PC may reconstruct the 3D data from the V-DMC data. That is, the PE reconstruction may be applied. For example, as illustrated in FIG. 22, subdivision (subdivision) of the base mesh may be performed in MAF, and displacement (refinement) of vertices by displacement vectors (displacement) and mapping of attributes may be performed in PE. In this case, the V-DMC data before being reconfigured is stored in the buffer. More specifically, the subdivided base mesh, displacement video, attribute video, and atlas information are each supplied to the PE via a buffer. The PE reconstructs the 3D data by performing displacement of the vertices and mapping of attributes using the V-DMC data. Furthermore, the PE may perform rendering or the like of the 3D data.

In the case of the PE reconstruction, since data is stored in a buffer, the execution timing of the processing of the PE can be controlled, and the processing of the PE can be processed by an arithmetic unit different from the processing of the MAF.

Therefore, the decoding processing can be executed more efficiently than in the case of the MAF reconstruction. Further, in the case of the PE reconstruction, the processing of the PE can be performed using, for example, a GPU. The GPU can execute parallel processing and pipeline processing more efficiently than the CPU. Therefore, by applying the PE reconstruction, the decoding processing can be executed more efficiently than in the case of the MAF reconstruction.

Incidentally, the displacement vector of the mesh is divided into a plurality of partial areas, and each partial area is projected on a two-dimensional plane. A “set of displacement vectors projected on a two-dimensional plane” corresponding to this partial area is also referred to as a patch of displacement vectors. The displacement map (displacement video) is packed with this patch of the displacement vectors. Similarly, the attribute of the mesh is divided into a plurality of partial areas, and each of the partial areas is projected onto a two-dimensional plane. A “set of attributes projected on a two-dimensional plane” corresponding to this partial area is also referred to as a patch of attributes. The attribute map (attribute video) is packed with this patch of the attributes.

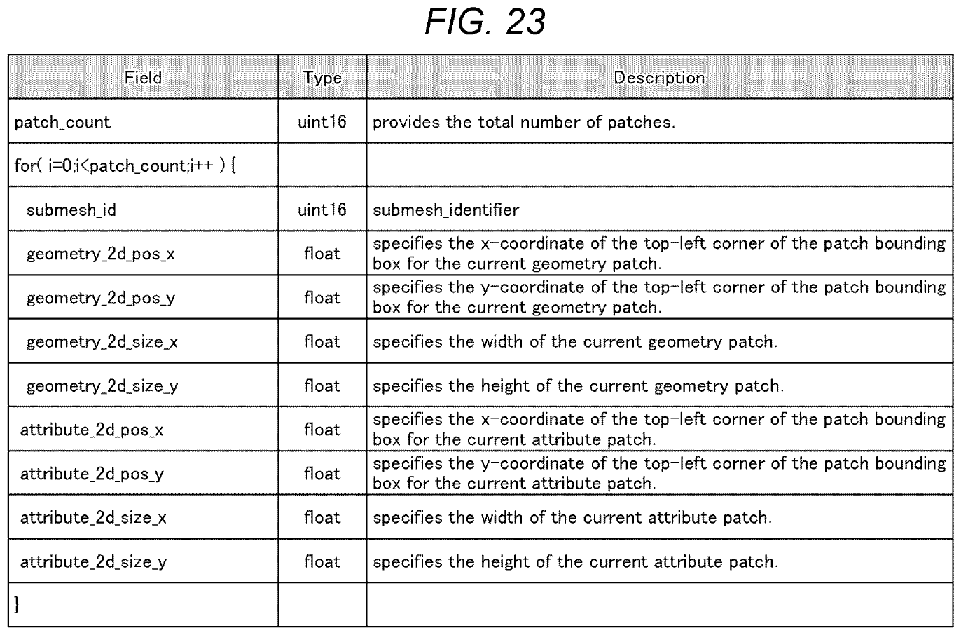

Similarly to the case of the V-PCC, the atlas information includes patch information about the patch packed in this displacement video or attribute video. For example, as illustrated in FIG. 23, the patch information may include identification information (submesh id) of the submesh of the base mesh, information (gemetry 2d_pos_x, gemetry 2d_pos_y, gemetry 2d_size_x, gemetry 2d_size_y) indicating the position and size of the patch of the geometry (displacement vector), and information (attribute 2d_pos_x, attribute 2d_pos_y, attribute 2d_size_x, attribute 2d_size_y) indicating the position and size of the patch of the attribute. That is, the atlas information includes a correspondence between each patch of the displacement vector and the attribute and the identification information of the submesh of the base mesh.

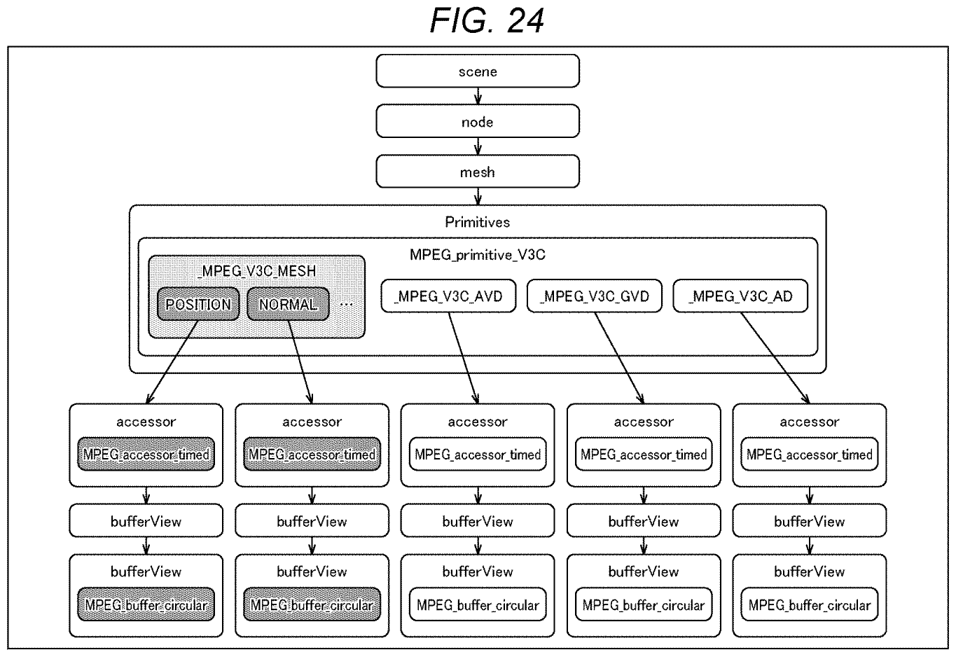

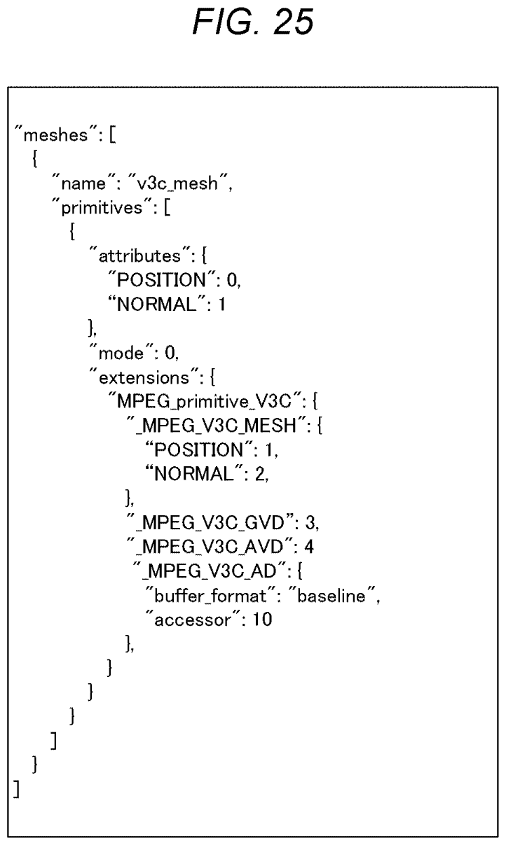

FIG. 24 is a diagram illustrating a main configuration example of the scene description in the case of the PE reconstruction. As illustrated in FIG. 24, an MPEG primitive V3C object that handles V-DMC data is set to mesh. primitives, properties such as MPEG_V3C_MESH, MPEG_V3C_AVD, MPEG_V3C_GVD, and MPEG_V3C_AD are formed in the MPEG primitive V3C object, and an accessor (accessor) to a buffer (buffer) that stores V-DMC data before reconstruction is designated. For example, in_MPEG_V3C_MESH, an access to a buffer that stores the geometry (POSITION) of each vertex of the base mesh and an access to a buffer that stores the normal vector (NORMAL) of each vertex are designated. In_MPEG_V3C_AVD, an access to a buffer that stores the attribute video is designated. In_MPEG_V3C_GVD, an access to a buffer that stores the displacement video is designated. In_MPEG_V3C_AD, an access to a buffer that stores atlas information is designated. FIG. 25 illustrates a description example of the scene description.

A conventional decoder of V-DMC data manages submeshes of a base mesh that is 3D data. That is, the decoder manages which part of the data the identification information of each submesh corresponds to for the base mesh. Therefore, the decoder can grasp the correspondence between the data of the submesh of the base mesh and the patch of the displacement vector or the attribute on the basis of the atlas information described above. Therefore, the 3D data can be reconstructed (perform displacement (refinement) of vertices and mapping of attributes using displacement vector) from the V-DMC data.

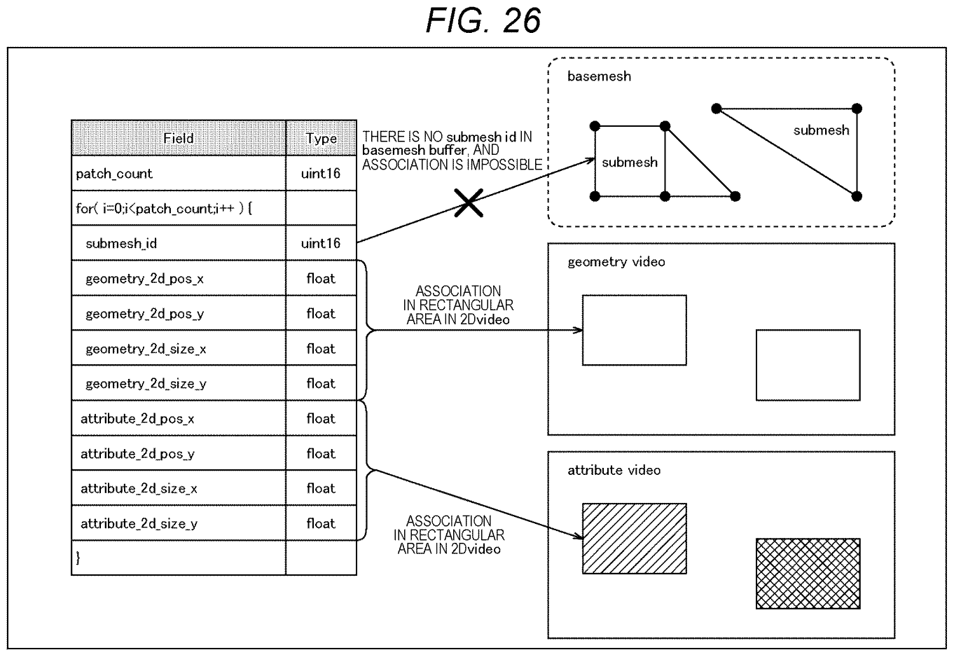

However, when the PE reconstruction is applied as described above and the V-DMC data before reconstruction is stored in the buffer (supplied to the PE via the buffer), the PE cannot acquire the information for managing the identification information of each submesh even if the data of the subdivided base mesh can be acquired. That is, the PE cannot grasp the submesh of the base mesh. Therefore, as illustrated in FIG. 26, even if the PE can grasp the correspondence between the “identification information of the submesh of the base mesh” and the “each patch of the displacement vector and the attribute” on the basis of the patch information (FIG. 23) of the atlas information, the PE cannot grasp which “part of the data of the base mesh” the “identification information of the submesh” corresponds to. That is, the PE cannot grasp the correspondence between the “submesh of the base mesh” and the “patch of the displacement vector or the attribute”. Therefore, in the PE, it is difficult to reconstruct (perform displacement (refinement) of vertices and mapping of attributes using displacement vector) the 3D data from the V-DMC data. Therefore, there is a possibility that the processing efficiency of the decoding processing is reduced.

Therefore, as illustrated in the third part from the top of the table in FIG. 20, the submesh association information may be supplied from the MAF to the PE, and the 3D data may be reconstructed from the V-DMC data using the submesh association information in the PE (Method 1-2). The submesh association information is information for specifying data of a submesh that is a part of a mesh representing a 3D object.

For example, the first information processing device may include a scene description generation unit that generates a scene description representing a scene including a 3D object, and sets first reference information to a first buffer that stores submesh association information in the scene description.

Furthermore, in the first information processing device, a scene description representing a scene including a 3D object may be generated, and first reference information to a first buffer that stores submesh association information may be set in the scene description.

By doing so, the information processing device that decodes the V-DMC bit stream using the scene description can realize the PE reconstruction, and can execute the decoding processing more efficiently than in the case of the MAF reconstruction. That is, the first information processing device can suppress a reduction in the processing efficiency of the decoding processing.

Further, the second information processing device may include: a storage processing unit that stores submesh association information for specifying data of a submesh that is a part of a mesh representing a 3D object in a first buffer designated by a scene description representing a scene configured by the 3D object; and a reconstruction unit that acquires the submesh association information from the first buffer, specifies the data of the submesh using the acquired submesh association information, and reconstructs the mesh.

Further, in the second information processing device, submesh association information for specifying data of a submesh that is a part of a mesh representing a 3D object may be stored in a first buffer designated by a scene description representing a scene configured by the 3D object, and the submesh association information may be acquired from the first buffer, the data of the submesh may be specified using the acquired submesh association information, and the mesh may be reconstructed.

By doing so, the second information processing device can grasp the correspondence between the “submesh of the base mesh” and the “patch of the displacement vector or the attribute” in the PE. That is, the PE reconstruction can be realized, and the processing efficiency of the decoding processing can be improved as compared with the case of the MAF reconstruction. That is, the first information processing device and the second information processing device can suppress a reduction in the processing efficiency of the decoding processing.

### <Method 1-2-1>

In a case where Method 1-2 is applied, for example, as illustrated in the fourth part from the top of the table in FIG. 20, reference information to a buffer that stores the submesh association information may be newly defined (Method 1-2-1).

For example, the first buffer referred to in the first reference information set in the scene description by the first information processing device may be a buffer different from a second buffer that stores data of the mesh. That is, in the first information processing device, the scene description generation unit may set a “buffer different from a second buffer that stores data of the mesh” as the “first buffer that stores submesh association information”, and set the first reference information to the first buffer in the scene description.

Furthermore, in the second information processing device, the “first buffer designated by a scene description” may be a buffer different from a second buffer that stores data of the mesh. That is, the storage processing unit may store the submesh association information in the first buffer that is a “buffer different from a second buffer that stores data of the mesh”. Then, the reconstruction unit may acquire the submesh association information from the first buffer.

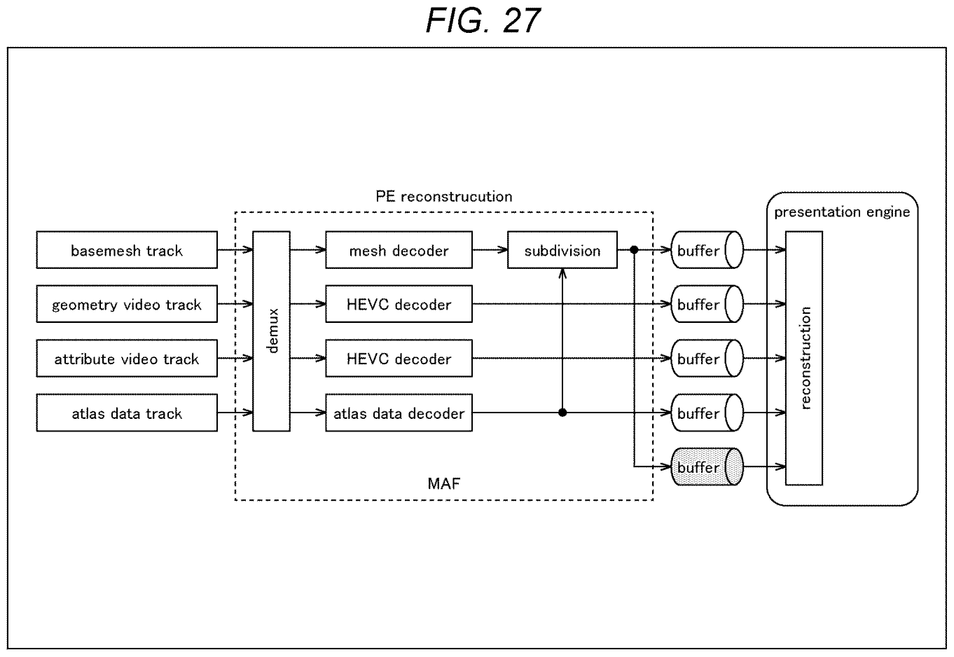

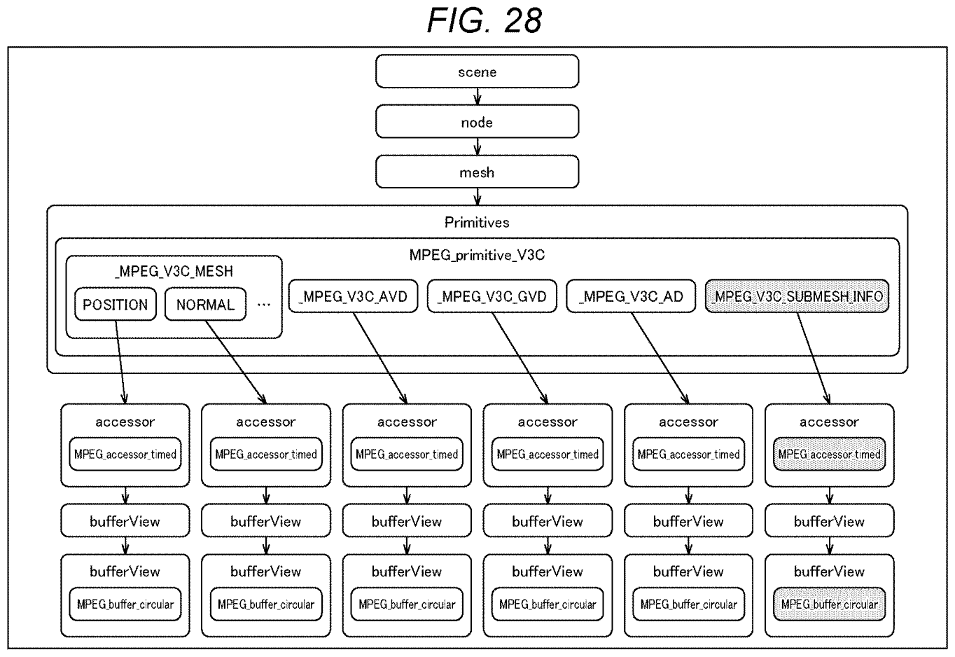

That is, as illustrated in FIG. 27, a buffer (buffer indicated in gray in the drawing) is newly defined separately from the buffer that stores the V-DMC data, and the submesh association information that is information for specifying the data of the submesh that is a part of the mesh representing the 3D object is supplied from the MAF to the PE via the new buffer. FIG. 28 is a diagram illustrating a configuration example of the scene description in that case. As illustrated in FIG. 28, the MPEG_V3C SUBMESH_INFO property is provided in the MPEG primitive V3C object of mesh. primitives, and an accessor (accessor) to a buffer (buffer) that stores submesh association information is designated. The first information processing device generates a scene description having such a configuration. The MAF of the second information processing device stores the submesh association information in the buffer designated by the MPEG_V3C SUBMESH_INFO property on the basis of the scene description. Then, the PE acquires the submesh association information from the buffer designated by the MPEG_V3C SUBMESH_INFO property, and reconstructs the 3D data using the submesh association information.

By doing so, the PE can grasp the correspondence between each submesh included in the base mesh data and the identification information of the submesh by the submesh association information. Therefore, the PE can grasp the correspondence between the submesh of the base mesh and the patch on the basis of the submesh association information and (the patch information of) the atlas information. That is, the PE can reconstruct the 3D data from the V-DMC data by using the identification information of the submesh. That is, the PE reconstruction can be realized, and the processing efficiency of the decoding processing can be improved as compared with the case of the MAF reconstruction. That is, the first information processing device and the second information processing device can suppress a reduction in the processing efficiency of the decoding processing.

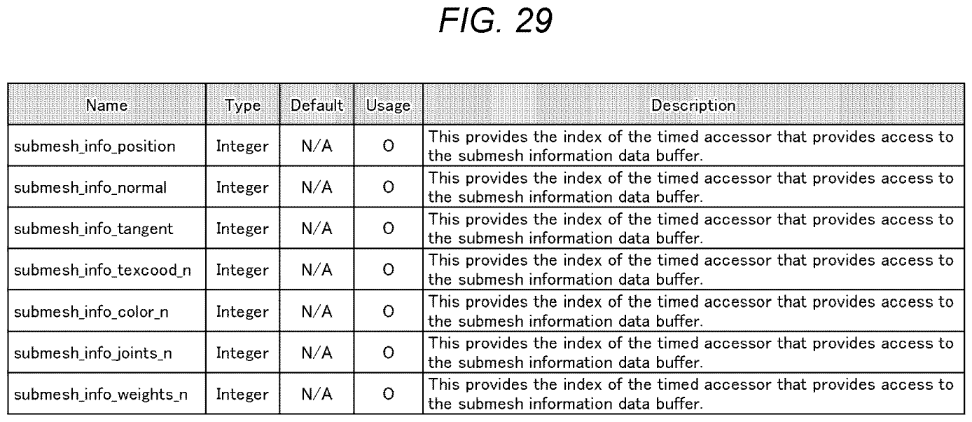

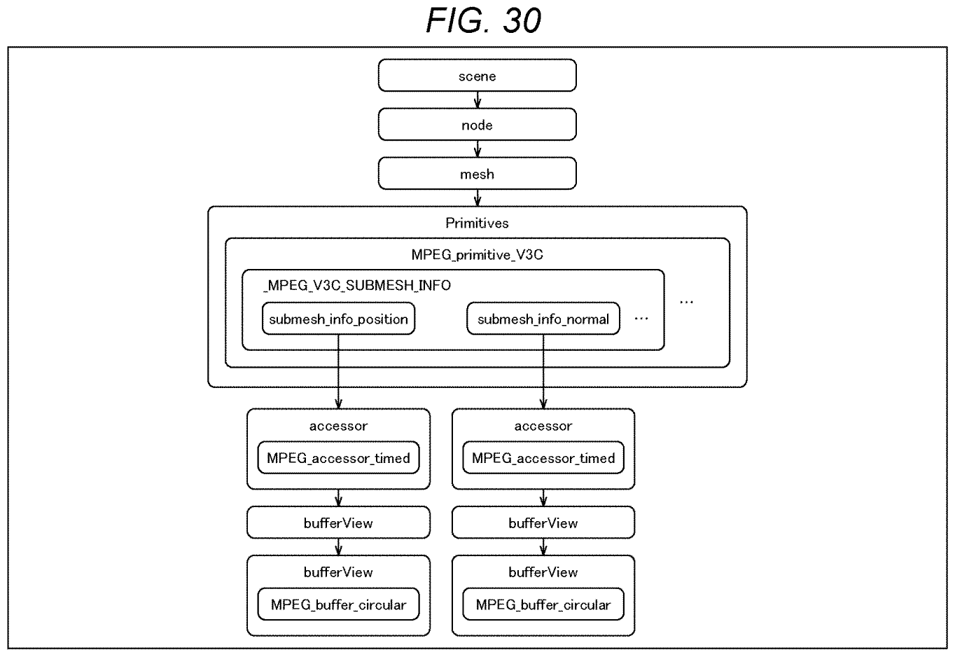

Note that, in the MPEG_V3C SUBMESH_INFO property, for each property of the attribute of the base mesh, a timed accessor index (timed accessor index) to a buffer that stores the submesh association information may be designated. For example, as illustrated in FIG. 29, properties such as “submesh_info_position”, “submesh_info_normal”, “submesh_info_tangent”, “submesh_info_texcoord_n”, “submesh_info_color_n”, “submesh_info_joints_n”, and “submesh_info_weights_n” may be set in the MPEG_V3C SUBMESH_INFO property, and as illustrated in FIG. 30, an index of a timed accessor may be designated for each property.

Furthermore, in this case, the submesh association information may include boundary information indicating the boundary of the submesh in the data of the base mesh from which the vertices of the mesh have been thinned out. By indicating the boundary of the submesh, the PE can specify (the position of) the data of the submesh unit in the data of the base mesh.

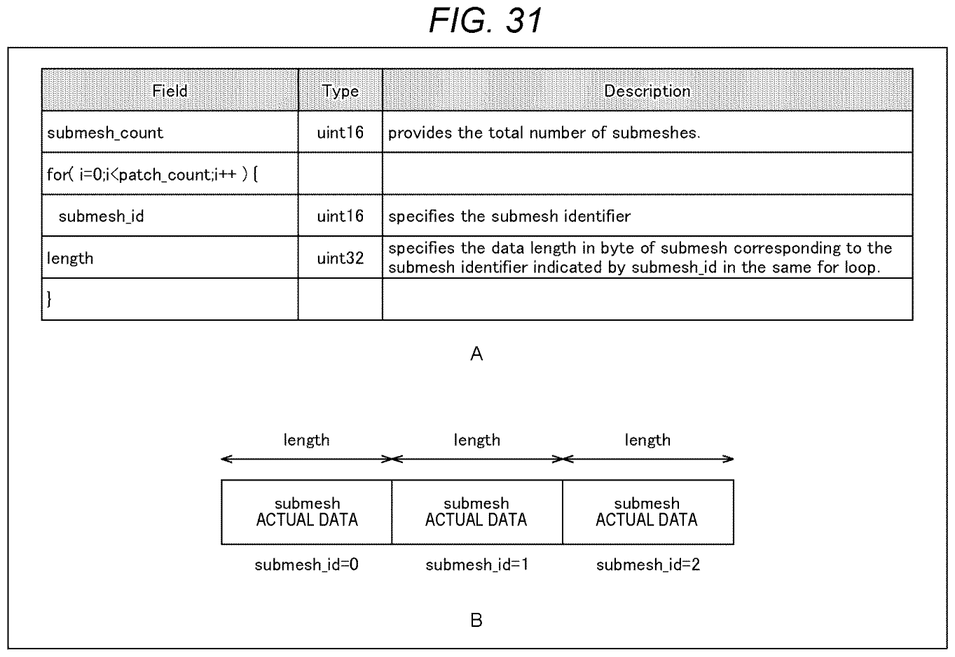

For example, the boundary information may include information indicating the length of the data of the submesh and identification information of the submesh. For example, as illustrated in A of FIG. 31, a parameter “submesh id” and a parameter “length” may be set for each submesh in the submesh association information. “submesh id” is identification information of the submesh. “length” is information indicating the length of the data of the submesh. That is, as illustrated in B of FIG. 31, the data of the base mesh is divided for each “length”. Data in each section is actual data of a submesh, and “submesh id” is assigned to each data. Since such boundary information is indicated in the submesh association information, the PE can easily grasp which part of the base mesh the data of the submesh corresponding to submesh id included in the patch information is.

### <Method 1-2-2>

In a case where Method 1-2 is applied, for example, as illustrated in the fifth part from the top of the table of FIG. 20, atlas data may be extended to store submesh association information (Method 1-2-2).

For example, the first buffer referred to in the first reference information set in the scene description by the first information processing device may be configured to store atlas information including submesh association information. That is, in the first information processing device, the scene description generation unit may set a buffer that stores atlas information as a “first buffer that stores submesh association information”, and set the first reference information to the first buffer in the scene description.

Furthermore, in the second information processing device, the “first buffer designated by a scene description” may be configured to store the atlas information including the submesh association information. That is, the storage processing unit may store the atlas information including the submesh association information in the first buffer. Then, the reconstruction unit may acquire the atlas information including the submesh association information from the first buffer.

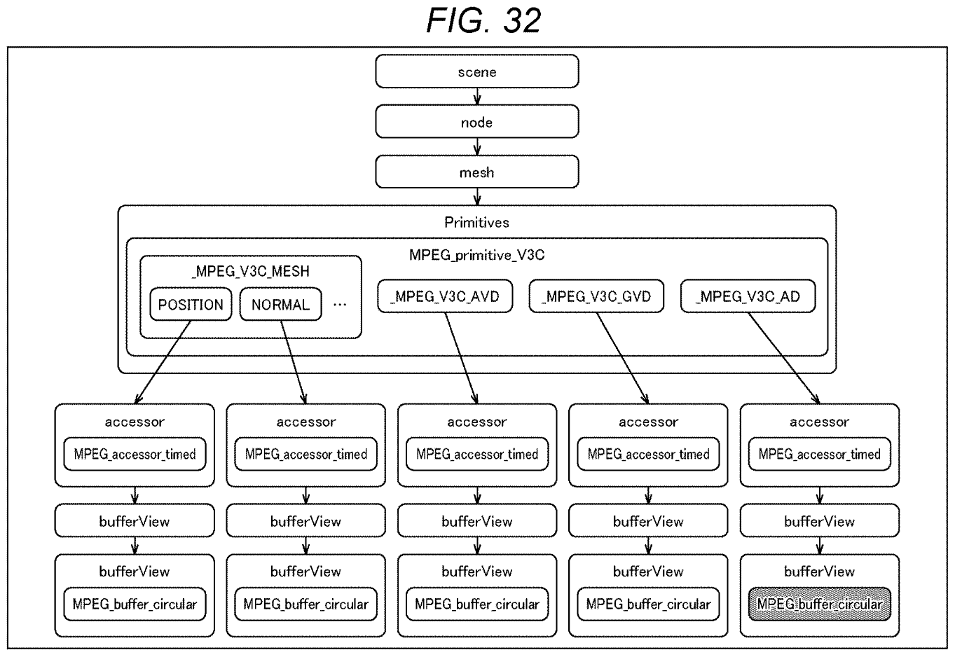

That is, in that case, the scene description has a configuration as illustrated in FIG. 32, and the submesh association information is stored as atlas information in the buffer via the accessor designated by the MPEG_V3C_AD property.

In this way, the PE can acquire the submesh association information together with the atlas information. Therefore, the PE can grasp the correspondence between the submesh of the base mesh and the patch on the basis of the atlas information (including the submesh association information). That is, the PE can reconstruct the 3D data from the V-DMC data by using the identification information of the submesh. That is, the PE reconstruction can be realized, and the processing efficiency of the decoding processing can be improved as compared with the case of the MAF reconstruction. That is, the first information processing device and the second information processing device can suppress a reduction in the processing efficiency of the decoding processing.

Note that, in this case, the atlas information may include submesh association information associated with the patch. In the atlas information, since the submesh association information is indicated in association with each patch, the PE can more easily grasp the correspondence between the submesh of the base mesh and the patch. In addition, since the submesh association information is indicated in association with the patch, the identification information of the submesh becomes unnecessary. Therefore, an increase in the amount of data can be suppressed accordingly.

Furthermore, in that case, the submesh association information may include boundary information indicating the boundary of the submesh in the data of the base mesh from which the vertices of the mesh have been thinned out. By indicating the boundary of the submesh, the PE can specify (the position of) the data of the submesh unit in the data of the base mesh.

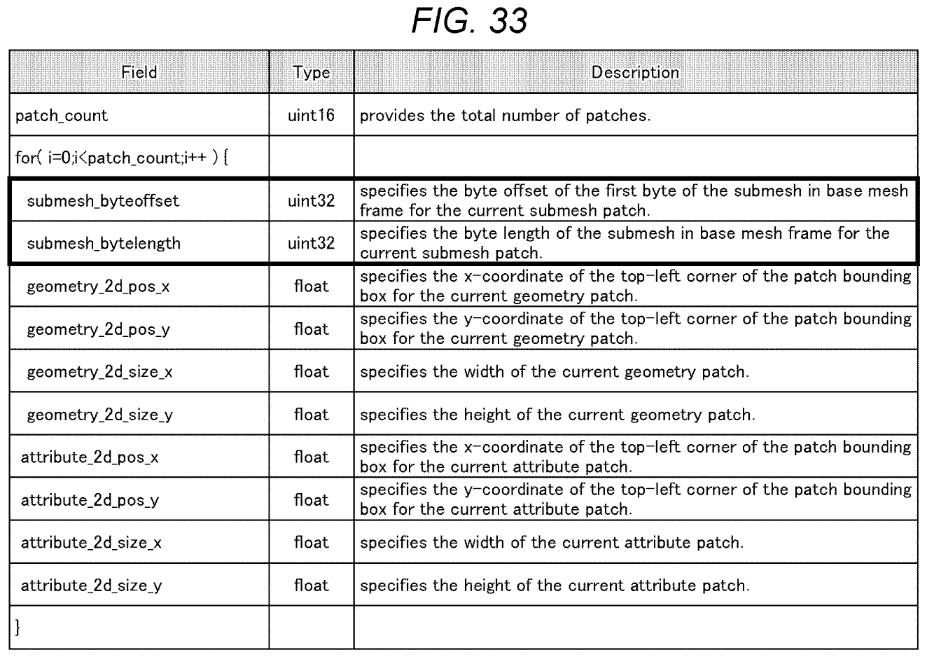

Further, the boundary information may include information indicating the offset and length of the data of the submesh. For example, the atlas information may have patch information as illustrated in FIG. 33. In the case of the example of FIG. 33, a parameter “submesh_byte offset” and a parameter “submesh_byte length” are set for each patch. “submesh_byteoffset” is information indicating an offset of a boundary of data of a submesh. “submesh_byte length” is information indicating the length of data of the submesh. In this way, by indicating the offset and the length of the data of each submesh in the data of the base mesh, the PE can specify (the position of) the data of the submesh unit in the data of the base mesh.

Note that, in a case where Method 1-2-1 or Method 1-2-2 described above is applied, data formats of MPEG primitive V3C/MPEG_V3C_MESH and attribute/POSITION of mesh/primitives provided by conventional glTF are the same. Therefore, MPEG_V3C_MESH is not defined by MPEG primitive V3C, and attribute/POSITION of mesh/primitives may be used at the time of PE reconstruction.

### <Method 1-2-3>

In a case where Method 1-2 is applied, for example, as illustrated in the sixth part from the top of the table in FIG. 20, the base mesh may be extended to store the submesh association information (Method 1-2-3).

For example, the first buffer referred to in the first reference information set in the scene description by the first information processing device may be configured to store the base mesh including the submesh association information. That is, in the first information processing device, the scene description generation unit may set the buffer that stores the base mesh as the “first buffer that stores submesh association information”, and set the first reference information to the first buffer in the scene description.

Furthermore, in the second information processing device, the “first buffer designated by a scene description” may be configured to store the base mesh including the submesh association information. That is, the storage processing unit may store the base mesh including the submesh association information in the first buffer. Then, the reconstruction unit may acquire the base mesh including the submesh association information from the first buffer.

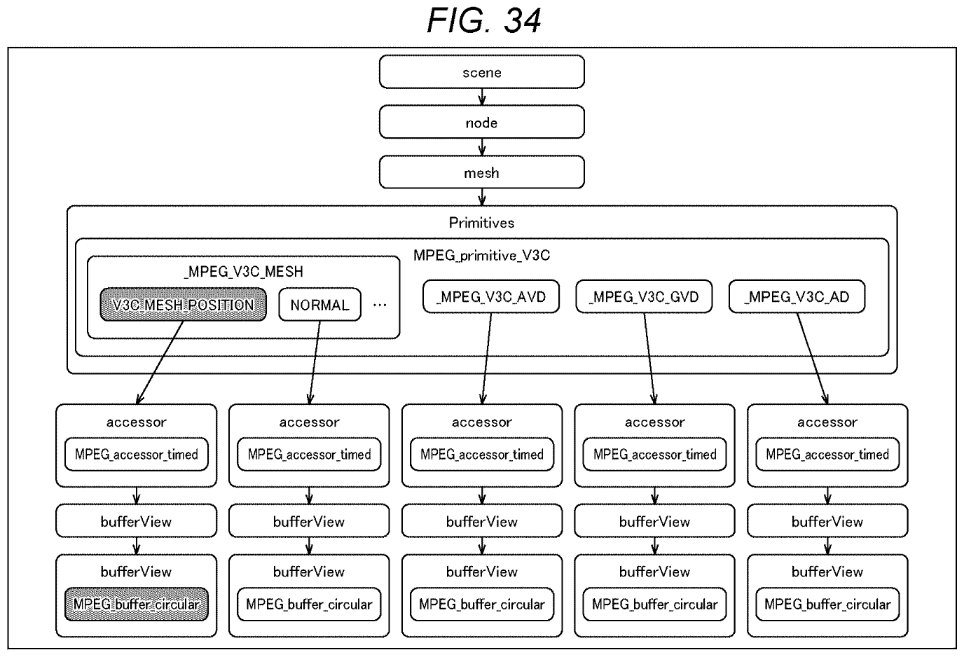

That is, in that case, the scene description has a configuration as illustrated in FIG. 34, and the submesh association information is stored as atlas information in the buffer via the accessor designated by the MPEG_V3C_MESH property.

In this way, the PE can acquire the submesh association information together with the base mesh. Therefore, the PE can grasp the correspondence between the submesh of the base mesh and the patch on the basis of the submesh association information and the atlas information. That is, the PE can reconstruct the 3D data from the V-DMC data by using the identification information of the submesh. That is, the PE reconstruction can be realized, and the processing efficiency of the decoding processing can be improved as compared with the case of the MAF reconstruction. That is, the first information processing device and the second information processing device can suppress a reduction in the processing efficiency of the decoding processing.

Note that, in this case, the submesh association information may include the identification information of the submesh. Since the submesh association information associated with the base mesh has the identification information, the PE can be associated with the patch information of the atlas information by using the identification information, and the correspondence between the submesh of the base mesh and the patch can be more easily grasped.

For example, a type of one property of primitive/attribute included in the base mesh may be extended, one element of an accessory type (accessor type) may be added, and the identification information of the submesh may be stored therein.

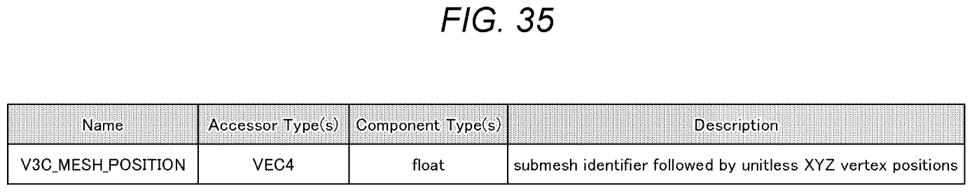

For example, the identification information of the submesh may be stored in the property of the vertex of the base mesh. As illustrated in FIGS. 34 and 35, the V3C_MESH POSITION property set to the MPEG_V3C_MESH property may designate the timed accessor to the buffer that stores the identification information of the submesh associated with each vertex of the base mesh. By doing so, the identification information of the submesh is associated with each vertex of the base mesh. That is, the submesh association information can include the identification information of the submesh associated with each vertex of the base mesh. That is, the correspondence between each vertex of the base mesh and the submesh is clearly indicated. Therefore, the PE can more easily grasp the correspondence between each vertex of the base mesh and the patch. For other properties, the PE can identify the submeshes in the data storage order on the basis of the identification information of the submeshes of this V3C_MESH POSITION.

Note that other properties such as NORMAL may be similarly extended. All properties of the base mesh primitive/attribute may be extended.

### <Method 1-2-4>

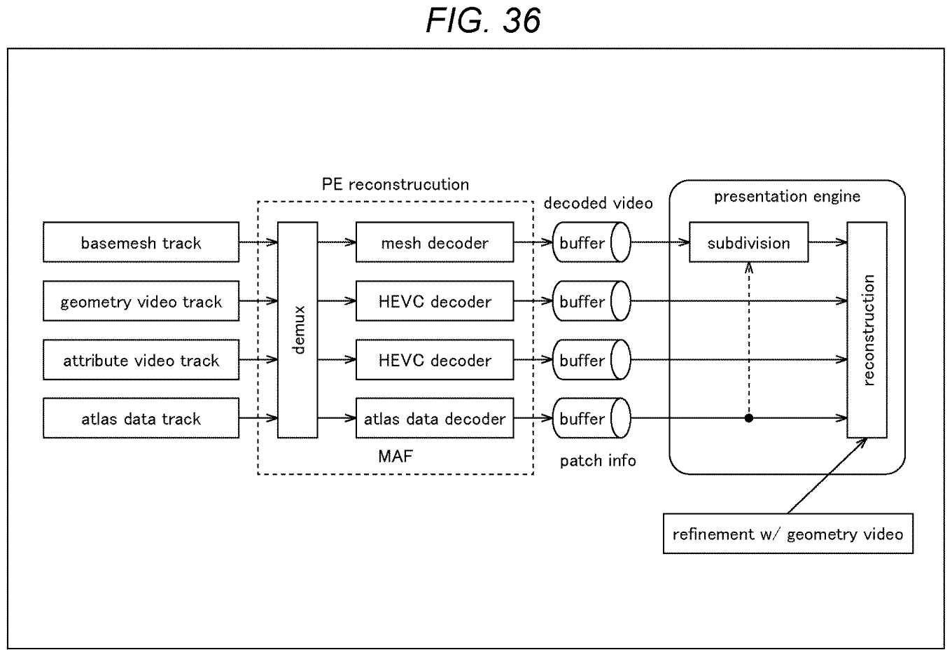

Although the subdivision (subdivision) of the base mesh is performed in the MAF in the PE reconstruction in the above description, this processing may be performed in the PE as illustrated in FIG. 36. By doing so, the processing efficiency of the decoding processing can be further improved. In that case, the base mesh before being subdivided is stored in a buffer (supplied from MAF to PE). In a conventional general decoder of V-DMC data, a method of subdivision is managed, but in this method, the PE cannot acquire the information, and it is difficult to grasp how to subdivide the base mesh.

Therefore, in a case where Method 1-2 is applied, for example, as illustrated in the bottom row of the table in FIG. 20, the subdivision information may be supplied from the MAF to the PE, and the base mesh may be subdivided in the PE by using the subdivision information (Method 1-2-4). This subdivision information is information related to subdivision of the base mesh. The subdivision information designates a subdivision method.

For example, in the first information processing device, the scene description generation unit may further set, in the scene description, second reference information to a second buffer that stores subdivision information related to subdivision of the base mesh from which the vertices of the mesh have been thinned out.

Furthermore, in the second information processing device, the storage processing unit may further store the subdivision information related to the subdivision of the base mesh from which the vertices of the mesh have been thinned out in the second buffer designated by the scene description, and the reconstruction unit may acquire the subdivision information from the second buffer, subdivide the base mesh using the acquired subdivision information, and reconfigure the mesh using the subdivided base mesh.

In this way, the PE can acquire the subdivision information. Therefore, the PE can subdivide the base mesh on the basis of the subdivision information. Therefore, the processing efficiency of the decoding processing can be further improved. That is, the first information processing device and the second information processing device can suppress a reduction in the processing efficiency of the decoding processing.

Here, the second buffer that stores the subdivision information may be the same as or different from the first buffer that stores submesh association information described above.

For example, the second buffer may be configured to store atlas information including the subdivision information. That is, the atlas data may be extended to store the subdivision information. In the first information processing device, the scene description generation unit may set a buffer that stores atlas information as a “second buffer that stores subdivision information” and set second reference information to the second buffer in the scene description. Furthermore, in the second information processing device, the “second buffer designated by the scene description” may be configured to store atlas information including the subdivision information. That is, the storage processing unit may store the atlas information including the subdivision information in the second buffer. Then, the reconstruction unit may acquire the atlas information including the subdivision information from the second buffer.

In this way, the PE can acquire the subdivision information together with the atlas information. Therefore, the PE can subdivide the base mesh on the basis of the subdivision information. Therefore, the second information processing device can execute the decoding processing more efficiently. That is, the first information processing device and the second information processing device can suppress a reduction in the processing efficiency of the decoding processing.

Note that, in this case, the atlas information may include subdivision information associated with the patch. In the atlas information, the subdivision information is indicated in association with each patch, so that the PE can grasp the subdivision method for each submesh of the base mesh.

The subdivision information may include any information as long as information that designates the subdivision method is included. For example, the subdivision information may include information indicating whether or not to apply a predetermined method in the subdivision of the base mesh. This predetermined method may be any method. For example, information indicating whether or not to apply the midpoint may be included in the subdivision information. In addition, the subdivision information may include information indicating the number of iterations of subdivision of the base mesh.

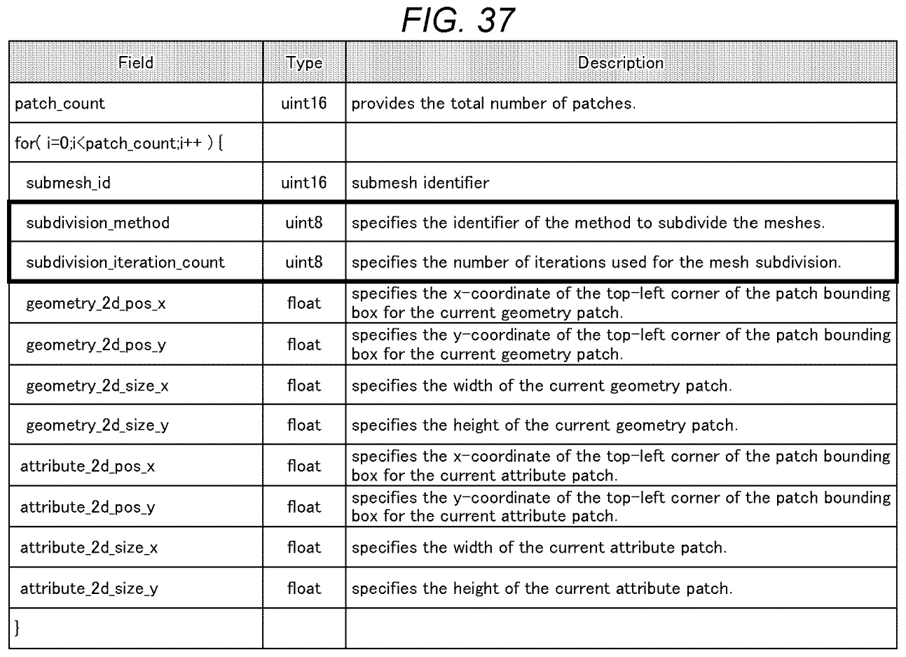

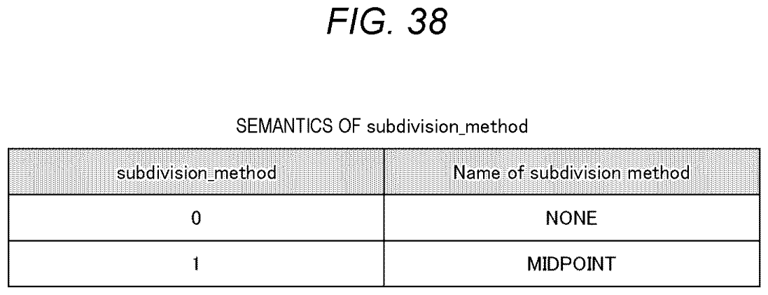

FIG. 37 is a diagram illustrating an example of atlas information. In the case of the example of FIG. 37, the patch information is extended, and fields of “subdivision method” and “subdivision iteration count” are added. “subdivision method” is a parameter indicating a method of subdivision, and has a value of “O” or “1” as illustrated in FIG. 38. The value “0” indicates that a method of subdivision is not designated (NONE), and the value “1” indicates that a midpoint (MIDPOINT) at which a processing of dividing an edge between vertices into two equal parts is recursively repeated is designated as the method of subdivision. That is, “subdivision method” indicates whether or not to apply the midpoint. “subdivision iteration count” is a parameter indicating the number of iterations (iteration count) of edge division by the midpoint.

On the basis of such subdivision information in the patch information, in a case where the value of “subdivision method” is “1”, the PE performs subdivision by applying the midpoint to the submesh corresponding to the patch, and repeats the edge division for the number of times indicated by “subdivision iteration count”. In this way, the PE can perform subdivision on the basis of the subdivision information stored in the patch information of the atlas information.

### <Combination>

Each method described above may be applied in combination with any other method as long as there is no contradiction. Three or more methods may be applied in combination. For example, any two or more of Method 1-2-1 to Method 1-2-4 may be applied in combination. Further, the combinable approach may include not only those illustrated in the table of FIG. 20 as “methods” but also all the elements described above. Furthermore, each method described above may be applied in combination with other methods not described above.

Note that, in the present specification, the description made for the superior method is also applied to the inferior method belonging to the method as long as there is no contradiction. For example, in a case where it is described that “Method 1 may be applied”, Method 1-1 or Method 1-2 may be applied. Further, any one or more of Methods 1-2-1 to 1-2-4 may also be applied.

### 4. First Embodiment

### <File Generation Device>

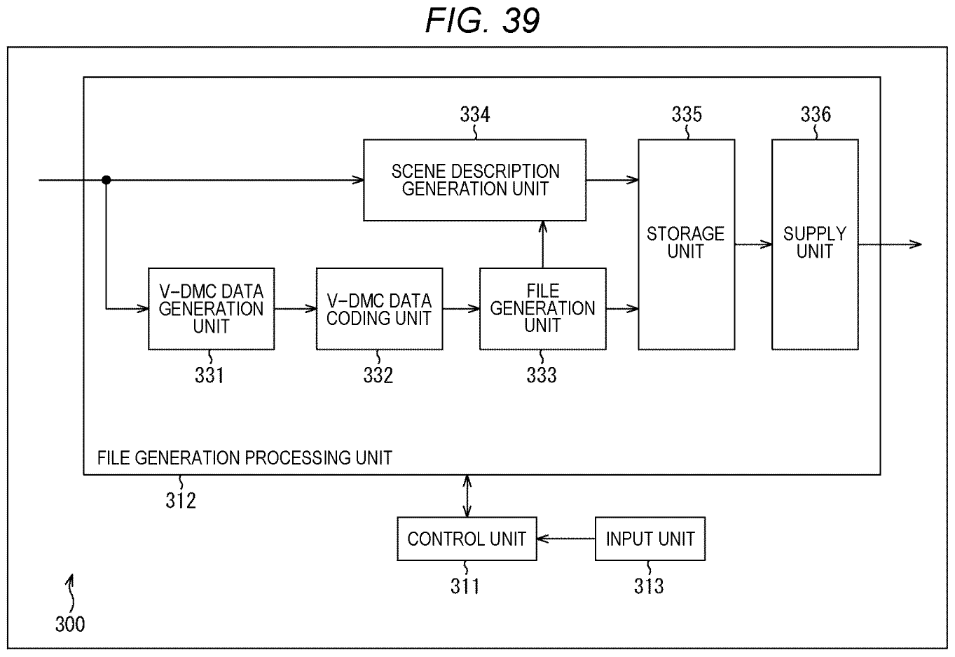

The above-described present technology can be applied to any device. FIG. 39 is a block diagram illustrating an example of a configuration of a file generation device that is an aspect of an information processing device to which the present technology is applied. A file generation device 300 illustrated in FIG. 39 is a device that converts mesh data into V-DMC data, codes the V-DMC data, and stores the V-DMC data in, for example, a file container such as ISOBMFF, thereby generating a content file for distribution. In addition, the file generation device 300 generates a scene description used for the distribution.

Note that FIG. 39 illustrates main parts of processing units, data flows, and the like, and those illustrated in FIG. 39 are not necessarily all. That is, in the file generation device 300, there may be a processing unit not illustrated as a block in FIG. 39, or there may be processing or a data flow not illustrated as an arrow or the like in FIG. 39.

As illustrated in FIG. 39, the file generation device 300 includes a control unit 311, a file generation processing unit 312, and an input unit 313. The control unit 311 executes processing related to control of the file generation processing unit 312. The file generation processing unit 312 executes processing related to generation of a content file or the like. The input unit 313 has an input device, receives information input from the outside such as a user or another device, and supplies the input information to the control unit 311. The input device may include, for example, a keyboard, a mouse, a touch panel, a physical switch, a physical button, an input terminal, and the like. The control unit 311 may execute processing on the basis of the information supplied from the input unit 313.

The file generation processing unit 312 includes a V-DMC data generation unit 331, a V-DMC data coding unit 332, a file generation unit 333, a scene description generation unit 334, a storage unit 335, and a supply unit 336.

The V-DMC data generation unit 331 executes processing related to generation of V-DMC data. For example, the V-DMC data generation unit 331 may acquire mesh data representing a 3D object supplied from the outside of the file generation device 300. The V-DMC data generation unit 331 may convert the mesh data into V-DMC data. For example, the V-DMC data generation unit 331 may generate the base mesh by decimating the mesh. In addition, the V-DMC data generation unit 331 may generate a displacement vector corresponding to each vertex by using the base mesh and the original mesh. In addition, atlas information indicating a correspondence between the base mesh, the displacement vector, and the texture may be generated. The V-DMC data generation unit 331 may supply the generated V-DMC data to the V-DMC data coding unit 332.

The V-DMC data coding unit 332 executes processing related to coding of V-DMC data. For example, the V-DMC data coding unit 332 may acquire the V-DMC data supplied from the V-DMC data generation unit 331. The V-DMC data coding unit 332 may code the V-DMC data to generate a V-DMC bit stream. The V-DMC data coding unit 332 may supply the generated V-DMC bit stream to the file generation unit 333.

The file generation unit 333 executes processing related to generation of a content file. For example, the file generation unit 333 may acquire the V-DMC bit stream supplied from the V-DMC data coding unit 332. The file generation unit 333 may generate a content file that stores the V-DMC bit stream. The content file may have any specification, and may be, for example, an international organization for standardization base media file format (ISOBMFF). The file generation unit 333 may supply the generated content file to the scene description generation unit 334. The file generation unit 333 may supply the generated content file to the storage unit 335.

The scene description generation unit 334 executes processing related to generation of a scene description. For example, the scene description generation unit 334 may acquire mesh data supplied from the outside of the file generation device 300. The scene description generation unit 334 may acquire the content file supplied from the file generation unit 333. The scene description generation unit 334 generates a scene description representing a scene constituted by 3D objects corresponding to the mesh data on the basis of these pieces of information. This scene description corresponds to the V-DMC bit stream (that is, V-DMC data). The scene description generation unit 334 generates a scene description generation unit file that stores the scene description. The scene description generation unit 334 may supply the generated scene description file to the storage unit 335.

The storage unit 335 has a storage area and executes processing related to storage of information. For example, the storage unit 335 may acquire the content file supplied from the file generation unit 333. The storage unit 335 may store the content file in the storage area. In addition, the storage unit 335 may acquire the scene description file supplied from the scene description generation unit 334. The storage unit 335 may store the scene description file in the storage area.

The supply unit 336 executes processing related to supply of information. For example, the supply unit 336 may acquire a scene description file or a content file stored in the storage unit 335. The supply unit 336 may supply the acquired scene description file or content file to the outside of the file generation device 300 (for example, a distribution server, a reproduction device, or the like).

### <V-DMC Data Coding Unit>

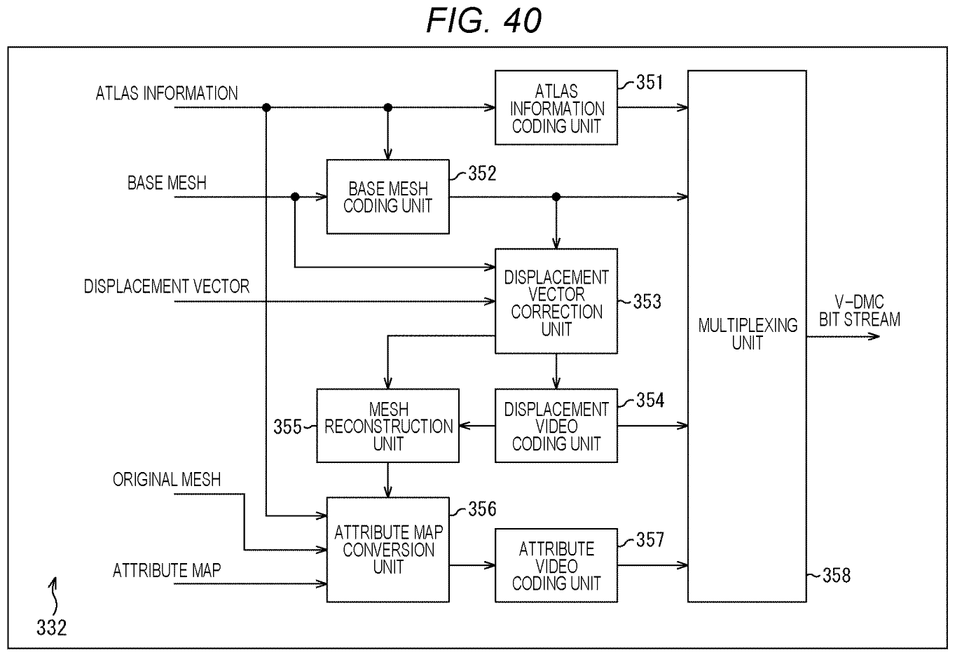

FIG. 40 is a block diagram illustrating a main configuration example of the V-DMC data coding unit 332. Note that, FIG. 40 illustrates main parts of processing units, data flows, and the like, and those illustrated in FIG. 40 are not necessarily all. That is, in the V-DMC data coding unit 332, there may be a processing unit not illustrated as a block in FIG. 40, or there may be processing or a data flow not illustrated as an arrow or the like in FIG. 40.

As illustrated in FIG. 40, the V-DMC data coding unit 332 includes an atlas information coding unit 351, a base mesh coding unit 352, a displacement vector correction unit 353, a displacement video coding unit 354, a mesh reconstruction unit 355, an attribute map conversion unit 356, an attribute video coding unit 357, and a multiplexing unit 358.

The atlas information coding unit 351 performs processing related to coding of atlas information. For example, the atlas information coding unit 351 may acquire atlas information supplied from the V-DMC data generation unit 331. Furthermore, the atlas information coding unit 351 may code the acquired atlas information by a predetermined coding scheme to generate coded data of the atlas information. The atlas information coding unit 351 may supply the generated coded data of the atlas information to the multiplexing unit 358.

The base mesh coding unit 352 performs processing related to coding of the base mesh. For example, the base mesh coding unit 352 may acquire the base mesh supplied from the V-DMC data generation unit 331. Furthermore, the base mesh coding unit 352 may quantize the acquired base mesh, code the quantized base mesh by a predetermined coding scheme (for example, Draco or the like), and generate coded data of the base mesh. At that time, the base mesh coding unit 352 may code the base mesh according to the atlas information. The base mesh coding unit 352 may supply the generated coded data of the base mesh to the displacement vector correction unit 353. Furthermore, the base mesh coding unit 352 may supply the generated coded data of the base mesh to the multiplexing unit 358.

The displacement vector correction unit 353 performs processing related to correction of the displacement vector. For example, the displacement vector correction unit 353 may acquire the base mesh and the displacement vector supplied from the V-DMC data generation unit 331. Furthermore, the displacement vector correction unit 353 may acquire the coded data of the base mesh supplied from the base mesh coding unit 352. The displacement vector correction unit 353 may correct the displacement vector on the basis of these pieces of information. For example, the displacement vector correction unit 353 may decode and inversely quantize the acquired coded data of the base mesh, and may restore the base mesh (may generate a restored base mesh). The displacement vector correction unit 353 may subdivide each of the base mesh before coding and the restored base mesh. The displacement vector correction unit 353 may compare the subdivided base mesh before coding with the subdivided restored base mesh to obtain coding distortion. The displacement vector correction unit 353 may correct the displacement vector according to the coding distortion. The displacement vector correction unit 353 may supply the displacement vector after correction to the displacement video coding unit 354. Furthermore, the displacement vector correction unit 353 may supply the subdivided restored base mesh to the mesh reconstruction unit 355.

The displacement video coding unit 354 performs processing related to coding of the displacement video. The displacement video is a moving image in which a displacement map is a frame image, the displacement map being a two-dimensional area in which displacement vectors are packed. For example, the displacement video coding unit 354 may acquire the displacement vector supplied from the displacement vector correction unit 353. The displacement video coding unit 354 may generate a displacement map by performing wavelet transform on the displacement vector, quantizing the displacement vector, and packing the displacement vector in a two-dimensional area. The displacement video coding unit 354 may generate a displacement video using the displacement map as a frame image. The displacement video coding unit 354 may convert the generated displacement video into a geometry video. The displacement video coding unit 354 may code the generated geometry video using a predetermined coding scheme for 2D moving images to generate coded data of the geometry video. The displacement video coding unit 354 may supply the coded data of the generated geometry video to the multiplexing unit 358. Furthermore, the displacement video coding unit 354 may decode the coded data of the generated geometry video to restore the geometry video. The displacement video coding unit 354 may inversely convert the geometry video into a displacement video (may generate a reconstructed displacement video). The displacement video coding unit 354 may extract the displacement map from the restored displacement video. The displacement video coding unit 354 may unpack the displacement vector from the displacement map. The displacement video coding unit 354 may inversely quantize the displacement vector. The displacement video coding unit 354 may supply the inversely-quantized displacement vector to the mesh reconstruction unit 355.

The mesh reconstruction unit 355 performs processing related to mesh reconstruction. For example, the mesh reconstruction unit 355 may acquire the base mesh (subdivided restored base mesh) supplied from the displacement vector correction unit 353. Furthermore, the mesh reconstruction unit 355 may acquire the displacement vector supplied from the displacement video coding unit 354. The mesh reconstruction unit 355 may reconstruct the restored mesh using the base mesh and the displacement vector. The mesh reconstruction unit 355 may supply the restored mesh to the attribute map conversion unit 356.

The attribute map conversion unit 356 performs processing related to conversion of the attribute map. For example, the attribute map conversion unit 356 may acquire the restored mesh supplied from the mesh reconstruction unit 355. Furthermore, the attribute map conversion unit 356 may acquire the atlas information supplied from the V-DMC data generation unit 331. The attribute map conversion unit 356 may acquire the original mesh input to the file generation device 300. The attribute map conversion unit 356 may acquire the attribute map supplied from the V-DMC data generation unit 331. The attribute map conversion unit 356 may convert the acquired attribute map on the basis of the acquired other information. For example, the attribute map conversion unit 356 may convert the attribute map so as to correspond to the restored mesh on the basis of the atlas information, the original mesh, and the like. In other words, it can also be said that the attribute map conversion unit 356 generates the attribute map after the conversion. Therefore, the attribute map conversion unit 356 can also be referred to as an attribute map generation unit. The attribute map conversion unit 356 may supply the attribute map after the conversion to the attribute video coding unit 357.

The attribute video coding unit 357 performs processing related to coding of the attribute video. For example, the attribute video coding unit 357 may acquire the attribute map supplied from the attribute map conversion unit 356. Furthermore, the attribute video coding unit 357 may generate an attribute video using the acquired attribute map as a frame image. Furthermore, the attribute video coding unit 357 may code the generated attribute video by a predetermined coding scheme for 2D moving images to generate coded data of the attribute video. The attribute video coding unit 357 may supply the generated coded data of the attribute video to the multiplexing unit 358.

The multiplexing unit 358 performs processing related to multiplexing of the coded data (substreams). For example, the multiplexing unit 358 may acquire the coded data of the atlas information supplied from the atlas information coding unit 351. Furthermore, the multiplexing unit 358 may acquire the coded data of the base mesh supplied from the base mesh coding unit 352. Furthermore, the multiplexing unit 358 may acquire the coded data of the geometry video supplied from the displacement video coding unit 354. Furthermore, the multiplexing unit 358 may acquire the coded data of the attribute video supplied from the attribute video coding unit 357. The multiplexing unit 358 may multiplex those coded data as a substream to generate a V-DMC bit stream. Therefore, the multiplexing unit 358 can also be referred to as a bit stream generation unit. The multiplexing unit 358 may supply the generated V-DMC bit stream to the file generation unit 333.

The file generation device 300 having the above configuration may be the first information processing device, and the various methods (the present technology) described above in <3. V-DMC Data Distribution using Scene Description> may be applied.

### <Flow 1 of File Generation Processing>

For example, Method 1-1 described above may be applied to generate a scene description in which 3D data is reconstructed from V-DMC data in MAF. That is, as in the example of FIG. 21, the file generation device 300 may set the reference information to the buffer that stores the geometry of the 3D data reconstructed using the V-DMC data and the reference information to the buffer that stores the attribute of the 3D data reconstructed using the V-DMC data in the scene description.

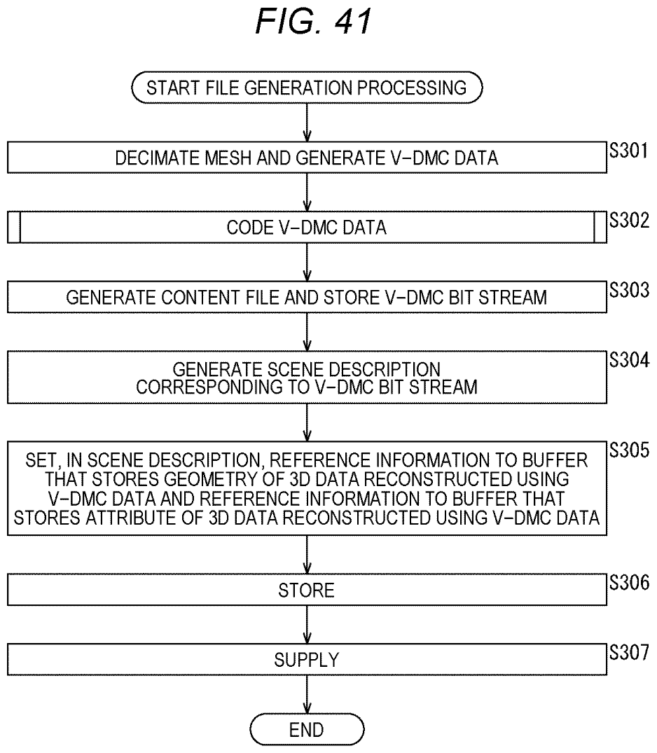

An example of a flow of the file generation processing executed by the file generation device 300 in this case will be described with reference to a flowchart of FIG. 41.

In this case, when the file generation processing is started, the V-DMC data generation unit 331 of the file generation device 300 decimates the mesh and generates V-DMC data in step S301.

In step S302, the V-DMC data coding unit 332 executes V-DMC coding processing, codes the V-DMC data, and generates a V-DMC bit stream.

In step S303, the file generation unit 333 generates a content file and stores the V-DMC bit stream.

In step S304, the scene description generation unit 334 generates a scene description corresponding to the V-DMC bit stream (content file), and generates a scene description file that stores the scene description.

In step S305, the scene description generation unit 334 sets, in the scene description, reference information to a buffer that stores the geometry of the 3D data reconstructed using the V-DMC data and reference information to a buffer that stores the attribute of the 3D data reconstructed using the V-DMC data.

In step S306, the storage unit 335 stores the generated scene description file and content file.

In step S307, the supply unit 336 supplies the scene description file and the content file to the outside of the file generation device 300 (for example, a distribution server, a reproduction device, or the like).

When the processing in step S307 ends, the file generation processing ends.

### <Flow of V-DMC Coding Processing>

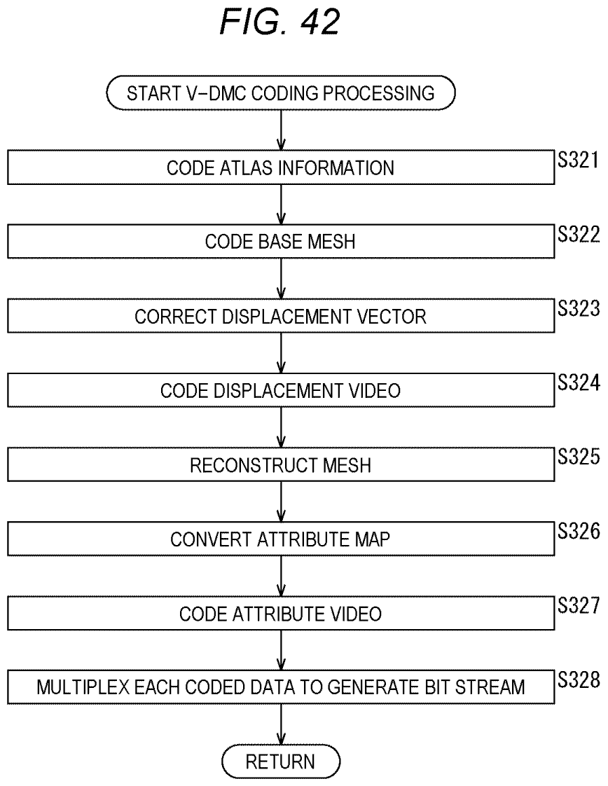

Next, an example of a flow of the V-DMC coding processing executed in step S302 of FIG. 41 will be described with reference to a flowchart of FIG. 42.

When the V-DMC coding processing is started, the atlas information coding unit 351 codes the atlas information and generates coded data of the atlas information in step S321.

In step S322, the base mesh coding unit 352 codes the base mesh and generates coded data of the base mesh.

In step S323, the displacement vector correction unit 353 corrects the displacement vector.

In step S324, the displacement video coding unit 354 converts the displacement video having the displacement map packed with the corrected displacement vectors as a frame image into a geometry video, codes the geometry video with a coding scheme for moving images, and generates coded data of the geometry video.

In step S325, the mesh reconstruction unit 355 reconstructs the mesh (generates a restored mesh).

In step S326, the attribute map conversion unit 356 converts the attribute map.

In step S327, the attribute video coding unit 357 codes the attribute video having the attribute map as a frame image, and generates coded data of the attribute video.

In step S328, the multiplexing unit 358 multiplexes each of the coded data of the atlas information, the coded data of the bit stream, the coded data of the geometry video, and the coded data of the attribute video as a sub stream to generate a V-DMC bit stream.

When the processing in step S328 ends, the V-DMC coding processing ends, and the processing returns to FIG. 41.

By executing each processing as described above, the file generation device 300 can realize MAF reconstruction. That is, the file generation device 300 can realize the distribution of the V-DMC data using the scene description, and can suppress the reduction in the coding efficiency in the distribution of the 3D data using the scene description.

### <Flow 2 of File Generation Processing>

In addition, by applying Method 1-2 described above, the submesh association information may be supplied from the MAF to the PE, and a scene description may be generated such that the 3D data is reconstructed from the V-DMC data by using the submesh association information in the PE. For example, the file generation device 300 may generate a scene description representing a scene configured by a 3D object, and set the first reference information to the first buffer that stores submesh association information in the scene description.

In this way, the file generation device 300 can realize the PE reconstruction, and can improve the processing efficiency of the decoding processing as compared with the case of the MAF reconstruction. That is, the file generation device 300 can suppress a reduction in the processing efficiency of the decoding processing.

In that case, for example, Method 1-2-1 described above may be applied, and the file generation device 300 may newly define the reference information to the buffer that stores the submesh association information as in the example of FIG. 27 or FIG. 28 in the scene description. That is, the first buffer that stores submesh association information may be a buffer different from a second buffer that stores data of the mesh.

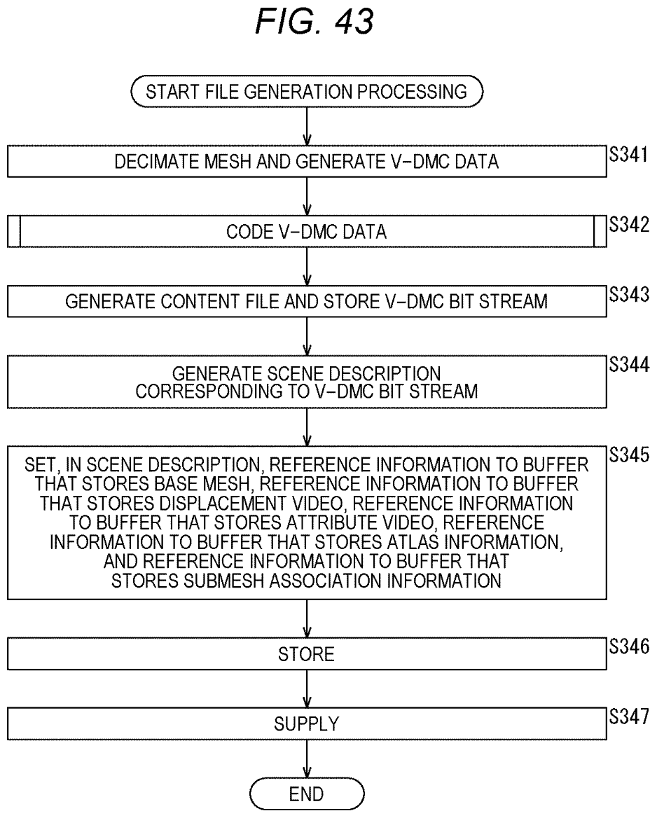

An example of a flow of the file generation processing executed by the file generation device 300 in this case will be described with reference to a flowchart of FIG. 43.

In the file generation processing in this case, each processing from step S341 to step S344 is executed similarly to each processing from step S301 to step S304 of FIG. 41. Note that the V-DMC coding processing in step S342 is executed in a flow similar to that in the example of FIG. 42.

In step S345, the scene description generation unit 334 sets, in the scene description, reference information to a buffer that stores the base mesh, reference information to a buffer that stores the displacement video, reference information to a buffer that stores the attribute video, reference information to a buffer that stores the atlas information, and reference information to a buffer that stores the submesh association information.

Then, each processing of steps S346 and S347 is executed similarly to each processing of steps S306 and S307 of FIG. 41.

When the processing of step S347 ends, the file generation processing ends.

By executing each processing as described above, the file generation device 300 can realize the PE reconstruction, and can improve the processing efficiency of the decoding processing as compared with the case of the MAF reconstruction. That is, the file generation device 300 can suppress a reduction in the processing efficiency of the decoding processing.

### <Flow 3 of File Generation Processing>

In addition, Method 1-2-2 described above may be applied, and the file generation device 300 may store the submesh association information by extending the atlas data in the scene description as in the example of FIG. 32. That is, the first buffer that stores submesh association information may be configured to store atlas information including the submesh association information.

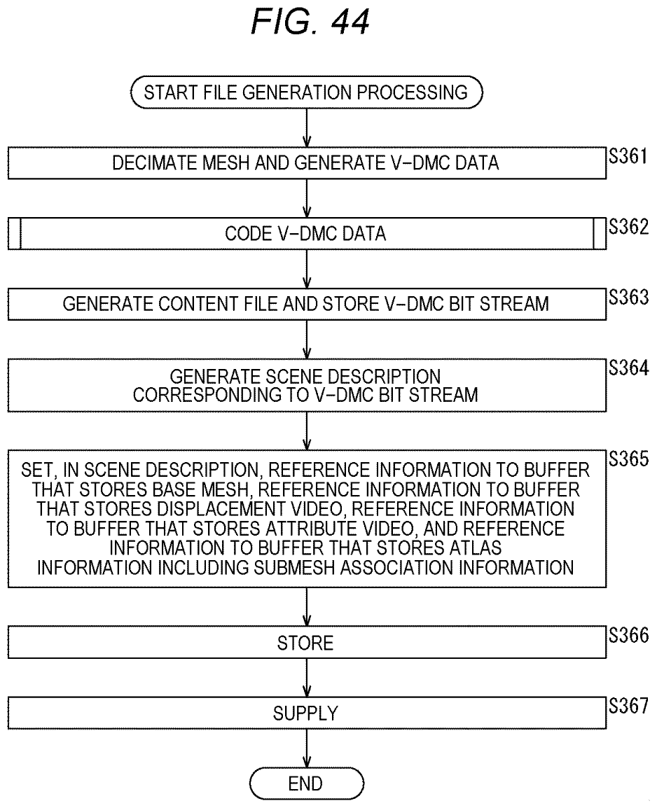

An example of a flow of the file generation processing executed by the file generation device 300 in this case will be described with reference to a flowchart of FIG. 44.

In the file generation processing in this case, each processing from step S361 to step S364 is executed similarly to each processing from step S301 to step S304 of FIG. 41. Note that the V-DMC coding processing in step S362 is executed in a flow similar to that in the example of FIG. 42.

In step S365, the scene description generation unit 334 sets, in the scene description, reference information to a buffer that stores the base mesh, reference information to a buffer that stores the displacement video, reference information to a buffer that stores the attribute video, and reference information to a buffer that stores the atlas information including the submesh association information.

Then, each processing of steps S366 and S367 is executed similarly to each processing of steps S306 and S307 of FIG. 41.

When the processing of step S367 ends, the file generation processing ends.

By executing each processing as described above, the file generation device 300 can realize the PE reconstruction, and can improve the processing efficiency of the decoding processing as compared with the case of the MAF reconstruction. That is, the file generation device 300 can suppress a reduction in the processing efficiency of the decoding processing.

### <Flow 4 of File Generation Processing>

In addition, Method 1-2-3 described above may be applied, and the file generation device 300 may store the submesh association information by extending the base mesh in the scene description as in the example of FIG. 34. That is, it may be configured to store the base mesh including the submesh association information.

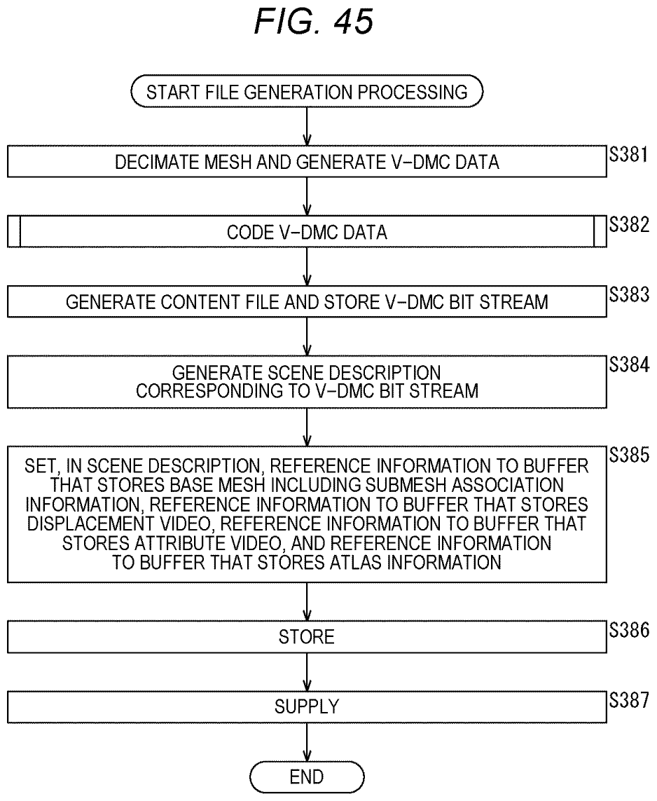

An example of a flow of the file generation processing executed by the file generation device 300 in this case will be described with reference to a flowchart of FIG. 45.

In the file generation processing in this case, each processing from step S381 to step S384 is executed similarly to each processing from step S301 to step S304 of FIG. 41. Note that the V-DMC coding processing in step S382 is executed in a flow similar to that in the example of FIG. 42.

In step S385, the scene description generation unit 334 sets, in the scene description, reference information to a buffer that stores the base mesh including the submesh association information, reference information to a buffer that stores the displacement video, reference information to a buffer that stores the attribute video, and reference information to a buffer that stores the atlas information.

Then, each processing of steps S386 and S387 is executed similarly to each processing of steps S306 and S307 of FIG. 41.

When the processing of step S387 ends, the file generation processing ends.

By executing each processing as described above, the file generation device 300 can realize the PE reconstruction, and can improve the processing efficiency of the decoding processing as compared with the case of the MAF reconstruction. That is, the file generation device 300 can suppress a reduction in the processing efficiency of the decoding processing.

### <Flow 5 of File Generation Processing>

In addition, Method 1-2-4 described above may be applied, the subdivision information may be supplied from the MAF to the PE, and the base mesh may be subdivided in the PE by using the subdivision information. That is, in the file generation device 300, the scene description generation unit may set, in the scene description, the second reference information to the second buffer that stores the subdivision information related to subdivision of the base mesh from which the vertices of the mesh have been thinned out.

For example, Method 1-2-1 and Method 1-2-4 may be applied, and the file generation device 300 may set, in the scene description, the first reference information to the first buffer that stores submesh association information and the second reference information to the second buffer that is different from the first buffer and that stores the atlas information including the subdivision information.

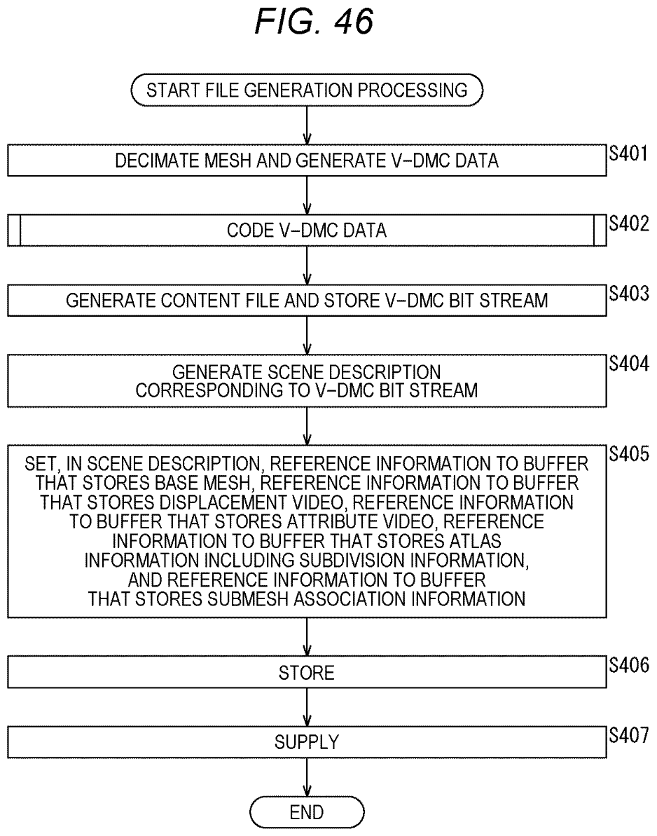

An example of a flow of the file generation processing executed by the file generation device 300 in this case will be described with reference to a flowchart of FIG. 46.

In the file generation processing in this case, each processing from step S401 to step S404 is executed similarly to each processing from step S301 to step S304 of FIG. 41. Note that the V-DMC coding processing in step S402 is executed in a flow similar to that in the example of FIG. 42.

In step S405, the scene description generation unit 334 sets, in the scene description, reference information to a buffer that stores the base mesh, reference information to a buffer that stores the displacement video, reference information to a buffer that stores the attribute video, reference information to a buffer that stores the atlas information including the subdivision information, and reference information to a buffer that stores the submesh association information.

Then, each processing of steps S406 and S407 is executed similarly to each processing of steps S306 and S307 of FIG. 41.

When the processing of step S407 ends, the file generation processing ends.

By executing each processing as described above, the file generation device 300 can realize the PE reconstruction, and can improve the processing efficiency of the decoding processing as compared with the case of the MAF reconstruction. In addition, since the PE can acquire the subdivision information and subdivide the base mesh on the basis of the subdivision information, the file generation device 300 can further improve the processing efficiency of the decoding processing as compared with the case of applying only Method 1-2-1.

### <Flow 6 of File Generation Processing>

In addition, Method 1-2-2 and Method 1-2-4 may be applied, and the file generation device 300 may set, in the scene description, reference information to a buffer that stores the atlas information including the submesh association information and the subdivision information.

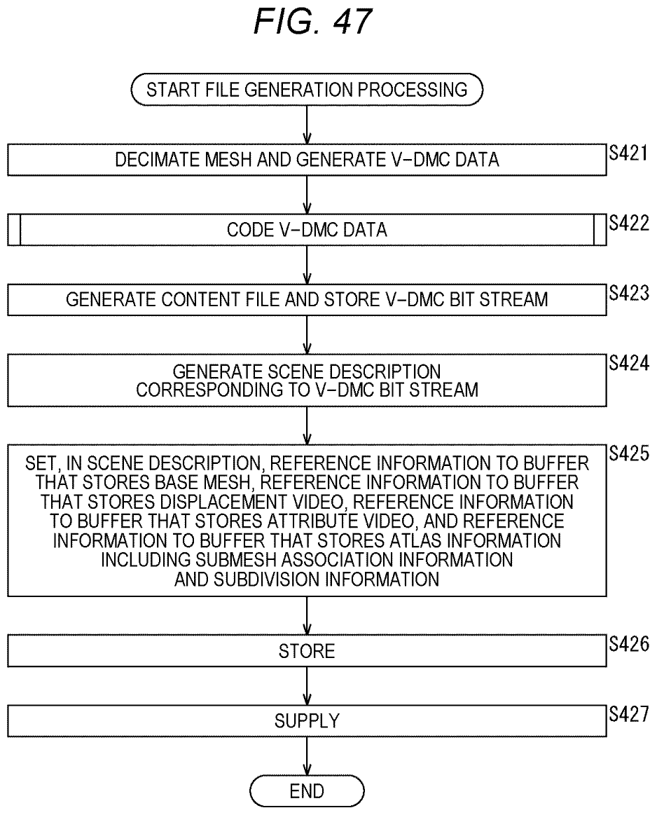

An example of a flow of the file generation processing executed by the file generation device 300 in this case will be described with reference to a flowchart of FIG. 47.

In the file generation processing in this case, each processing from step S421 to step S424 is executed similarly to each processing from step S301 to step S304 of FIG. 41. Note that the V-DMC coding processing in step S422 is executed in a flow similar to that in the example of FIG. 42.

In step S425, the scene description generation unit 334 sets, in the scene description, reference information to a buffer that stores the base mesh, reference information to a buffer that stores the displacement video, reference information to a buffer that stores the attribute video, and reference information to a buffer that stores the atlas information including the submesh association information and the subdivision information.

Then, each processing of steps S426 and S427 is executed similarly to each processing of steps S306 and S307 of FIG. 41.

When the processing of step S427 ends, the file generation processing ends.

By executing each processing as described above, the file generation device 300 can realize the PE reconstruction, and can improve the processing efficiency of the decoding processing as compared with the case of the MAF reconstruction. In addition, since the PE can acquire the subdivision information and subdivide the base mesh on the basis of the subdivision information, the file generation device 300 can further improve the processing efficiency of the decoding processing as compared with the case of applying only Method 1-2-2.

### <Flow 7 of File Generation Processing>

In addition, Method 1-2-3 and Method 1-2-4 may be applied, and the file generation device 300 may set, in the scene description, the first reference information to the first buffer that stores the base mesh including the submesh association information and the second reference information to the second buffer that stores the atlas information including the subdivision information.

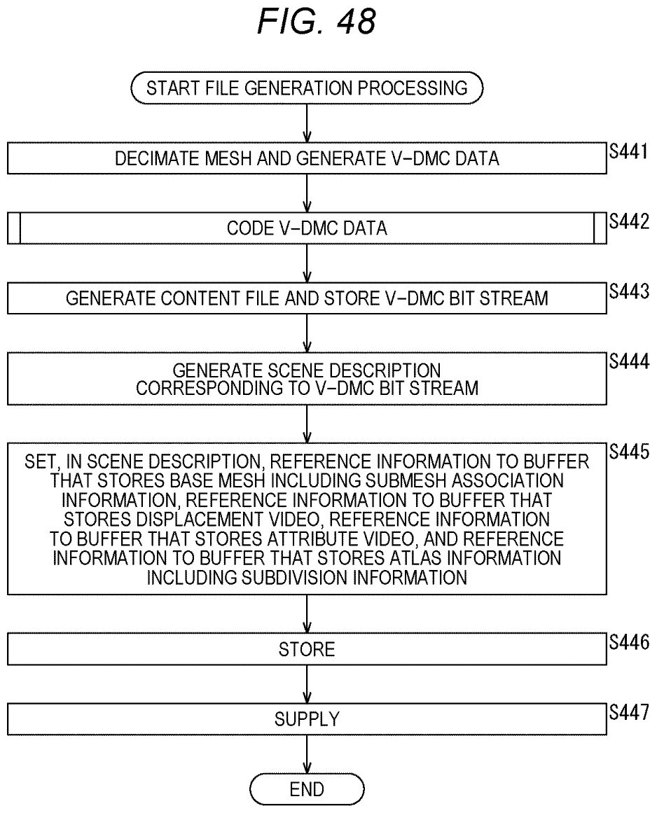

An example of a flow of the file generation processing executed by the file generation device 300 in this case will be described with reference to a flowchart of FIG. 48.

In the file generation processing in this case, each processing from step S441 to step S444 is executed similarly to each processing from step S301 to step S304 of FIG. 41. Note that the V-DMC coding processing in step S442 is executed in a flow similar to that in the example of FIG. 42.

In step S445, the scene description generation unit 334 sets, in the scene description, reference information to a buffer that stores the base mesh including the submesh association information, reference information to a buffer that stores the displacement video, reference information to a buffer that stores the attribute video, and reference information to a buffer that stores the atlas information including the subdivision information.

Then, each processing of steps S446 and S447 is executed similarly to each processing of steps S306 and S307 of FIG. 41.

When the processing of step S447 ends, the file generation processing ends.

By executing each processing as described above, the file generation device 300 can realize the PE reconstruction, and can improve the processing efficiency of the decoding processing as compared with the case of the MAF reconstruction. In addition, since the PE can acquire the subdivision information and subdivide the base mesh on the basis of the subdivision information, the file generation device 300 can further improve the processing efficiency of the decoding processing as compared with the case of applying only Method 1-2-2.

### 5. Second Embodiment

### <Application of Method 1-1>

### <Reproduction Device>

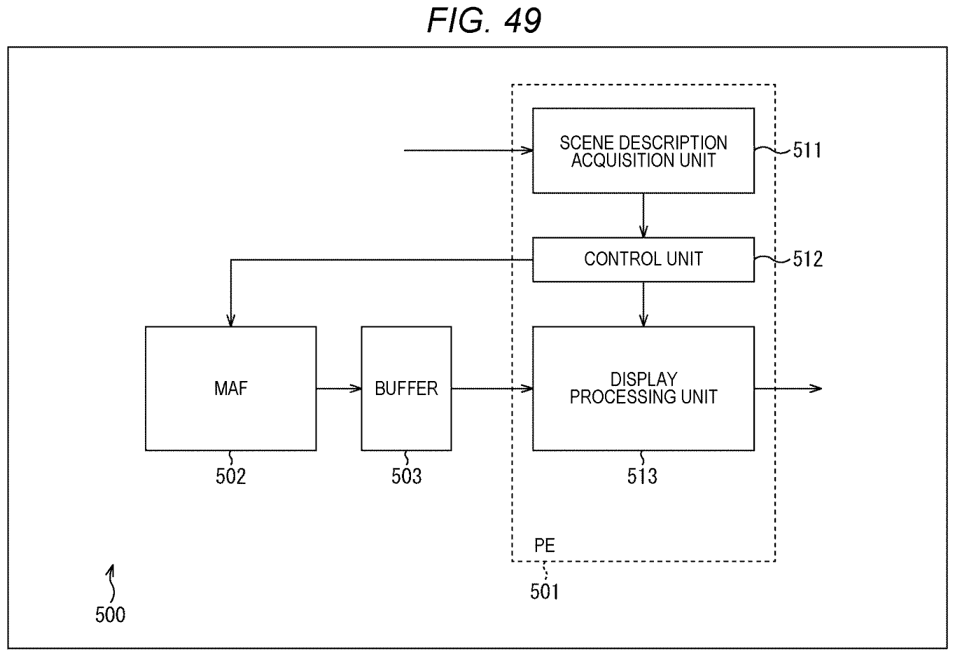

The above-described present technology can be applied to any device. FIG. 49 is a block diagram illustrating an example of a configuration of a reproduction device which is an aspect of an information processing device to which the present technology is applied. A reproduction device 500 illustrated in FIG. 49 is a reproduction device that performs a reproduction processing of mesh data (V-DMC data). For example, the reproduction device 500 acquires the scene description generated by the file generation device 300, acquires the content file generated by the file generation device 300 on the basis of the scene description, decodes the V-DMC bit stream stored in the content file, and reproduces the V-DMC data. That is, the reproduction device 500 reconstructs the mesh using the V-DMC data, performs rendering to generate a display image, and displays the display image.

Note that, FIG. 49 illustrates main parts of processing units, data flows, and the like, and those illustrated in FIG. 49 are not necessarily all. That is, in the reproduction device 500, there may be a processing unit not illustrated as a block in FIG. 49, or there may be processing or a data flow not illustrated as an arrow or the like in FIG. 49.

As illustrated in FIG. 49, the reproduction device 500 includes a presentation engine (PE) 501, a media access function (MAF) 502, and a buffer 503. In addition, the PE 501 includes a scene description acquisition unit 511, a control unit 512, and a display processing unit 513.

The scene description acquisition unit 511 executes processing related to acquisition of a scene description. For example, the scene description acquisition unit 511 may acquire the scene description file generated by the file generation device 300. The scene description acquisition unit 511 may supply the acquired scene description file to the control unit 512.

The PE 501 executes processing related to control using the scene description.

The control unit 512 executes processing related to control of decoding processing. For example, the control unit 512 may acquire the scene description file supplied from the scene description acquisition unit 511. The control unit 512 may control the MAF 502 on the basis of the scene description stored in the scene description file. Furthermore, the control unit 512 may control the display processing unit 513 on the basis of the scene description.

The MAF 502 performs processing related to a content file. For example, the MAF 502 may execute acquisition of a content file, decoding of a bit stream, and the like under the control of (the control unit 512 of) the PE 501. Further, the MAF 502 may store the decoded data in the buffer 503.

The buffer 503 has a storage area and executes processing related to storage of information. For example, the buffer 503 may store the data supplied from the MAF in its own storage area. In addition, the buffer 503 may supply data stored in its own storage area to the PE. That is, the MAF 502 may supply the data related to the content to (the display processing unit 513 of) the PE 501 via the buffer 503.

The display processing unit 513 executes processing related to display of content. For example, the display processing unit 513 may acquire data related to content from the buffer 503. The display processing unit 513 may generate the display information of the content by using the acquired data. For example, the display processing unit 513 may generate the display information by rendering the 3D data or the like. Here, the display information indicates information to be displayed. For example, a display image (an image to be displayed) or the like can be included in the display information. The display processing unit 513 may supply the generated display information to a display device (not illustrated) to be displayed.

The reproduction device 500 having such a configuration may be the second information processing device, and the various methods (the present technology) described above in <3. V-DMC Data Distribution using Scene Description> may be applied.

For example, Method 1-1 described above may be applied such that the MAF 502 reconstructs the 3D data from the V-DMC data. That is, the MAF 502 may store the geometry of the 3D data reconstructed using the V-DMC data and the attribute of the 3D data reconstructed using the V-DMC data in the buffer 503 on the basis of the scene description. The PE 501 may acquire the geometry and the attribute of the reconstructed 3D data from the buffer 503 and generate the display information using the data. That is, the reproduction device 500 may execute the MAF reconstruction as in the example of FIG. 21.

### <MAF>

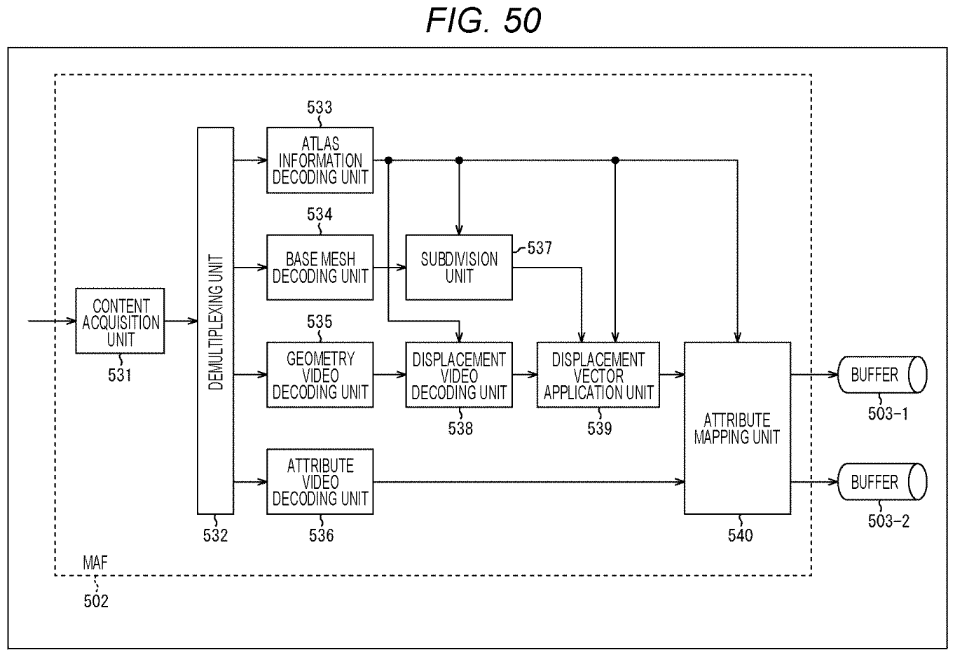

FIG. 50 illustrates a main configuration example of the MAF 502 in a case where Method 1-1 described above is applied. Note that, FIG. 50 illustrates main parts of processing units, data flows, and the like, and those illustrated in FIG. 50 are not necessarily all. That is, in the MAF 502, there may be a processing unit not illustrated as a block in FIG. 50, or there may be processing or a data flow not illustrated as an arrow or the like in FIG. 50.

As illustrated in FIG. 50, in this case, the MAF 502 includes a content acquisition unit 531, a demultiplexing unit 532, an atlas information decoding unit 533, a base mesh decoding unit 534, a geometry video decoding unit 535, an attribute video decoding unit 536, a subdivision unit 537, a displacement video decoding unit 538, a displacement vector application unit 539, and an attribute mapping unit 540.

The content acquisition unit 531 executes processing related to content acquisition. For example, the content acquisition unit 531 may acquire the designated content file under the control of (the control unit 512 of) the PE 501. Further, the V-DMC bit stream may be acquired from the content file. The content acquisition unit 531 may supply the V-DMC bit stream to the demultiplexing unit 532.

The demultiplexing unit 532 performs processing related to demultiplexing. For example, the demultiplexing unit 532 may acquire the V-DMC bit stream supplied from content acquisition unit 531. Furthermore, the demultiplexing unit 532 may demultiplex the acquired V-DMC bit stream, and extract the coded data (sub stream) of the atlas information, the coded data (sub stream) of the base mesh, the coded data (sub stream) of the geometry video, and the coded data (sub stream) of the attribute video. Therefore, the demultiplexing unit 532 can also be referred to as an acquisition unit of various types of information included in the V-DMC bit stream. The demultiplexing unit 532 may supply the coded data (sub stream) of the extracted atlas information to the atlas information decoding unit 533. Furthermore, the demultiplexing unit 532 may supply the extracted coded data (sub stream) of the base mesh to the base mesh decoding unit 534. Furthermore, the demultiplexing unit 532 may supply the coded data (sub stream) of the extracted geometry video to the geometry video decoding unit 535. Furthermore, the demultiplexing unit 532 may supply the coded data (sub stream) of the extracted attribute video to the attribute video decoding unit 536.

The atlas information decoding unit 533 performs processing related to decoding of the coded data (sub stream) of the atlas information. For example, the atlas information decoding unit 533 may acquire the coded data (sub stream) of the atlas information supplied from the demultiplexing unit 532. In addition, the atlas information decoding unit 533 may decode the coded data (sub stream) of the acquired atlas information to generate (restore) the atlas information. The atlas information decoding unit 533 may supply the atlas information to the subdivision unit 537, the displacement video decoding unit 538, the displacement vector application unit 539, and the attribute mapping unit 540.

The base mesh decoding unit 534 performs processing related to decoding of the coded data (sub stream) of the base mesh. For example, the base mesh decoding unit 534 may acquire the coded data (sub stream) of the base mesh supplied from the demultiplexing unit 532. Furthermore, the base mesh decoding unit 534 may decode the acquired coded data (sub stream) of the base mesh by a predetermined decoding scheme (for example, Draco or the like), and generate (restore) information (for example, a vertex list, a triangle list, or the like) related to the base mesh. The base mesh decoding unit 534 may further reconfigure the base mesh using the information related to the base mesh (may generate a restored base mesh). The base mesh decoding unit 534 may supply the base mesh (restored base mesh) to the subdivision unit 537.

The geometry video decoding unit 535 executes processing related to decoding of the coded data (substream) of the geometry video. For example, the geometry video decoding unit 535 may acquire the coded data (substream) of the geometry video supplied from the demultiplexing unit 532. Furthermore, the geometry video decoding unit 535 may decode the coded data (sub stream) of the geometry video by a predetermined decoding scheme for 2D moving images to generate (restore) the geometry video. The geometry video decoding unit 535 may supply the generated geometry video to the displacement video decoding unit 538.

The attribute video decoding unit 536 executes processing related to decoding of the coded data (sub stream) of the attribute video. For example, the attribute video decoding unit 536 may acquire the coded data (sub stream) of the attribute video supplied from the demultiplexing unit 532. Furthermore, the attribute video decoding unit 536 may decode the coded data of the attribute video by a predetermined decoding scheme for 2D moving images, and generate (restore) the attribute video. The attribute video decoding unit 536 may supply the attribute video to the attribute mapping unit 540.

The subdivision unit 537 performs processing related to subdivision of the triangles of the base mesh (restored base mesh). For example, the subdivision unit 537 may acquire the base mesh (restored base mesh) supplied from the base mesh decoding unit 534. The subdivision unit 537 may acquire atlas information (for example, a subdivision method, identification information of submesh (submesh id), identification information of subpart (subpart id), and the like) supplied from the atlas information decoding unit 533. The subdivision unit 537 may subdivide triangles of the base mesh (restored base mesh) on the basis of the atlas information to generate division points. The subdivision unit 537 may supply the subdivided base mesh (subdivided restoration base mesh) to the displacement vector application unit 539.

The displacement video decoding unit 538 executes processing related to decoding (conversion) of the geometry video. For example, the displacement video decoding unit 538 may acquire the geometry video supplied from the geometry video decoding unit 535. The displacement video decoding unit 538 may acquire atlas information (for example, a transform method, transform parameters, 2D patch information, and the like) supplied from the atlas information decoding unit 533. The displacement video decoding unit 538 may convert the geometry video into the displacement video on the basis of the atlas information. The displacement video decoding unit 538 may supply the displacement video generated in this manner to the displacement vector application unit 539.

The displacement vector application unit 539 performs processing related to application of the displacement vector to the subdivided base mesh (subdivided restored base mesh). For example, the displacement vector application unit 539 may acquire the subdivided base mesh (subdivided restoration base mesh) supplied from the subdivision unit 537. The displacement vector application unit 539 may acquire atlas information (for example, 2D patch information (2d patch information), subpart identification information (subpart id), and the like) supplied from the atlas information decoding unit 533. The displacement vector application unit 539 may acquire the displacement video supplied from the displacement video decoding unit 538. The displacement vector application unit 539 may unpack the displacement vector from the displacement video. The displacement vector application unit 539 may apply the displacement vector to vertices of the subdivided base mesh (subdivided restored base mesh). That is, the displacement vector application unit 539 may reconstruct a mesh (geometry) corresponding to the original mesh. In the present specification, the mesh (geometry) corresponding to the original mesh is also referred to as a decoded mesh. The displacement vector application unit 539 may supply the generated decoded mesh (geometry of the reconstructed 3D data) to the attribute mapping unit 540.

The attribute mapping unit 540 executes processing related to mapping of attributes. For example, the attribute mapping unit 540 may acquire the atlas information supplied from the atlas information decoding unit 533. The attribute mapping unit 540 may acquire the attribute video supplied from the attribute video decoding unit 536. The attribute mapping unit 540 may unpack the attribute from the attribute video. The attribute mapping unit 540 may acquire the decoded mesh (geometry of the reconstructed 3D data) supplied from the displacement vector application unit 539. The attribute mapping unit 540 may map the attribute to the face of the decoded mesh (geometry of the reconstructed 3D data) on the basis of the atlas information. The attribute mapping unit 540 may store the decoded mesh (geometry of the reconstructed 3D data) in a buffer 503-1. Furthermore, the attribute mapping unit 540 may store the attribute mapped to the decoded mesh (attribute of the reconstructed 3D data) in a buffer 503-2.

The buffer 503-1 and the buffer 503-2 are different buffer areas formed in the buffer 503 (FIG. 49). That is, the geometry and the attribute of the reconstructed 3D data are stored in different buffers. That is, the geometry and the attribute of the reconstructed 3D data are supplied to the PE 501 via buffers different from each other.

With such a configuration, the reproduction device 500 can realize the MAF reconstruction. That is, the reproduction device 500 can realize the distribution of the V-DMC data using the scene description, and can suppress the reduction in the coding efficiency in the distribution of the 3D data using the scene description.

### <Flow 1 of Reproduction Processing>

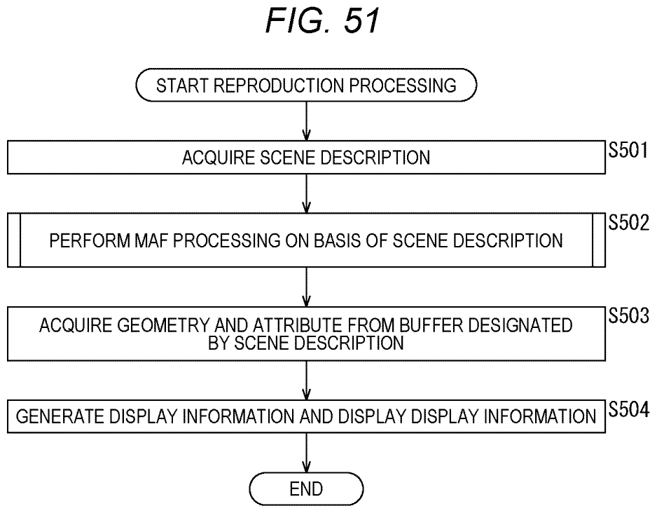

An example of a flow of reproduction processing executed by the reproduction device 500 having such a configuration will be described with reference to a flowchart of FIG. 51.

When the reproduction processing is started, the scene description acquisition unit 511 of the reproduction device 500 acquires the scene description in step S501.

In step S502, the MAF 502 performs MAF processing on the basis of the scene description, generates the geometry and the attribute of the reconstructed 3D data, and stores the geometry and the attribute in a buffer.

In step S503, the display processing unit 513 acquires the geometry and the attribute of the reconstructed 3D data from the buffer designated by the scene description. In the case of the example of FIG. 50, the display processing unit 513 acquires the geometry of the reconstructed 3D data from the buffer 503-1, and acquires the attribute of the reconstructed 3D data from the buffer 503-2.

In step S504, the display processing unit 513 generates display information related to the reconstructed 3D data using the acquired geometry and attribute, and causes the display device to display the display information. For example, the display processing unit 513 performs rendering or the like of the reconstructed 3D data and generates display information.

When the processing of step S504 ends, the reproduction processing ends.

### <MAF Processing Flow 2>

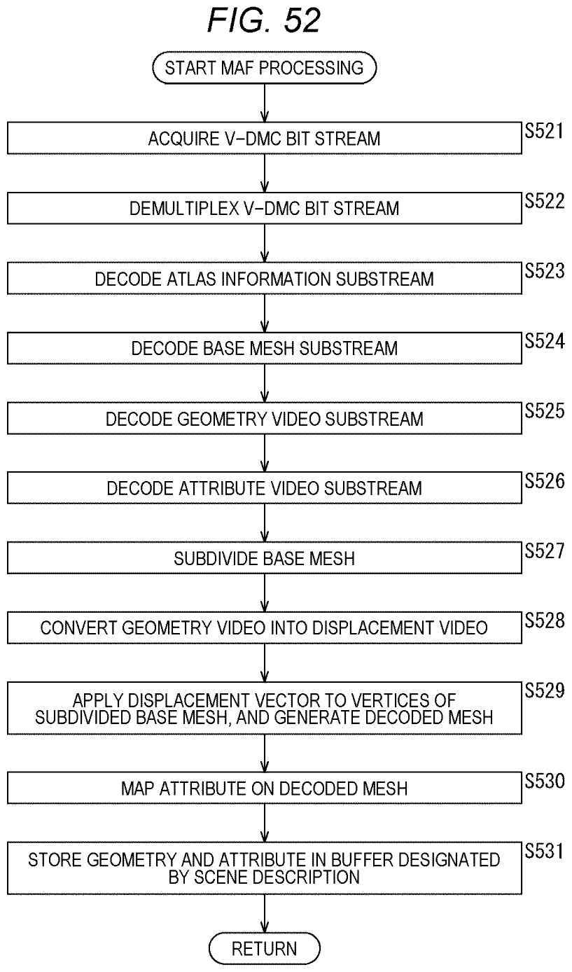

Next, an example of a flow of the MAF processing executed in step S502 of FIG. 51 will be described with reference to a flowchart of FIG. 52.

When the MAF processing is started, the content acquisition unit 531 acquires the content (V-DMC bit stream) in step S521.

In step S522, the demultiplexing unit 532 demultiplexes the V-DMC bit stream to generate an atlas information substream, a base mesh substream, a geometry video substream, and an attribute video substream.

In step S523, the atlas information decoding unit 533 decodes the atlas information substream to generate (restore) atlas information.

In step S524, the base mesh decoding unit 534 decodes the base mesh substream to generate (restore) the base mesh.

In step S525, the geometry video decoding unit 535 decodes the geometry video substream to generate (restore) the geometry video.

In step S526, the attribute video decoding unit 536 decodes the attribute video substream to generate (restore) the attribute video.

In step S527, the subdivision unit 537 subdivides the base mesh.

In step S528, the displacement video decoding unit 538 converts the geometry video into the displacement video.

In step S529, the displacement vector application unit 539 unpacks the displacement vector from the displacement video, applies the displacement vector to the vertices of the subdivided base mesh, and generates a decoded mesh.

In step S530, the attribute mapping unit 540 unpacks the attribute from the attribute video and maps the attribute to the decoded mesh.

In step S531, the attribute mapping unit 540 stores the geometry and the attribute of the reconstructed 3D data in a buffer designated by the scene description. For example, the attribute mapping unit 540 stores the geometry of the reconstructed 3D data in the buffer 503-1, and stores the attribute of the reconstructed 3D data in the buffer 503-2.

When the processing of step S531 ends, the MAF processing ends, and the processing returns to FIG. 51.

By executing each processing as described above, the reproduction device 500 can realize the MAF reconstruction. That is, the reproduction device 500 can realize the distribution of the V-DMC data using the scene description, and can suppress the reduction in the coding efficiency in the distribution of the 3D data using the scene description.

### <Application of Method 1-2>

### <Reproduction Device>

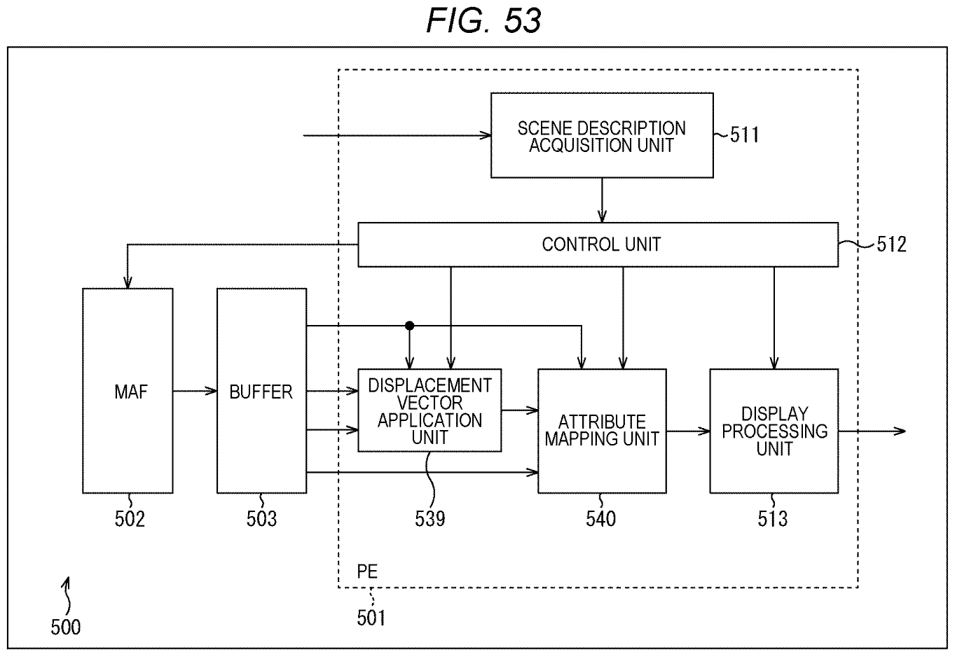

For example, Method 1-2 described above may be applied to the reproduction device 500. That is, the reproduction device 500 may execute the PE reconstruction as in the example of FIG. 22. In this case, for example, as illustrated in FIG. 53, the PE 501 may include the displacement vector application unit 539 and the attribute mapping unit 540 in addition to the configuration illustrated in FIG. 49. The displacement vector application unit 539 and the attribute mapping unit 540 execute processing similar to the case of the example of FIG. 50. That is, the MAF 502 may perform subdivision (subdivision) of the base mesh, and the PE 501 may perform displacement (refinement) of vertices by displacement vectors (displacement) and mapping of attributes. In this case, the MAF 502 supplies the subdivided base mesh to the PE 501 via the buffer 503.

In this way, the reproduction device 500 can improve the processing efficiency of the decoding processing as compared with the case of MAF reconstruction. That is, the reproduction device 500 can suppress a decrease in the processing efficiency of the decoding processing.

### <Application of Method 1-2-1>

### <MAF>

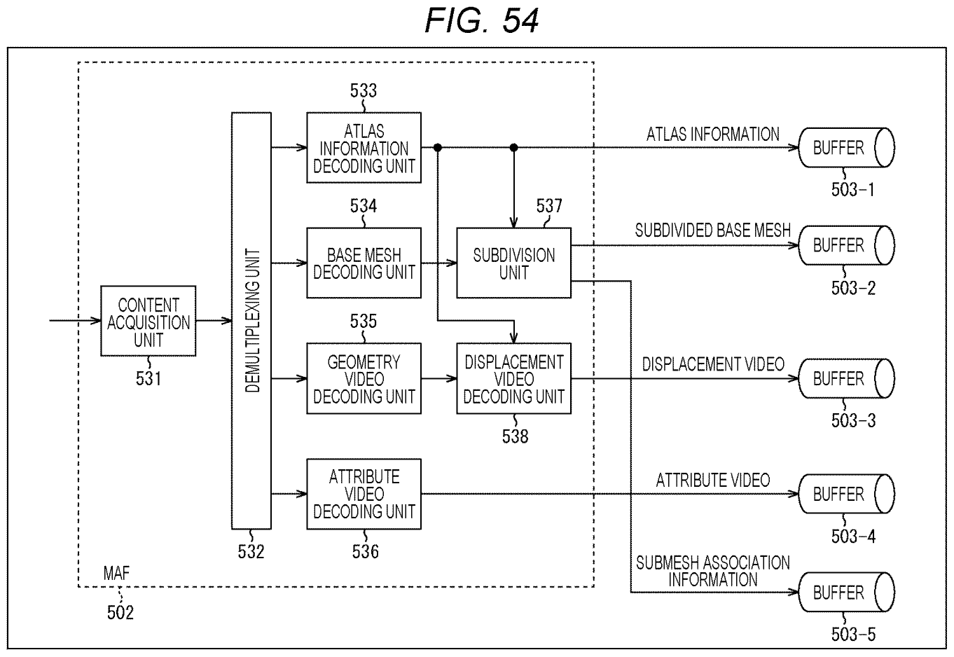

In the reproduction device 500 having such a configuration, for example, Method 1-2-1 described above may be applied. That is, in the scene description, reference information to a buffer that stores the submesh association information may be newly defined. In that case, the MAF 502 may have a configuration as illustrated in FIG. 54.

Note that, FIG. 54 illustrates main parts of processing units, data flows, and the like, and those illustrated in FIG. 54 are not necessarily all. That is, in the MAF 502, there may be a processing unit not illustrated as a block in FIG. 54, or there may be processing or a data flow not illustrated as an arrow or the like in FIG. 54.

As illustrated in FIG. 54, in this case, the MAF 502 may include the content acquisition unit 531 to the displacement video decoding unit 538 in the configuration of the MAF 502 described with reference to FIG. 50. Each of these processing units may execute processing similar to that in the example of FIG. 50.

However, the atlas information decoding unit 533 may store the atlas information in the buffer 503-1. The subdivision unit 537 may store the subdivided base mesh in the buffer 503-2. The displacement video decoding unit 538 may store the displacement video in the buffer 503-3. The attribute video decoding unit 536 may store the attribute video in a buffer 503-4. The subdivision unit 537 may store the submesh association information in a buffer 503-5.

The buffers from the buffer 503-1 to the buffer 503-5 are mutually different buffer areas formed in the buffer 503 (FIG. 53). That is, in the case of this example, the submesh association information is stored in a buffer different from the V-DMC data. Therefore, the displacement vector application unit 539 and the attribute mapping unit 540 (FIG. 53) of the PE 501 acquire the V-DMC data and the submesh association information from the buffer 503-1 to the buffer 503-5, respectively. In other words, the submesh association information is supplied to the PE 501 via a buffer different from the V-DMC data.

With such a configuration, the reproduction device 500 can realize the PE reconstruction. That is, the reproduction device 500 can improve the processing efficiency of the decoding processing as compared with the case of the MAF reconstruction. That is, the reproduction device 500 can suppress a decrease in the processing efficiency of the decoding processing.

### <Flow 2 of Reproduction Processing>

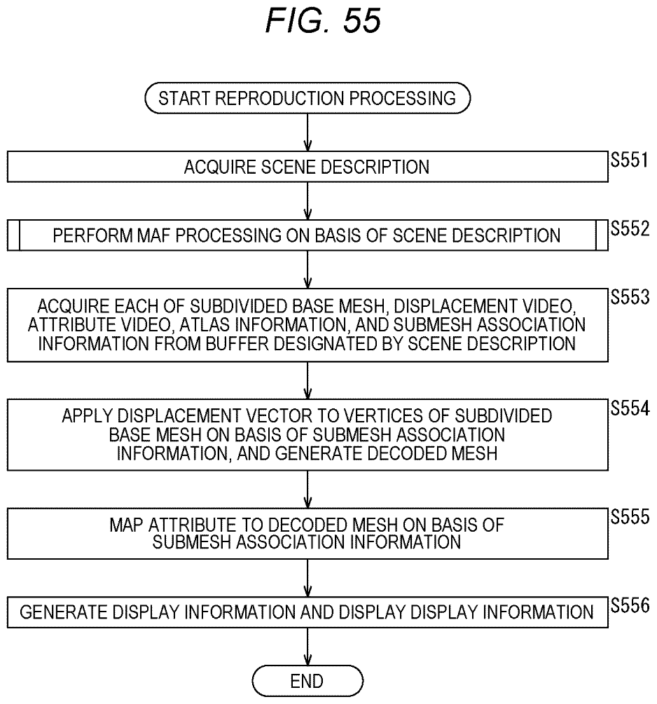

An example of a flow of reproduction processing executed by the reproduction device 500 having such a configuration will be described with reference to a flowchart of FIG. 55.

When the reproduction processing is started, the scene description acquisition unit 511 of the reproduction device 500 acquires the scene description in step S551.

In step S552, the MAF 502 executes MAF processing on the basis of the scene description, generates V-DMC data and submesh association information, and stores the V-DMC data and the submesh association information in the buffer 503.

In step S553, the PE 501 acquires each of the subdivided base mesh, displacement video, attribute video, atlas information, and submesh association information from the buffer designated by the scene description.

In step S554, the displacement vector application unit 539 of the PE 501 applies the displacement vector to the vertices of the subdivided base mesh on the basis of the submesh association information, and generates a decoded mesh. That is, the displacement vector application unit 539 generates the geometry of the reconstructed 3D data.

In step S555, the attribute mapping unit 540 of the PE 501 maps the attribute to the decoded mesh on the basis of the submesh association information. That is, the attribute mapping unit 540 generates an attribute of the reconstructed 3D data.

In step S556, the display processing unit 513 of the PE 501 generates and displays the display information using the decoded mesh (geometry of the reconstructed 3D data) and the attribute (attribute of the reconstructed 3D data) mapped to the decoded mesh.

When the processing of step S556 ends, the reproduction processing ends.

### <MAF Processing Flow 2>

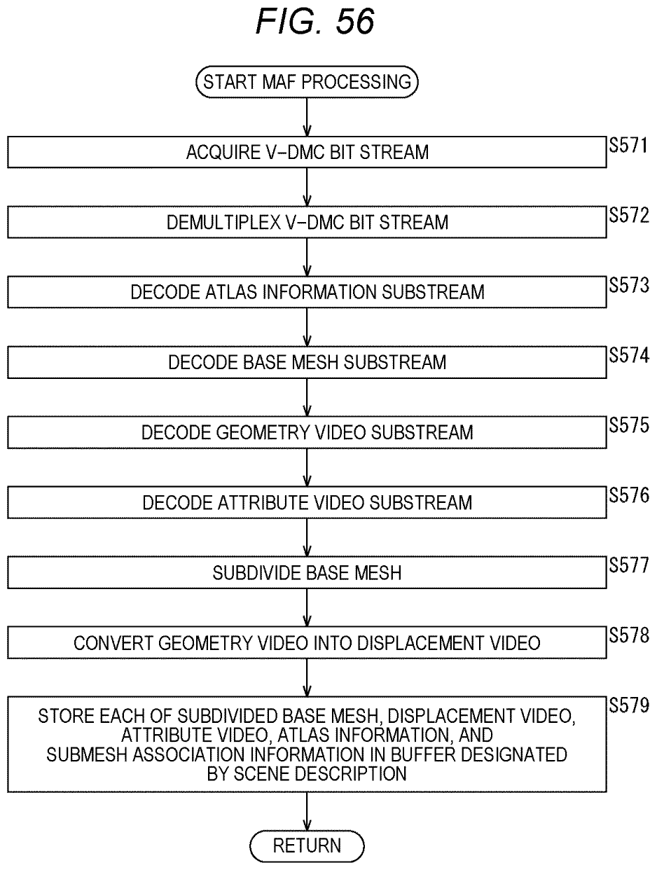

Next, an example of a flow of the MAF processing executed in step S552 of FIG. 55 will be described with reference to a flowchart of FIG. 56.

In the MAF processing in this case, each processing from step S571 to step S578 is executed similarly to each processing from step S521 to step S528 of FIG. 52.

In step S579, the MAF 502 stores each of the subdivided base mesh, the displacement video, the attribute video, the atlas information, and the submesh association information in the buffer designated by the scene description. That is, the subdivision unit 537 stores the subdivided base mesh in the buffer 503-2. The displacement video decoding unit 538 stores the displacement video in the buffer 503-3. The attribute video decoding unit 536 stores the attribute video in the buffer 503-4. The atlas information decoding unit 533 stores the atlas information in the buffer 503-1. The subdivision unit 537 stores the submesh association information in the buffer 503-5.

When the processing of step S579 ends, the MAF processing ends, and the processing returns to FIG. 55.

By executing each processing as described above, the reproduction device 500 can realize the PE reconstruction. That is, the reproduction device 500 can improve the processing efficiency of the decoding processing as compared with the case of the MAF reconstruction. That is, the reproduction device 500 can suppress a decrease in the processing efficiency of the decoding processing.

### <Application of Method 1-2-2>

### <MAF>

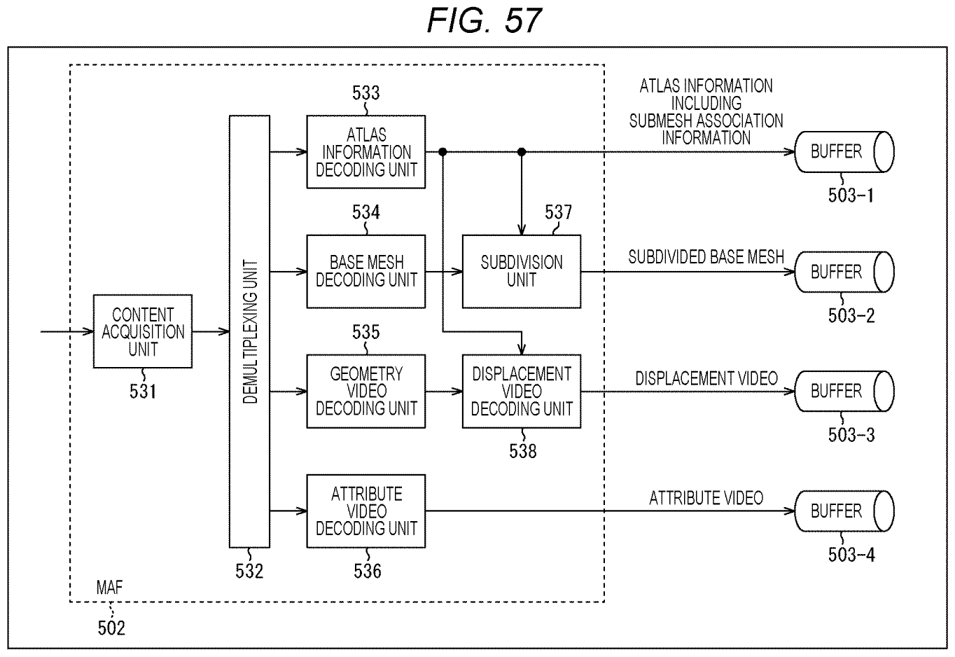

Furthermore, for example, Method 1-2-2 may be applied to the reproduction device 500 of FIG. 53. That is, the atlas data may be extended to store the submesh association information. In that case, the MAF 502 may have a configuration as illustrated in FIG. 57.

Note that, FIG. 57 illustrates main parts of processing units, data flows, and the like, and those illustrated in FIG. 57 are not necessarily all. That is, in the MAF 502, there may be a processing unit not illustrated as a block in FIG. 57, or there may be processing or a data flow not illustrated as an arrow or the like in FIG. 57.

As illustrated in FIG. 57, in this case, the MAF 502 has a similar configuration to the MAF 502 described with reference to FIG. 54. Each of these processing units may execute processing similar to that in the case of the example of FIG. 50. However, in this case, the atlas information includes submesh association information. Then, the atlas information decoding unit 533 may store atlas information including the submesh association information in the buffer 503-1. The subdivision unit 537 may store the subdivided base mesh in the buffer 503-2. The displacement video decoding unit 538 may store the displacement video in the buffer 503-3. The attribute video decoding unit 536 may store the attribute video in a buffer 503-4.

The buffers from the buffer 503-1 to the buffer 503-4 are mutually different buffer areas formed in the buffer 503 (FIG. 53). That is, in the case of this example, the submesh association information is stored in the buffer 503-1 together with the atlas information. Therefore, the displacement vector application unit 539 and the attribute mapping unit 540 (FIG. 53) of the PE 501 acquire the V-DMC data and the submesh association information from the buffer 503-1 to the buffer 503-4, respectively. In other words, the submesh association information is supplied to the PE 501 via the same buffer as the atlas information.

With such a configuration, the reproduction device 500 can realize the PE reconstruction. That is, the reproduction device 500 can improve the processing efficiency of the decoding processing as compared with the case of the MAF reconstruction. That is, the reproduction device 500 can suppress a decrease in the processing efficiency of the decoding processing.

### <MAF Processing Flow 3>

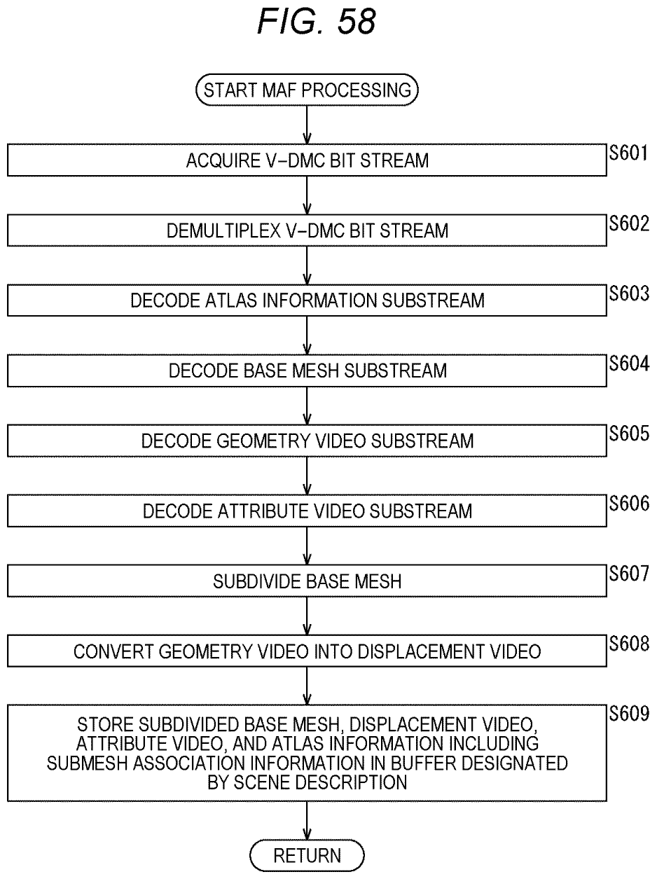

The reproduction processing executed by the reproduction device 500 having such a configuration is executed in a flow similar to the example of the flowchart of FIG. 55. An example of a flow of the MAF processing executed in step S552 of FIG. 55 in this case will be described with reference to a flowchart of FIG. 58.

In the MAF processing in this case, each processing from step S601 to step S608 is executed similarly to each processing from step S521 to step S528 of FIG. 52.

In step S609, the MAF 502 stores each of the subdivided base mesh, the displacement video, the attribute video, and the atlas information including the submesh association information in the buffer designated by the scene description. That is, the subdivision unit 537 stores the subdivided base mesh in the buffer 503-2. The displacement video decoding unit 538 stores the displacement video in the buffer 503-3. The attribute video decoding unit 536 stores the attribute video in the buffer 503-4. The atlas information decoding unit 533 stores atlas information including the submesh association information in the buffer 503-1.

When the processing of step S609 ends, the MAF processing ends, and the processing returns to FIG. 55.

By executing each processing as described above, the reproduction device 500 can realize the PE reconstruction. That is, the reproduction device 500 can improve the processing efficiency of the decoding processing as compared with the case of the MAF reconstruction. That is, the reproduction device 500 can suppress a decrease in the processing efficiency of the decoding processing.

### <Application of Method 1-2-3>

### <MAF>

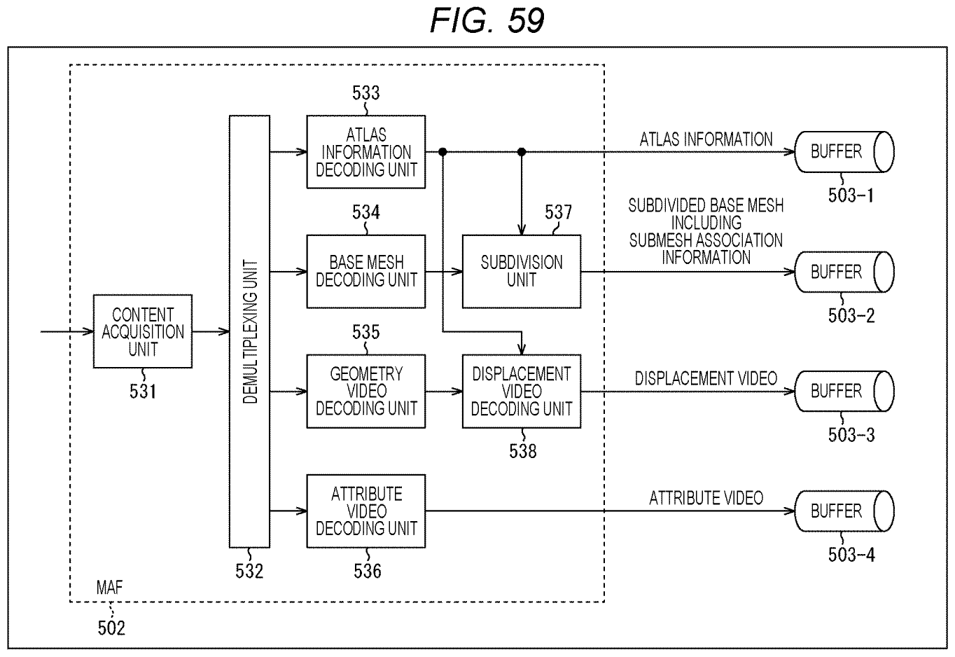

Furthermore, for example, Method 1-2-3 may be applied to the reproduction device 500 of FIG. 53. That is, the base mesh may be extended to store the submesh association information. In that case, the MAF 502 may have a configuration as illustrated in FIG. 59.

Note that, FIG. 59 illustrates main parts of processing units, data flows, and the like, and those illustrated in FIG. 59 are not necessarily all. That is, in the MAF 502, there may be a processing unit not illustrated as a block in FIG. 59, or there may be processing or a data flow not illustrated as an arrow or the like in FIG. 59.

As illustrated in FIG. 59, in this case, the MAF 502 has a similar configuration to the MAF 502 described with reference to FIG. 54. Each of these processing units may execute processing similar to that in the case of the example of FIG. 50. However, in this case, the subdivided base mesh includes submesh association information. Then, the subdivision unit 537 may store the subdivided base mesh including the submesh association information in the buffer 503-2. The atlas information decoding unit 533 may store the atlas information in the buffer 503-1. The displacement video decoding unit 538 may store the displacement video in the buffer 503-3. The attribute video decoding unit 536 may store the attribute video in a buffer 503-4.

The buffers from the buffer 503-1 to the buffer 503-4 are mutually different buffer areas formed in the buffer 503 (FIG. 53). That is, in the case of this example, the submesh association information is stored in the buffer 503-2 together with the subdivided base mesh. Therefore, the displacement vector application unit 539 and the attribute mapping unit 540 (FIG. 53) of the PE 501 acquire the V-DMC data and the submesh association information from the buffer 503-1 to the buffer 503-4, respectively. In other words, the submesh association information is supplied to the PE 501 via the same buffer as the subdivided base mesh.

With such a configuration, the reproduction device 500 can realize the PE reconstruction. That is, the reproduction device 500 can improve the processing efficiency of the decoding processing as compared with the case of the MAF reconstruction. That is, the reproduction device 500 can suppress a decrease in the processing efficiency of the decoding processing.

### <MAF Processing Flow 4>

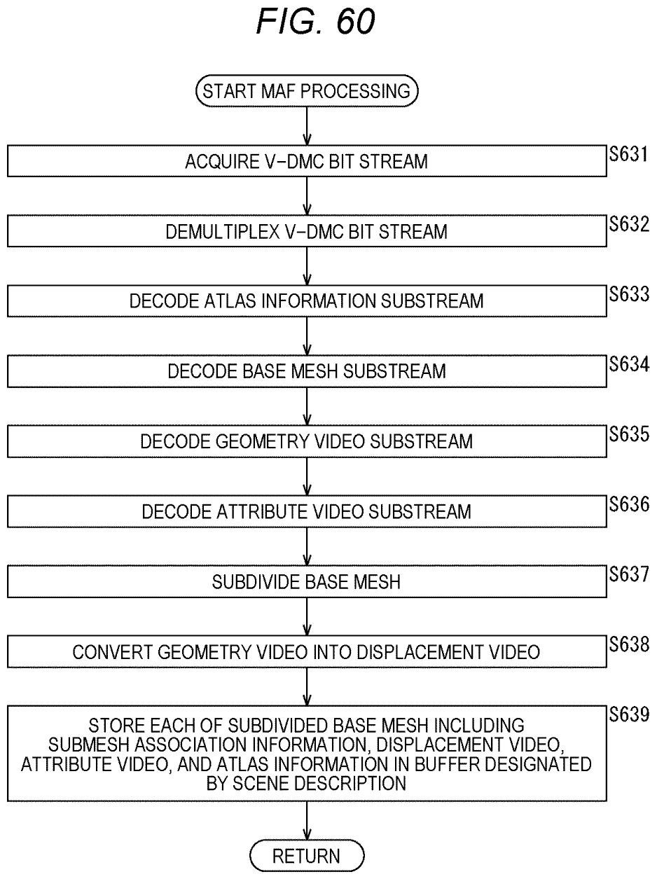

The reproduction processing executed by the reproduction device 500 having such a configuration is executed in a flow similar to the example of the flowchart of FIG. 55. An example of a flow of the MAF processing executed in step S552 of FIG. 55 in this case will be described with reference to a flowchart of FIG. 60.

In the MAF processing in this case, each processing from step S631 to step S638 is executed similarly to each processing from step S521 to step S528 of FIG. 52.

In step S639, the MAF 502 stores each of the subdivided base mesh including the submesh association information, the displacement video, the attribute video, and the atlas information in the buffer designated by the scene description. That is, the subdivision unit 537 stores the subdivided base mesh including the submesh association information in the buffer 503-2. The displacement video decoding unit 538 stores the displacement video in the buffer 503-3. The attribute video decoding unit 536 stores the attribute video in the buffer 503-4. The atlas information decoding unit 533 stores the atlas information in the buffer 503-1.

When the processing of step S639 ends, the MAF processing ends, and the processing returns to FIG. 55.

By executing each processing as described above, the reproduction device 500 can realize the PE reconstruction. That is, the reproduction device 500 can improve the processing efficiency of the decoding processing as compared with the case of the MAF reconstruction. That is, the reproduction device 500 can suppress a decrease in the processing efficiency of the decoding processing.

### <Application of Method 1-2-4>

### <Reproduction Device>

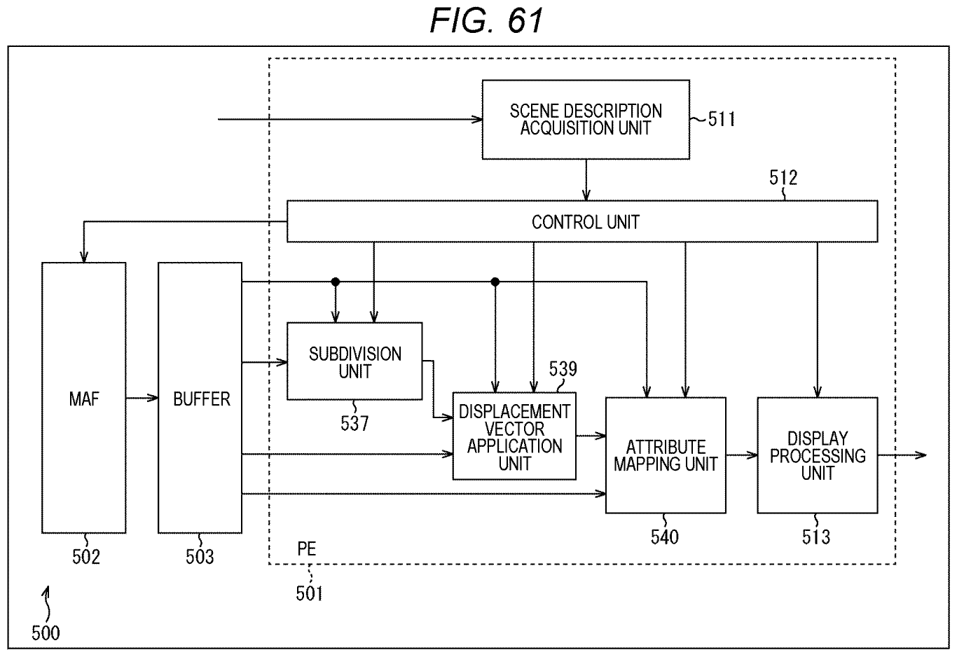

For example, Method 1-2-4 described above may be applied to the reproduction device 500. That is, the reproduction device 500 may execute the PE reconstruction as in the example of FIG. 36, and the PE may execute subdivision (subdivision) of the base mesh. In that case, for example, as illustrated in FIG. 61, the PE 501 may include the subdivision unit 537 in addition to the configuration illustrated in FIG. 53. Also in this case, the subdivision unit 537 executes processing similar to that in the example of FIG. 50. That is, the PE 501 may execute subdivision (subdivision) of the base mesh, displacement (refinement) of vertices by displacement vectors (displacement), and mapping of attributes. In this case, the MAF 502 supplies the base mesh (before being subdivided) and the subdivision information to the PE 501 via the buffer 503.

By doing so, the reproduction device 500 can further improve the processing efficiency of the decoding processing. That is, the reproduction device 500 can suppress a decrease in the processing efficiency of the decoding processing.

### <Application of Method 1-2-1>

### <MAF>

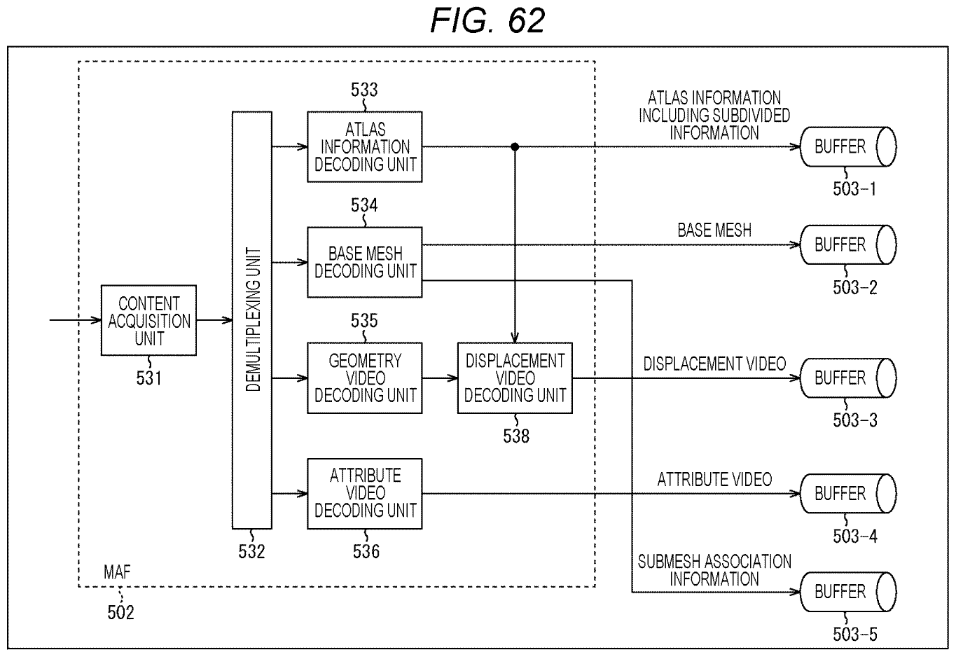

In the reproduction device 500 having such a configuration, for example, Method 1-2-1 and Method 1-2-4 may be applied. That is, reference information to a buffer that stores the submesh association information may be newly defined in the scene description, and the subdivision information may be supplied from the MAF to the PE, and the base mesh may be subdivided in the PE using the subdivision information. In that case, the MAF 502 may have a configuration as illustrated in FIG. 62.

Note that, FIG. 62 illustrates main parts of processing units, data flows, and the like, and those illustrated in FIG. 62 are not necessarily all. That is, in the MAF 502, there may be a processing unit not illustrated as a block in FIG. 62, or there may be processing or a data flow not illustrated as an arrow or the like in FIG. 62.

As illustrated in FIG. 62, in this case, the MAF 502 may include the content acquisition unit 531 to the attribute video decoding unit 536 and the displacement video decoding unit 538 in the configuration of the MAF 502 described with reference to FIG. 50. Each of these processing units may execute processing similar to that in the case of the example of FIG. 50.

However, the atlas information decoding unit 533 may store the atlas information including the subdivision information in the buffer 503-1. The base mesh decoding unit 534 may store the base mesh in the buffer 503-2. The displacement video decoding unit 538 may store the displacement video in the buffer 503-3. The attribute video decoding unit 536 may store the attribute video in a buffer 503-4. The base mesh decoding unit 534 may store the submesh association information in the buffer 503-5.

The buffers from the buffer 503-1 to the buffer 503-5 are mutually different buffer areas formed in the buffer 503 (FIG. 61). That is, in the case of this example, the submesh association information is stored in a buffer different from the V-DMC data. Therefore, the subdivision unit 537, the displacement vector application unit 539, and the attribute mapping unit 540 (FIG. 61) of the PE 501 acquire the V-DMC data, the subdivision information, and the submesh association information from each of the buffer 503-1 to the buffer 503-5. In other words, the subdivision information is supplied to the PE 501 via the same buffer as the atlas information. In addition, the submesh association information is supplied to the PE 501 via a buffer different from the V-DMC data.

With such a configuration, the reproduction device 500 can further improve the processing efficiency of the decoding processing. That is, the reproduction device 500 can suppress a decrease in the processing efficiency of the decoding processing.

### <Flow 3 of Reproduction Processing>

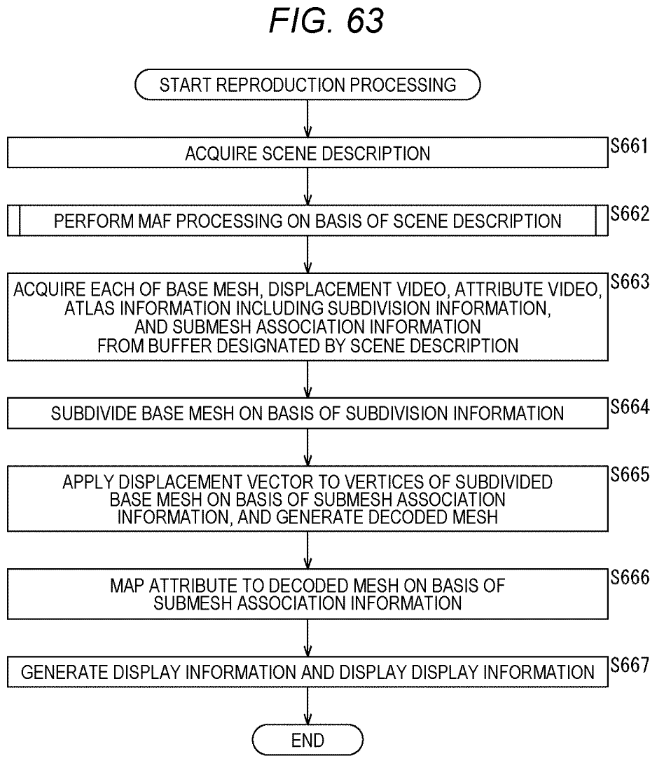

An example of a flow of reproduction processing executed by the reproduction device 500 having such a configuration will be described with reference to a flowchart of FIG. 63.

When the reproduction processing is started, the scene description acquisition unit 511 of the reproduction device 500 acquires the scene description in step S661.

In step S662, the MAF 502 executes MAF processing on the basis of the scene description, and stores the V-DMC data, the subdivision information, and the submesh association information in the buffer 503.

In step S663, the PE 501 acquires each of the base mesh, the displacement video, the attribute video, the atlas information including the subdivision information, and the submesh association information from the buffer designated by the scene description.

In step S664, the subdivision unit 537 of the PE 501 subdivides the base mesh on the basis of the subdivision information.

In step S665, the displacement vector application unit 539 of the PE 501 applies the displacement vector to the vertices of the subdivided base mesh on the basis of the submesh association information, and generates a decoded mesh. That is, the displacement vector application unit 539 generates the geometry of the reconstructed 3D data.

In step S666, the attribute mapping unit 540 of the PE 501 maps the attribute to the decoded mesh on the basis of the submesh association information. That is, the attribute mapping unit 540 generates an attribute of the reconstructed 3D data.

In step S667, the display processing unit 513 of the PE 501 generates and displays the display information using the decoded mesh (geometry of the reconstructed 3D data) and the attribute (attribute of the reconstructed 3D data) mapped to the decoded mesh.

When the processing of step S667 ends, the reproduction processing ends.

### <MAF Processing Flow 5>

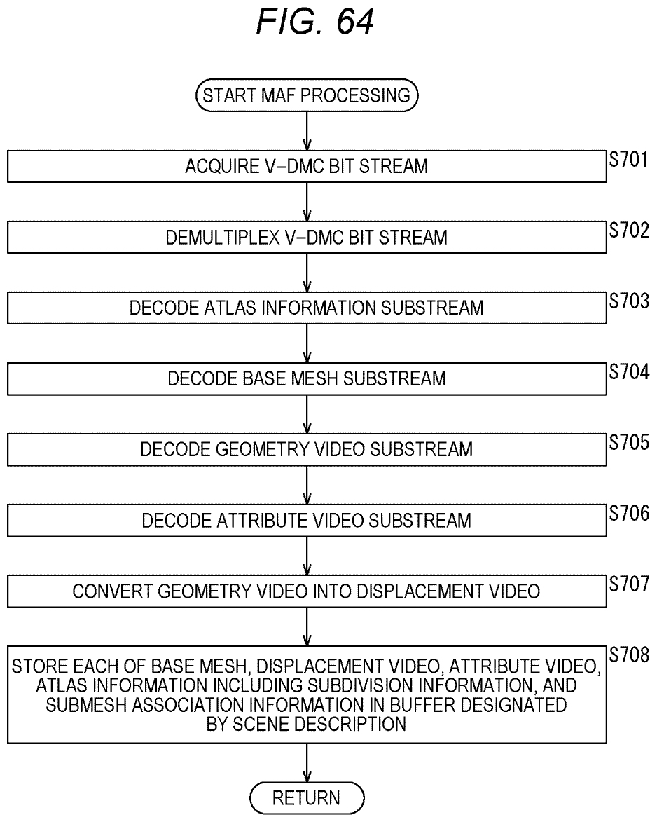

Next, an example of a flow of the MAF processing executed in step S662 of FIG. 63 will be described with reference to a flowchart of FIG. 64.

In the MAF processing in this case, each processing from step S701 to step S707 is executed similarly to each processing from step S521 to step S526 of FIG. 52 and the processing of step S528.

In step S708, the MAF 502 stores each of the base mesh, the displacement video, the attribute video, the atlas information including the subdivision information, and the submesh association information in the buffer designated by the scene description. That is, the base mesh decoding unit 534 stores the base mesh in the buffer 503-2. The displacement video decoding unit 538 stores the displacement video in the buffer 503-3. The attribute video decoding unit 536 stores the attribute video in the buffer 503-4. The atlas information decoding unit 533 stores atlas information including the subdivision information in the buffer 503-1. The base mesh decoding unit 534 stores the submesh association information in the buffer 503-5.

When the processing of step S708 ends, the MAF processing ends, and the processing returns to FIG. 63.

By executing each processing as described above, the reproduction device 500 can further improve the processing efficiency of the decoding processing. That is, the reproduction device 500 can suppress a decrease in the processing efficiency of the decoding processing.

### <Application of Method 1-2-2>

### MAF>

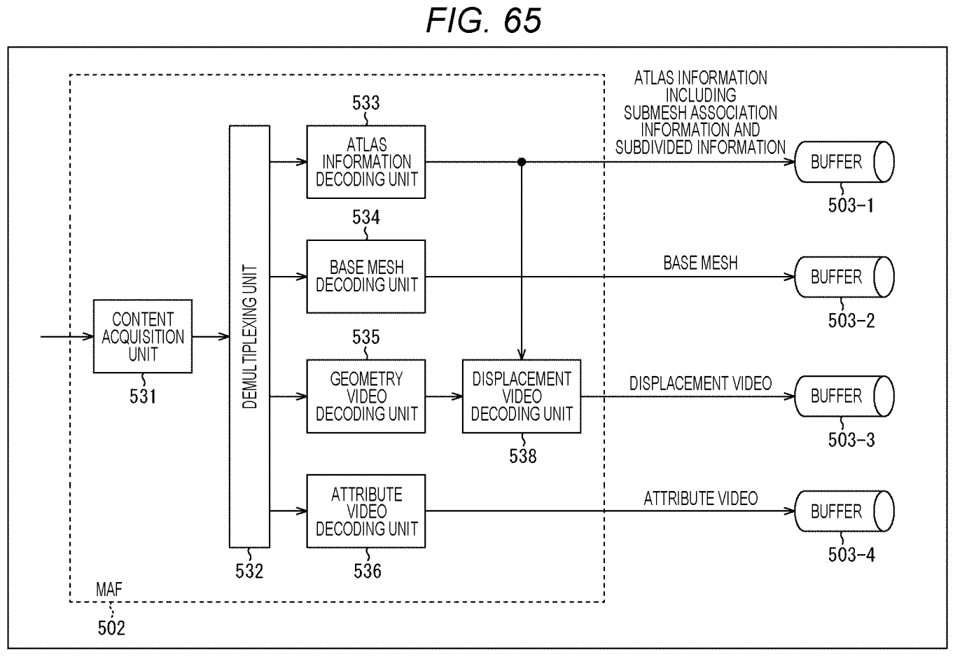

Further, for example, Method 1-2-2 and Method 1-2-4 may be applied to the reproduction device 500 in FIG. 61. That is, the atlas data may be extended to store the submesh association information, and the subdivision information may be supplied from the MAF to the PE to subdivide the base mesh in the PE using the subdivision information. In that case, the MAF 502 may have a configuration as illustrated in FIG. 65.

Note that, FIG. 65 illustrates main parts of processing units, data flows, and the like, and those illustrated in FIG. 65 are not necessarily all. That is, in the MAF 502, there may be a processing unit not illustrated as a block in FIG. 65, or there may be processing or a data flow not illustrated as an arrow or the like in FIG. 65.

As illustrated in FIG. 65, in this case, the MAF 502 has a similar configuration to the MAF 502 described with reference to FIG. 62. Each of these processing units may execute processing similar to that in the case of the example of FIG. 50. However, in this case, the atlas information includes submesh association information and subdivision information. Then, the atlas information decoding unit 533 may store atlas information including the submesh association information and the subdivision information in the buffer 503-1. The base mesh decoding unit 534 may store the base mesh in the buffer 503-2. The displacement video decoding unit 538 may store the displacement video in the buffer 503-3. The attribute video decoding unit 536 may store the attribute video in a buffer 503-4.

The buffers from the buffer 503-1 to the buffer 503-4 are mutually different buffer areas formed in the buffer 503 (FIG. 61). That is, in the case of this example, the submesh association information and the subdivision information are stored in the buffer 503-1 together with the atlas information. Therefore, the subdivision unit 537, the displacement vector application unit 539, and the attribute mapping unit 540 (FIG. 61) of the PE 501 acquire the V-DMC data, the submesh association information, and the subdivision information from each of the buffer 503-1 to the buffer 503-4. In other words, the submesh association information and the subdivision information are supplied to the PE 501 via the same buffer as the atlas information.

With such a configuration, the reproduction device 500 can further improve the processing efficiency of the decoding processing. That is, the reproduction device 500 can suppress a decrease in the processing efficiency of the decoding processing.

### <MAF Processing Flow 6>

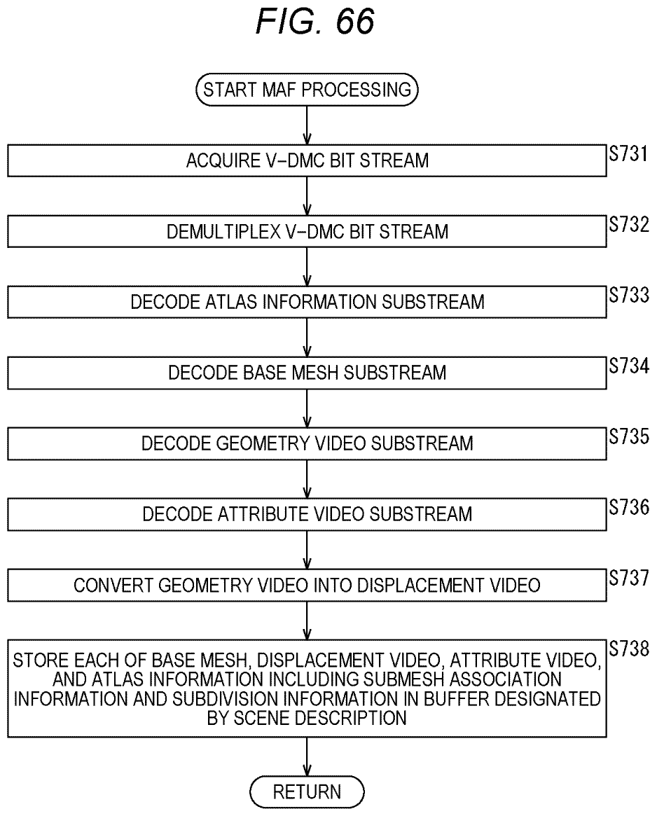

The reproduction processing executed by the reproduction device 500 having such a configuration is executed in a flow similar to the example of the flowchart of FIG. 63. An example of a flow of the MAF processing executed in step S662 of FIG. 63 in this case will be described with reference to a flowchart of FIG. 66.

In the MAF processing in this case, each processing from step S731 to step S737 is executed similarly to each processing from step S701 to step S707 of FIG. 64.

In step S738, the MAF 502 stores each of the base mesh, the displacement video, the attribute video, and the atlas information including the submesh association information and the subdivision information in the buffer designated by the scene description. That is, the base mesh decoding unit 534 stores the base mesh in the buffer 503-2. The displacement video decoding unit 538 stores the displacement video in the buffer 503-3. The attribute video decoding unit 536 stores the attribute video in the buffer 503-4. The atlas information decoding unit 533 stores the atlas information including the submesh association information and the subdivision information in the buffer 503-1.

When the processing of step S738 ends, the MAF processing ends, and the processing returns to FIG. 63.

By executing each processing as described above, the reproduction device 500 can further improve the processing efficiency of the decoding processing. That is, the reproduction device 500 can suppress a decrease in the processing efficiency of the decoding processing.

### <Application of Method 1-2-3>

### <MAF>

Further, for example, Method 1-2-3 and Method 1-2-4 may be applied to the reproduction device 500 in FIG. 61.

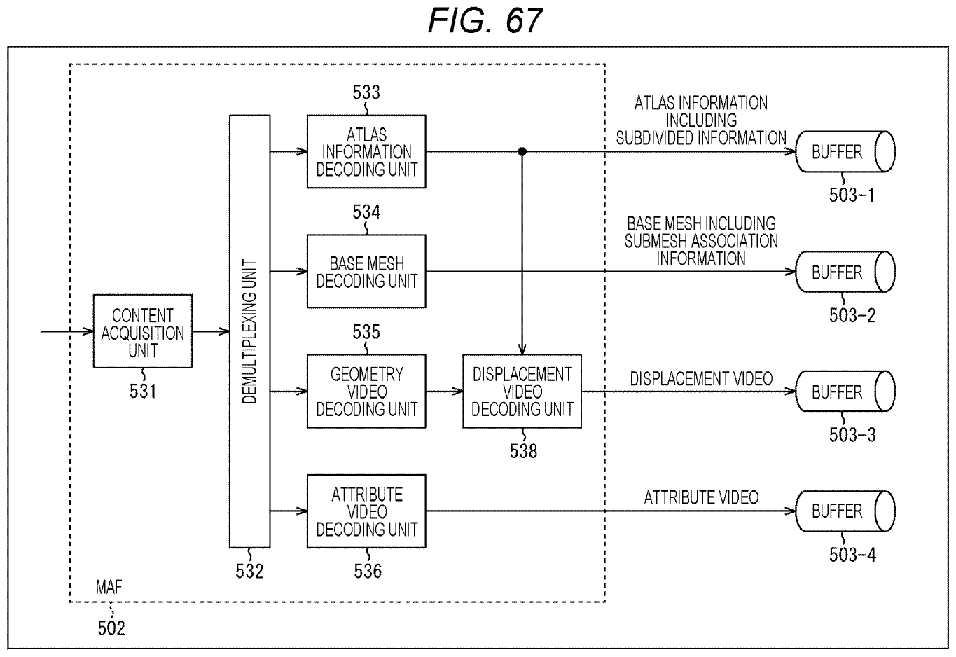

That is, the base mesh may be extended to store the submesh association information, the subdivision information may be supplied from the MAF to the PE, and the base mesh may be subdivided by using the subdivision information in the PE. In that case, the MAF 502 may have a configuration as illustrated in FIG. 67.

Note that, FIG. 67 illustrates main parts of processing units, data flows, and the like, and those illustrated in FIG. 67 are not necessarily all. That is, in the MAF 502, there may be a processing unit not illustrated as a block in FIG. 67, or there may be processing or a data flow not illustrated as an arrow or the like in FIG. 67.

As illustrated in FIG. 67, in this case, the MAF 502 has a similar configuration to the MAF 502 described with reference to FIG. 62. Each of these processing units may execute processing similar to that in the case of the example of FIG. 50. However, in this case, the base mesh includes submesh association information. Then, the base mesh decoding unit 534 may store the base mesh including the submesh association information in the buffer 503-2. In addition, the atlas information includes subdivision information. The atlas information decoding unit 533 may store atlas information including the subdivision information in the buffer 503-1. The displacement video decoding unit 538 may store the displacement video in the buffer 503-3. The attribute video decoding unit 536 may store the attribute video in a buffer 503-4.

The buffers from the buffer 503-1 to the buffer 503-4 are mutually different buffer areas formed in the buffer 503 (FIG. 61). That is, in the case of this example, the submesh association information is stored in the buffer 503-2 together with the base mesh. Further, the subdivision information is stored in the buffer 503-1 together with the atlas information. Therefore, the subdivision unit 537, the displacement vector application unit 539, and the attribute mapping unit 540 (FIG. 61) of the PE 501 acquire the V-DMC data, the submesh association information, and the subdivision information from each of the buffer 503-1 to the buffer 503-4. In other words, the submesh association information is supplied to the PE 501 via the same buffer as the base mesh. In addition, the subdivision information is supplied to the PE 501 via the same buffer as the atlas information.

With such a configuration, the reproduction device 500 can further improve the processing efficiency of the decoding processing. That is, the reproduction device 500 can suppress a decrease in the processing efficiency of the decoding processing.

### <MAF Processing Flow 7>

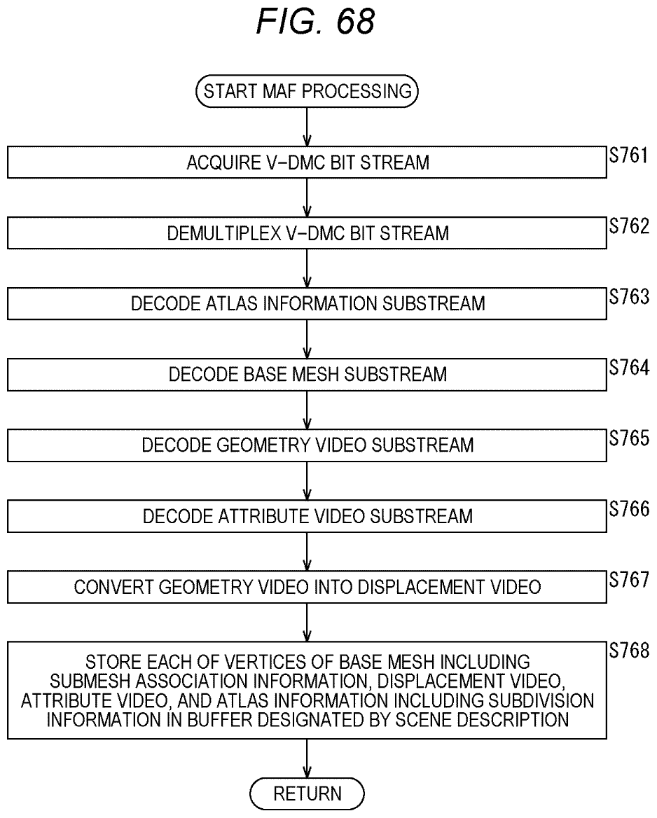

The reproduction processing executed by the reproduction device 500 having such a configuration is executed in a flow similar to the example of the flowchart of FIG. 63. An example of a flow of the MAF processing executed in step S662 of FIG. 63 in this case will be described with reference to a flowchart of FIG. 68.

In the MAF processing in this case, each processing from step S761 to step S767 is executed similarly to each processing from step S701 to step S707 of FIG. 64.

In step S768, the MAF 502 stores each of the subdivided base mesh including the submesh association information, the displacement video, the attribute video, and the atlas information in the buffer designated by the scene description. That is, the subdivision unit 537 stores the subdivided base mesh including the submesh association information in the buffer 503-2. The displacement video decoding unit 538 stores the displacement video in the buffer 503-3. The attribute video decoding unit 536 stores the attribute video in the buffer 503-4. The atlas information decoding unit 533 stores the atlas information in the buffer 503-1.

When the processing of step S768 ends, the MAF processing ends, and the processing returns to FIG. 63.

By executing each processing as described above, the reproduction device 500 can further improve the processing efficiency of the decoding processing. That is, the reproduction device 500 can suppress a decrease in the processing efficiency of the decoding processing.

### <6. Supplementary Note>

### <Computer>

The above-described series of processing may be executed by hardware or may be executed by software. In a case where the series of processing is executed by software, a program included in the software is installed in a computer. Here, the computer includes a computer incorporated in dedicated hardware, a general-purpose personal computer capable of executing various functions by installing various programs, and the like, for example.

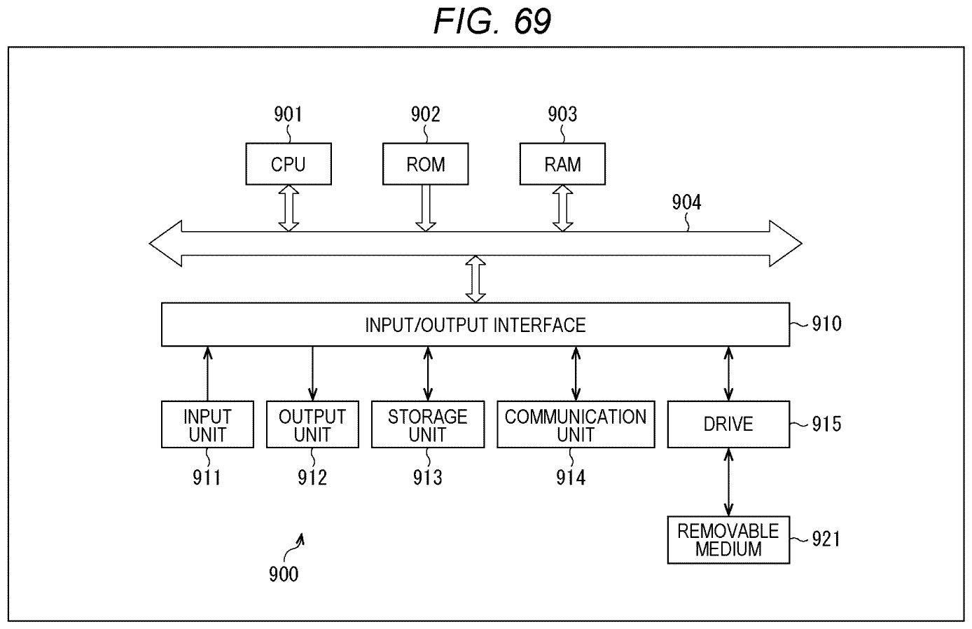

FIG. 69 is a block diagram illustrating a configuration example of hardware of a computer that executes the series of processing described above in accordance with a program.

In a computer 900 illustrated in FIG. 69, a central processing unit (CPU) 901, a read only memory (ROM) 902, and a random access memory (RAM) 903 are mutually connected via a bus 904.

Furthermore, an input/output interface 910 is also connected to the bus 904. To the input/output interface 910, an input unit 911, an output unit 912, a storage unit 913, a communication unit 914, and a drive 915 are connected.

The input unit 911 may include, for example, a keyboard, a mouse, a microphone, a touch panel, an input terminal, and the like. The output unit 912 may include, for example, a display, a speaker, an output terminal, and the like. The storage unit 913 may include, for example, a hard disk, a RAM disk, a nonvolatile memory, or the like. The communication unit 914 may include, for example, a network interface or the like. The drive 915 may drive a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is performed. The RAM 903 also appropriately stores data and the like necessary for the CPU 901 to execute various types of processing.

For example, the program executed by the computer may be applied by being recorded in the removable medium 921 as a package medium or the like. In this case, the program may be installed in the storage unit 913 via the input/output interface 910 when the removable medium 921 is attached to the drive 915.

Furthermore, the program may be provided via a wired or wireless transmission medium such as a local area network, the Internet, or digital satellite broadcasting. In this case, the program may be received by the communication unit 914 and installed in the storage unit 913.

In addition, this program may be installed in the ROM 902 or the storage unit 913 in advance.

<Object to which Present Technology is Applicable>

The present technology can be applied to any coding/decoding scheme.

Furthermore, the present technology can be applied to any configuration. For example, the present technology can be applied to various electronic devices.

Furthermore, for example, the present technology can also be implemented as a partial configuration of an device, such as a processor (for example, a video processor) as a system large scale integration (LSI) or the like, a module (for example, a video module) using a plurality of processors or the like, a unit (for example, a video unit) using a plurality of modules or the like, or a set (for example, a video set) or the like obtained by further adding other functions to the unit.

Furthermore, for example, the present technology can also be applied to a network system including a plurality of devices. For example, the present technology may be implemented as cloud computing shared and processed in cooperation by a plurality of devices via a network. For example, the present technology may be implemented in a cloud service that provides a service related to an image (moving image) to any terminal such as a computer, an audio visual (AV) device, a portable information processing terminal, or an Internet of Things (IOT) device.

Note that, in the present specification, a system means a set of a plurality of components (devices, modules (parts) and the like), and it does not matter whether or not all the components are in the same housing. Therefore, a plurality of devices stored in different housings and connected via a network and one device in which a plurality of modules is stored in one housing are both systems.

<Field and Application to which Present Technology is Applicable>

The system, device, processing unit, and the like to which the present technology is applied can be used in any field such as traffic, medical care, crime prevention, agriculture, livestock industry, mining, beauty care, factory, household appliance, weather, and natural surveillance, for example. Furthermore, application thereof is also arbitrary.

For example, the present technology can be applied to systems and devices used for providing content for appreciation and the like. Furthermore, for example, the present technology can also be applied to systems and devices used for traffic, such as traffic condition management and automated driving control. Moreover, for example, the present technology can also be applied to systems and devices used for security. Furthermore, for example, the present technology can be applied to systems and devices used for automatic control of a machine and the like. Moreover, for example, the present technology can also be applied to systems and devices used for use in agriculture and livestock industry. Furthermore, the present technology can also be applied to systems and devices that monitor, for example, the status of nature such as a volcano, a forest, and the ocean, wildlife, and the like. Moreover, for example, the present technology can also be applied to systems and devices used for sports.

### <Others>

Note that, in the present specification, a “flag” is information for identifying a plurality of states, and includes not only information used for identifying two states of true (1) and false (0) but also information capable of identifying three or more states. Hence, a value that may be taken by the “flag” may be, for example, a binary of I/O or a ternary or more. That is, the number of bits forming this “flag” is any number, and may be one bit or a plurality of bits. Furthermore, identification information (including the flag) is assumed to include not only identification information thereof in a bit stream but also difference information of the identification information with respect to certain reference information in the bit stream, and thus, in the present specification, the “flag” and “identification information” include not only the information thereof but also the difference information with respect to the reference information.

Furthermore, various types of information (such as metadata) related to coded data (bit stream) may be transmitted or recorded in any form as long as the information is associated with the coded data. Here, the term “associate” means, for example, that one data can be used (linked) when the other data is processed. That is, the data associated with each other may be collected as one data or may be made individual data. For example, information associated with the coded data (image) may be transmitted on a transmission path different from that of the coded data (image). Furthermore, for example, the information associated with the coded data (image) may be recorded in a recording medium different from that of the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “merge”, “include”, “store”, “put in”, “introduce”, and “insert” mean, for example, to combine a plurality of objects into one, such as to combine coded data and metadata into one data, and mean one method of “associate” described above.

Furthermore, the embodiments of the present technology are not limited to the above-described embodiments, and various modifications are possible without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, as long as the configuration and operation of the entire system are substantially the same, a part of the configuration of a certain device (or processing unit) may be included in the configuration of another device (or another processing unit).

Furthermore, for example, the above-described programs may be executed in any device. In this case, the device is only required to have a necessary function (functional block and the like) and obtain necessary information.

Furthermore, for example, each step in one flowchart may be executed by one device, or may be shared and executed by a plurality of devices. Moreover, in a case where a plurality of pieces of processing is included in one step, the plurality of pieces of processing may be executed by one device, or may be shared and executed by a plurality of devices. In other words, the plurality of pieces of processing included in one step can also be executed as pieces of processing of a plurality of steps. Conversely, the pieces of processing described as the plurality of the steps can also be collectively executed as one step.

Furthermore, for example, in a program executed by the computer, processing of steps describing the program may be executed in a time-series order in the order described in the present specification, or may be executed individually at a required timing such as when a call is made. That is, the pieces of processing of the respective steps may be executed in an order different from the above-described order as long as there is no contradiction. Moreover, the processing of the steps describing the program may be executed in parallel with processing of another program, or may be executed in combination with processing of the other program.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that the present technology can also have the following configurations.
(1) An information processing device including a scene description generation unit that generates a scene description representing a scene configured by a 3D object, and sets, in the scene description, first reference information to a first buffer that stores submesh association information, in which the submesh association information is information for specifying data of a submesh that is a part of a mesh representing the 3D object.
(2) The information processing device according to (1), in which the first buffer is a buffer different from a second buffer that stores data of the mesh.
(3) The information processing device according to (2), in which the submesh association information includes boundary information indicating a boundary of the submesh in data of a base mesh from which vertices of the mesh have been thinned out.
(4) The information processing device according to (3), in which the boundary information includes information indicating a length of data of the submesh and identification information of the submesh.
(5) The information processing device according to any one of (1) to (4), in which the first buffer is configured to store atlas information including the submesh association information.
(6) The information processing device according to (5), in which the atlas information includes the submesh association information associated with a patch.
(7) The information processing device according to (6), in which the submesh association information includes boundary information indicating a boundary of the submesh in data of a base mesh from which vertices of the mesh have been thinned out.
(8) The information processing device according to (7), in which the boundary information includes information indicating an offset and a length of data of the submesh.
(9) The information processing device according to any one of (1) to (8), in which the first buffer is configured to store a base mesh including the submesh association information.
(10) The information processing device according to (9), in which the submesh association information includes identification information of the submesh.
(11) The information processing device according to (9) or (10), in which the submesh association information includes identification information of the submesh associated with each vertex of the base mesh.
(12) The information processing device according to any one of (1) to (11), in which the scene description generation unit further sets, in the scene description, second reference information to a second buffer that stores subdivision information related to subdivision of a base mesh from which vertices of the mesh have been thinned out.
(13) The information processing device according to (12), in which the second buffer is configured to store atlas information including the subdivision information.
(14) The information processing device according to (13), in which the atlas information includes the subdivision information associated with a patch.
(15) The information processing device according to any one of (12) to (14), in which the subdivision information includes information indicating whether or not a predetermined method is applied in subdivision of the base mesh.
(16) The information processing device according to any one of (12) to (15), in which the subdivision information includes information indicating the number of iterations of subdivision of the base mesh.
(17) An information processing method including: generating a scene description representing a scene configured by a 3D object; and setting, in the scene description, first reference information to a first buffer that stores submesh association information, in which the submesh association information is information for specifying data of a submesh that is a part of a mesh representing the 3D object.
(21) An information processing device including: a storage processing unit that stores submesh association information for specifying data of a submesh that is a part of a mesh representing a 3D object in a first buffer designated by a scene description representing a scene configured by the 3D object; and a reconstruction unit that acquires the submesh association information from the first buffer, specifies the data of the submesh using the acquired submesh association information, and reconstructs the mesh.
(22) The information processing device according to (21), in which the first buffer is a buffer different from a second buffer that stores data of the mesh.
(23) The information processing device according to (22), in which the submesh association information includes boundary information indicating a boundary of the submesh in data of a base mesh from which vertices of the mesh have been thinned out.
(24) The information processing device according to (23), in which the boundary information includes information indicating a length of data of the submesh and identification information of the submesh.
(25) The information processing device according to any one of (21) to (24), in which the first buffer is configured to store atlas information including the submesh association information.
(26) The information processing device according to (25), in which the atlas information includes the submesh association information associated with a patch.
(27) The information processing device according to (26), in which the submesh association information includes boundary information indicating a boundary of the submesh in data of a base mesh from which vertices of the mesh have been thinned out.
(28) The information processing device according to (27), in which the boundary information includes information indicating an offset and a length of data of the submesh.
(29) The information processing device according to any one of (21) to (28), in which the first buffer is configured to store a base mesh including the submesh association information.
(30) The information processing device according to (29), in which the submesh association information includes identification information of the submesh.
(31) The information processing device according to (29) or (30), in which the submesh association information includes identification information of the submesh associated with each vertex of the base mesh.
(32) The information processing device according to (21) to (31), in which the storage processing unit further stores, in a second buffer designated by the scene description, subdivision information related to subdivision of a base mesh from which vertices of the mesh have been thinned out, and the reconstruction unit acquires the subdivision information from the second buffer, subdivides the base mesh using the acquired subdivision information, and reconfigures the mesh using the subdivided base mesh.
(33) The information processing device according to (32), in which the second buffer is configured to store atlas information including the subdivision information.
(34) The information processing device according to (33), in which the atlas information includes the subdivision information associated with a patch.
(35) The information processing device according to any one of (32) to (34), in which the subdivision information includes information indicating whether or not a predetermined method is applied in subdivision of the base mesh.
(36) The information processing device according to any one of (32) to (35), in which the subdivision information includes information indicating the number of iterations of subdivision of the base mesh.
(37) An information processing method including: storing submesh association information for specifying data of a submesh that is a part of a mesh representing a 3D object in a first buffer designated by a scene description representing a scene configured by the 3D object; and acquiring the submesh association information from the first buffer, specifying the data of the submesh using the acquired submesh association information, and reconfiguring the mesh.

### REFERENCE SIGNS LIST

300 File generation device
311 Control unit
312 File generation processing unit
313 Input unit
331 V-DMC data generation unit
332 V-DMC data coding unit
333 File generation unit
334 Scene description generation unit
335 Storage unit
336 Supply unit
351 Atlas information coding unit
352 Base mesh coding unit
353 Displacement vector correction unit
354 Displacement video coding unit
355 Mesh reconstruction unit
356 Attribute map conversion unit
357 Attribute video coding unit
358 Multiplexing unit
500 Reproduction device
501 PE
502 MAF
503 Buffer
511 Scene description acquisition unit
512 Control unit
513 Display processing unit
531 Content acquisition unit
532 Demultiplexing unit
533 Atlas information decoding unit
534 Base mesh decoding unit
535 Geometry video decoding unit
536 Attribute video decoding unit
537 Subdivision unit
538 Displacement video decoding unit
539 Displacement vector application unit
540 Attribute mapping decoding unit
900 Computer

1. An information processing device comprising
a scene description generation unit that generates a scene description representing a scene configured by a 3D object, and sets, in the scene description, first reference information to a first buffer that stores submesh association information,
wherein the submesh association information is information for specifying data of a submesh that is a part of a mesh representing the 3D object.

2. The information processing device according to claim 1, wherein the first buffer is a buffer different from a second buffer that stores data of the mesh.

3. The information processing device according to claim 2, wherein the submesh association information includes boundary information indicating a boundary of the submesh in data of a base mesh from which vertices of the mesh have been thinned out.

4. The information processing device according to claim 1, wherein the first buffer is configured to store atlas information including the submesh association information.

5. The information processing device according to claim 4, wherein the submesh association information includes boundary information indicating a boundary of the submesh in data of a base mesh from which vertices of the mesh have been thinned out.

6. The information processing device according to claim 1, wherein the first buffer is configured to store a base mesh including the submesh association information.

7. The information processing device according to claim 6, wherein the submesh association information includes identification information of the submesh.

8. The information processing device according to claim 1, wherein the scene description generation unit further sets, in the scene description, second reference information to a second buffer that stores subdivision information related to subdivision of a base mesh from which vertices of the mesh have been thinned out.

9. The information processing device according to claim 8, wherein the second buffer is configured to store atlas information including the subdivision information.

10. An information processing method comprising:
generating a scene description representing a scene configured by a 3D object; and
setting, in the scene description, first reference information to a first buffer that stores submesh association information,
wherein the submesh association information is information for specifying data of a submesh that is a part of a mesh representing the 3D object.

11. An information processing device comprising:
a storage processing unit that stores submesh association information for specifying data of a submesh that is a part of a mesh representing a 3D object in a first buffer designated by a scene description representing a scene configured by the 3D object; and
a reconstruction unit that acquires the submesh association information from the first buffer, specifies the data of the submesh using the acquired submesh association information, and reconstructs the mesh.

12. The information processing device according to claim 11, wherein the first buffer is a buffer different from a second buffer that stores data of the mesh.

13. The information processing device according to claim 12, wherein the submesh association information includes boundary information indicating a boundary of the submesh in data of a base mesh from which vertices of the mesh have been thinned out.

14. The information processing device according to claim 11, wherein the first buffer is configured to store atlas information including the submesh association information.

15. The information processing device according to claim 14, wherein the submesh association information includes boundary information indicating a boundary of the submesh in data of a base mesh from which vertices of the mesh have been thinned out.

16. The information processing device according to claim 11, wherein the first buffer is configured to store a base mesh including the submesh association information.

17. The information processing device according to claim 16, wherein the submesh association information includes identification information of the submesh.

18. The information processing device according to claim 11,
wherein the storage processing unit further stores, in a second buffer designated by the scene description, subdivision information related to subdivision of a base mesh from which vertices of the mesh have been thinned out, and
the reconstruction unit acquires the subdivision information from the second buffer, subdivides the base mesh using the acquired subdivision information, and reconstructs the mesh using the subdivided base mesh.

19. The information processing device according to claim 18, wherein the second buffer is configured to store atlas information including the subdivision information.

20. An information processing method comprising:
storing submesh association information for specifying data of a submesh that is a part of a mesh representing a 3D object in a first buffer designated by a scene description representing a scene configured by the 3D object; and
acquiring the submesh association information from the first buffer, specifying the data of the submesh using the acquired submesh association information, and reconstructing the mesh.
